(19) United States
(12) Patent Application Publication
(10) Pub. No.: US 2018/0368427 A1
(43) Pub. Date: Dec. 27, 2018

(54) Method of Reducing Spoilage in Harvested Produce During Storage and Shipping

(71) Applicant: Apeel Technology, Inc., Goleta, CA (US)

(72) Inventors: James Rogers, Santa Barbara, CA (US); Chance Holland, Goleta, CA (US); Alexander Thomas, Santa Barbara, CA (US); Jenny Du, Santa Barbara, CA (US)

(21) Appl. No.: 16/121,513

(22) Filed: Sep. 4, 2018

Related U.S. Application Data
(63) Continuation of application No. PCT/US2017/024799, filed on Mar. 29, 2017.
(60) Provisional application No. 62/316,741, filed on Apr. 1, 2016.

(51) Int. Cl. A23B 7/16; A23B 7/154; A23B 7/148; A01N 3/00

(52) U.S. Cl. CPC A23B 7/16; A23B 7/154; A23V 2002/00; A01N 3/00; A23B 7/148

(57) ABSTRACT

Described herein are formulations and methods of reducing spoilage in harvested produce by reducing the rate of water or mass loss, thereby resulting in high quality produce with lower rates of spoilage. The present disclosure provides coatings and methods of coating produce to prevent moisture loss from produce during storage and shipment of the produce. This in turn allows the produce to be shipped and stored at lower relative humidity (e.g., lower than industry standards for shipment and storage, or lower than about 90% relative humidity), which can help delay the growth of biotic stressors such as fungi, bacteria, viruses, and/or pests.

### CROSS REFERENCE TO RELATED APPLICATIONS

This application is a bypass continuation of PCT/US2017/024799, filed Mar. 29, 2017, which claims the benefit of priority to U.S. Provisional Patent Application Ser. No. 62/316,741, filed Apr. 1, 2016.

### FIELD OF THE DISCLOSURE

The present disclosure relates to formulations and methods for treating agricultural products, such as produce, to reduce spoilage during storage and shipping.

### BACKGROUND

Common agricultural products such as fresh produce can be highly susceptible to degradation and decomposition (i.e., spoilage) when exposed to the environment. The degradation of the agricultural products can occur via abiotic means as a result of evaporative moisture loss from an external surface of the agricultural products to the atmosphere and/or oxidation by oxygen that diffuses into the agricultural products from the environment and/or mechanical damage to the surface and/or light-induced degradation (i.e., photodegradation). Furthermore, biotic stressors such as, for example, bacteria, fungi, viruses, and/or pests can also infest and decompose the agricultural products.

Harvested produce (e.g., fruits, vegetables, berries, etc.) can also be stored at high density (i.e., high total mass of produce per unit volume of storage container) for extended periods of time prior to consumption. Methods for decreasing the rate of spoilage while maintaining high quality produce in a dense packing volume, with minimal loss in mass/moisture during storage and shipping, are therefore desirable.

### SUMMARY

Described herein are formulations and methods for extending storage time and reducing spoilage of harvested produce without increasing the rate of water or mass loss, thereby resulting in high quality produce with lower rates of spoilage. The present disclosure provides protective coatings, as well as methods of coating produce, to prevent moisture loss from the produce during storage and shipping. This in turn can allow the produce to be shipped and stored at lower relative humidity (e.g., lower than industry standards for shipping and storage, or lower than about 90% relative humidity), which can help inhibit or delay the growth of biotic stressors such as fungi, bacteria, viruses, and/or pests.

In one aspect, a method of reducing spoilage in harvested produce during storage includes applying a coating formulation to the produce to form a coating over a surface of the produce. The coating formulation comprises a plurality of monomers, oligomers, low molecular weight polymers, fatty acids, esters, or combinations thereof. The method further includes storing the produce at an average relative humidity level sufficiently low to suppress fungal growth in the produce during storage, wherein the coating is formulated to reduce a mass loss rate of the produce at the average relative humidity level.

In another aspect, a method of reducing spoilage in harvested produce during storage includes receiving the produce, wherein the produce is coated with a coating agent disposed over a surface of the produce, the coating agent formed from a composition comprising monomers, oligomers, low molecular weight polymers, fatty acids, esters, or combinations thereof. The method further includes storing the produce at an average relative humidity level, the average relative humidity level being sufficiently low to suppress fungal growth in the produce during storage. The coating agent is formulated to reduce a mass loss rate of the produce at relative humidity levels less than or equal to the average relative humidity level.

In another aspect, a method of storing produce includes dissolving a coating agent in a solvent to form a solution, and applying the solution to the surface of the produce. The method further includes allowing the solvent to at least partially evaporate to form a coating on the produce, and storing the produce in an enclosed container at an average relative humidity level in a range of about 50% to 90%.

In another aspect, a method of storing produce includes causing a coating agent to be applied to a surface of the produce, the coating agent formulated to form a coating over the surface of the produce, and storing the produce in an enclosed container at an average relative humidity level greater than an ambient humidity outside the container and less than 90%.

In another aspect, a method of storing produce includes dissolving a coating agent in a solvent to form a solution, and applying the solution to the surface of the produce. The method further includes allowing the solvent to at least partially evaporate to form a coating on the produce, and causing the produce to be stored at an average relative humidity level between 60% and 90%.

In another aspect, a method of storing produce includes causing a solution comprising a coating agent dissolved in a solvent to be applied to a surface of the produce, the coating agent formulated to form a coating over the surface of the produce, and causing the produce to be stored in an enclosed container at an average relative humidity level in a range of about 55% to 90%. Furthermore, the container includes a humidity controller configured to maintain a humidity level within the container at the average relative humidity level.

In another aspect, a method of storing produce comprises receiving produce that includes a coating formed thereon, the coating formed from a coating agent comprising at least one of fatty acids, esters, monomers, oligomers, and low molecular weight polymers. The method further includes storing the produce in an enclosed container at an average relative humidity level less than about 90%, wherein at least 20% of the internal volume of the container is filled with the produce.

Methods and formulations described herein can each include one or more of the following steps or features. Forming the coating can include causing the monomers, oligomers, low molecular weight polymers, or combinations thereof to cross-link, for instance on the surface of the produce. For instance, the components of the coating agent can crosslink to form the coating. The produce can be stored in a container (e.g., at the average humidity level, such as a relative humidity below about 90%) for at least about 1 day, at least about 2 days, at least about 3 days, at least about 4 days, at least about 5 days, at least about 6 days, at least about 7 days, at least about 8 days, at least about 9 days, at least about 10 days, at least about 15 days, at least about 20 days, at least about 25 days, at least about 30 days, at least about 35 days, at least about 40 days, at least about 45 days, at least about 50 days, at least about 55 days, at least about 60 days, about 1 to about 120 days, about 1 to about 110 days, about 1 to about 100 days, about 1 to about 90 days, about 1 to about 80 days, about 1 to about 70 days, about 1 to about 60 days, about 1 to about 50 days, about 1 to about 40 days, about 1 to about 30 days, about 1 to about 25 days, about 1 to about 20 days, about 1 to about 15 days, about 1 to about 10 days, about 1 to about 5 days, about 5 to about 120 days, about 5 to about 110 days, about 5 to about 100 days, about 5 to about 90 days, about 5 to about 80 days, about 5 to about 70 days, about 5 to about 60 days, about 5 to about 50 days, about 5 to about 40 days, about 5 to about 30 days, about 5 to about 25 days, about 5 to about 20 days, about 5 to about 15 days, about 5 to about 10 days, about 10 to about 120 days, about 10 to about 110 days, about 10 to about 100 days, about 10 to about 90 days, about 10 to about 80 days, about 10 to about 70 days, about 10 to about 60 days, about 10 to about 50 days, about 10 to about 40 days, about 10 to about 30 days, about 10 to about 25 days, about 10 to about 20 days, about 20 to about 120 days, about 20 to about 110 days, about 20 to about 100 days, about 20 to about 90 days, about 20 to about 80 days, about 20 to about 70 days, about 20 to about 60 days, about 20 to about 50 days, about 20 to about 40 days, or about 20 to about 30 days. A container containing the produce can be transported or shipped (e.g., while the produce is stored therein). For instance, the container, including the produce therein, can be transported from a first location to a second location, and optionally to a third location, or any number of locations. The produce can be stored at a relative humidity of less than about 90% (e.g., less than 90%) during the transporting from the first location to the second location, and so on. The produce can be stored in a container, and at least about 20%, at least about 30%, at least about 40%, at least about 50%, at least about 60%, at least about 70%, at least about 80%, or at least about 90% of the volume of the container can be filled with the produce. The produce can be stored in a container, and the container can include a humidity controller configured to maintain a humidity level within the container at the average relative humidity level.

The produce can be stored in a container, where the humidity level within the container is different from the ambient humidity around the container. The humidity level within the container can be greater than the ambient humidity around the container. The produce can be stored in a container, and the container can include a humidity controller configured to maintain a temperature within the container that is within a predetermined temperature range, for example within a range of −4° C. to 8° C.

The average relative humidity level in the container (e.g., for the shipment of produce after coating of the produce with a composition described herein) can be about 90% or lower. The average relative humidity level in the container (e.g., for the shipment of produce after coating of the produce with a composition described herein) can be sufficiently low to suppress fungal growth in the produce during storage. The average relative humidity level in the container can be below conventional industry standards for shipment of produce.

The coating agent can be formulated to reduce water loss from the produce (e.g., during shipment or storage). The coating agent can include at least one of monomers, oligomers, low molecular weight polymers, fatty acids, and esters. In some embodiments, the coating agent includes monoacylglycerides. The coating can further serve to prevent molding of the produce. The coating can further serve to prevent bacterial growth on the produce. The coating can be formed over a cuticular layer of the produce.

The compositions and formulations described herein can include compounds of Formula I, I-A and/or Formula I-B, as set forth below. The mass ratio of the compound of Formula I-B to the compound of Formula I-A in the compositions or formulations can be in a range of 0.1 to 1.0 or in a range of 0.2 to 0.7. The coating can be formed on the produce by dissolving the coating agent in a solvent to form a solution, applying the solution to the surface of the produce, and allowing at least a portion of the solvent to evaporate. The solvent can include at least one of ethanol and water. The average relative humidity level for the shipment of produce coated with a composition of the present disclosure can be less than about 85%, less than about 80%, less than about 75%, less than about 70%, less than about 65%, less than about 60%, less than about 55%, less than about 50%, less than about 45%, less than about 40%, less than about 35%, less than about 30%, less than about 25%, less than about 20%, less than about 15%, less than about 10%, or less than about 5%. The average relative humidity level can be in a range of about 55% to about 90%, about 60% to about 85%, about 65% to about 80%, or about 65% to about 75%.

The method can further comprise storing the produce at a temperature range of about −4° C. to about 8° C., about −2° C. to about 8° C., about −2° C. to about 6° C., or about −1° C. to about 8° C. The protective coating can have a thickness greater than about 0.1 microns. The protective coating can have a thickness less than about 1 micron. The protective coating can have an average transmittance of at least about 60% for light in the visible range. The coating can be substantially undetectable to the human eye, and/or can be substantially odorless or tasteless. The produce can be stored in a container at the average relative humidity level for at least about 20 days (e.g., at least about 25 days, at least about 30 days, about 20 to about 60 days), and the method can further include removing the produce from the container after the at least about 20 days (or at least about 25 days, at least about 30 days, about 20 to about 60 days), wherein the produce has a first mass when placed in the container and a second mass upon removal of the container, wherein the second mass is within about 30% (e.g., within about 28%, within about 26%, within about 25%, within about 24%, within about 23%, within about 22%, within about 21% or within about 20%) of the first mass.

As used herein, the term “relative humidity” (or “RH”) is defined as a ratio, expressed as a percentage, of the partial pressure of water vapor present in air to the equilibrium vapor pressure (i.e., the partial pressure of water vapor needed for saturation) at the same temperature.

As used herein, the terms “about” and “approximately” generally mean plus or minus 2% of the value stated, e.g., about 50% relative humidity would include 49% to 51% relative humidity. In regards to temperature, the terms “about” and “approximately” generally mean plus or minus 1% of the stated absolute temperature (as measured in Kelvin). For example, about 10° C. (283.15 K) would include 7.17° C. to 12.83° C. (280.32 K to 285.98 K).

As used herein, a “coating” or “protective coating” is understood to mean a layer of monomers, oligomers, low molecular weight polymers, or combinations thereof disposed over and substantially covering a surface of an agricultural product, such as a piece of produce. The monomers, oligomers, low molecular weight polymers, or combinations thereof can be, for example, of the Formula I, I-A and/or Formula I-B as set forth below.

As used herein, a “first relative humidity” or “first relative humidity level” can be understood as an industry standard relative humidity level for storage or shipment of produce. In some embodiments, a first humidity level can be higher than ambient (e.g., atmospheric) humidity. For instance, a first humidity level can be a relative humidity of about 100%, about 99%, about 98%, about 97%, about 96%, about 95%, about 94%, about 93%, about 92%, about 91%, about 90%, or about 85%. In some embodiments, it is customary (e.g., an industry standard) to ship or store produce at about 80% to 95% relative humidity. In some embodiments, the first humidity is maintained at a relatively high level in order to prevent or mitigate substantial moisture loss from the produce. However, as explained herein, a high “first humidity” can enable and promote the growth of biotic stressors such as fungi and bacteria that can lead to unwanted spoilage of the produce.

As used herein, a “coating agent” refers to a chemical formulation that can be used to coat the surface of a substrate (e.g., after removal of a solvent in which the coating agent is dispersed) to form a coating (e.g., a protective coating) on the surface of produce. The coating agent can comprise one or more coating components. For example, the coating components can be compounds of Formula I, I-A and/or Formula I-B, or monomers or oligomers of compounds of Formula I, I-A and/or Formula I-B. Coating components can also comprise fatty acids, fatty acid esters, fatty acid amides, amines, thiols, carboxylic acids, ethers, aliphatic waxes, alcohols, salts (inorganic and organic), or combinations thereof.

The coating agent can comprise a plurality of monomers, oligomers, fatty acids, esters, amides, amines, thiols, carboxylic acids, ethers, aliphatic waxes, alcohols, salts, or combinations thereof. The coating agent can be a non-sanitizing coating agent. The solvent in which the coating agent is dissolved can comprise water and/or an alcohol. The solvent in which the coating agent is dissolved can comprise or be formed of a sanitizing agent. For example, the solvent can comprise ethanol, methanol, acetone, isopropanol, or ethyl acetate. Sanitizing the produce or edible product can result in a reduction in a rate of fungal growth on the produce or edible product, or in an increase in the shelf life of the produce or edible product prior to fungal growth.

The term “alkyl” refers to a straight or branched chain saturated hydrocarbon. C₁-C₆ alkyl groups contain 1 to 6 carbon atoms. Examples of a C₁-C₆ alkyl group include, but are not limited to, methyl, ethyl, propyl, butyl, pentyl, isopropyl, isobutyl, sec-butyl and tert-butyl, isopentyl and neopentyl.

The term “alkenyl” means an aliphatic hydrocarbon group containing a carbon-carbon double bond and which may be straight or branched having about 2 to about 6 carbon atoms in the chain. Preferred alkenyl groups have 2 to about 4 carbon atoms in the chain. Branched means that one or more lower alkyl groups such as methyl, ethyl, or propyl are attached to a linear alkenyl chain. Exemplary alkenyl groups include ethenyl, propenyl, n-butenyl, and i-butenyl. A C₂-C₆ alkenyl group is an alkenyl group containing between 2 and 6 carbon atoms. As defined herein, the term “alkenyl” can include both “E” and “Z” or both “cis” and “trans” double bonds.

The term “alkynyl” means an aliphatic hydrocarbon group containing a carbon-carbon triple bond and which may be straight or branched having about 2 to about 6 carbon atoms in the chain. Preferred alkynyl groups have 2 to about 4 carbon atoms in the chain. Branched means that one or more lower alkyl groups such as methyl, ethyl, or propyl are attached to a linear alkynyl chain. Exemplary alkynyl groups include ethynyl, propynyl, n-butynyl, 2-butynyl, 3-methylbutynyl, and n-pentynyl. A C₂-C₆ alkynyl group is an alkynyl group containing between 2 and 6 carbon atoms.

The term “cycloalkyl” means monocyclic or polycyclic saturated carbon rings containing 3-18 carbon atoms. Examples of cycloalkyl groups include, without limitations, cyclopropyl, cyclobutyl, cyclopentyl, cyclohexyl, cycloheptanyl, cyclooctanyl, norboranyl, norborenyl, bicyclo[2.2.2]octanyl, or bicyclo[2.2.2]octenyl. A C₃-C₈ cycloalkyl is a cycloalkyl group containing between 3 and 8 carbon atoms. A cycloalkyl group can be fused (e.g., decalin) or bridged (e.g., norbornane).

The term “aryl” refers to cyclic, aromatic hydrocarbon groups that have 1 to 2 aromatic rings, including monocyclic or bicyclic groups such as phenyl, biphenyl or naphthyl. Where containing two aromatic rings (bicyclic, etc.), the aromatic rings of the aryl group may be joined at a single point (e.g., biphenyl), or fused (e.g., naphthyl). The aryl group may be optionally substituted by one or more substituents, e.g., 1 to 5 substituents, at any point of attachment.

The term “heteroaryl” means a monovalent monocyclic or bicyclic aromatic radical of 5 to 12 ring atoms or a polycyclic aromatic radical, containing one or more ring heteroatoms selected from N, O, or S, the remaining ring atoms being C. Heteroaryl as herein defined also means a bicyclic heteroaromatic group wherein the heteroatom(s) is selected from N, O, or S. The aromatic radical is optionally substituted independently with one or more substituents described herein.

As used herein, the term “halo” or “halogen” means fluoro, chloro, bromo, or iodo.

The following abbreviations are used throughout. Hexadecanoic acid (i.e., palmitic acid) is abbreviated to PA. Octadecanoic acid (i.e., stearic acid) is abbreviated to SA. Tetradecanoic acid (i.e., myristic acid) is abbreviated to MA. (9Z)-Octadecenoic acid (i.e., oleic acid) is abbreviated to OA. 1,3-dihydroxypropan-2-yl palmitate (i.e., 2-glycero palmitate) is abbreviated to PA-2G. 1,3-dihydroxypropan-2-yl octadecanoate (i.e., 2-glycero stearate) is abbreviated to SA-2G. 1,3-dihydroxypropan-2-yl tetradecanoic acid (i.e., 2-glycero myristate) is abbreviated to MA-2G. 1,3-dihydroxypropan-2-yl (9Z)-Octadecenoate (i.e., 2-glycero oleate) is abbreviated to OA-2G. 2,3-dihydroxypropan-2-yl palmitate (i.e., 1-glycero palmitate) is abbreviated to PA-1G. 2,3-dihydroxypropan-2-yl octadecanoate (i.e., 1-glycero stearate) is abbreviated to SA-1G. 2,3-dihydroxypropan-2-yl tetradecanoate (i.e., 1-glycero myristate) is abbreviated to MA-1G. 2,3-dihydroxypropan-2-yl (9Z)-Octadecenoate (i.e., 1-glycero oleate) is abbreviated to OA-1G. Ethyl hexadecanoate (i.e., ethyl palmitate) is abbreviated to EtPA.

### BRIEF DESCRIPTION OF THE DRAWINGS

FIG. 1 shows a flow-chart diagramming a process for reducing spoilage of produce by coating the produce with a coating agent, according to an embodiment.

FIG. 2 is a plot of rates of molding in groups of blueberries stored at various relative humidities when damaged on the top.

FIG. 3 is a plot of rates of molding in groups of blueberries stored at various relative humidities when damaged on the bottom.

FIG. 4 is a plot of rates of molding in groups of unwounded blueberries stored at various relative humidities.

FIG. 5 shows high resolution time lapse photographs of lemons, both with and without coatings formed of compounds described herein.

FIG. 6 is a normalized plot of the cross-sectional areas of the lemons coated with and without compounds described herein as a function of time.

FIG. 7A is a plot of average mass loss rates of uncoated strawberries and of strawberries that have been coated with a coating agent comprising C₁₆ glycerol esters.

FIG. 7B shows high resolution time lapse photographs of strawberries, both with and without coatings formed of compounds described herein.

FIG. 8 is a plot of the percent mass loss of blueberries with and without coatings formed of the compounds described herein as a function of time.

FIG. 9 shows high resolution photographs of blueberries, both with and without coatings formed of compounds described herein after five days.

FIG. 10 shows a bar graph showing average mass loss rates of sanitized blueberries with and without coatings formed of the compounds described herein and stored at various relative humidity levels.

FIG. 11 shows a bar graph showing average mass loss rates of unsanitized blueberries with and without coatings formed of the compounds described herein and stored at various relative humidity levels.

FIG. 12 shows a plot of molding rates of coated and uncoated blueberries stored at ambient temperature and 75% relative humidity.

FIG. 13 shows a plot of molding rates of coated and uncoated blueberries stored at ambient temperature and 85% relative humidity.

FIG. 14 shows a plot of molding rates of coated and uncoated blueberries stored at ambient temperature and 100% relative humidity.

FIG. 15 shows a plot of molding rates of coated and uncoated blueberries stored at 2° C. and 75% relative humidity.

FIG. 16 shows a plot of molding rates of coated and uncoated blueberries stored at 2° C. and 85% relative humidity.

FIG. 17 shows a plot of molding rates of coated and uncoated blueberries stored at 2° C. and 100% relative humidity.

FIG. 18 shows a plot of mass loss rates per day for finger limes coated with 1-glycerol and 2-glycerol esters of palmitic acid.

FIG. 19 shows a plot of the shelf life factor of avocados coated with coatings formed of 2-glycerol esters of palmitic acid and 1-glycerol esters of myristic acid, palmitic acid, and stearic acid.

FIG. 20 shows a plot of the shelf life factor of avocados coated with coatings formed of 2-glycerol esters of palmitic acid and a fatty acid additive, the fatty acid additive being myristic acid, palmitic acid, or stearic acid.

FIG. 21 shows a plot of the shelf life factor for avocados coated with compositions comprising 2-glycerol esters of palmitic acid combined with ethyl palmitate and oleic acid. FIG. 21 also shows a plot of the shelf life factor for avocados coated with compositions comprising 1-glycerol esters of stearic acid combined with a fatty acid additive, the fatty acid additive being myristic acid, palmitic acid, or stearic acid.

FIG. 22 shows a plot of the shelf life factor for avocados coated with 1-glycerol esters of myristic acid, palmitic acid, or stearic acid in various combination with myristic acid, palmitic acid, and stearic acid.

FIG. 23 shows a plot of the shelf life factor for avocados coated with various mixtures of 1-glycerol esters of stearic acid, palmitic acid, and myristic acid.

FIG. 24 shows a plot of the shelf life factor for avocados coated with mixtures comprising a combination of palmitic acid, 2-glycerol esters of palmitic acid, and 1-glycerol esters of stearic acid.

FIG. 25 shows a plot of the shelf life factor for avocados coated with mixtures comprising a combination of palmitic acid, oleic acid, and 1-glycerol esters of stearic acid.

FIG. 26 is a block diagram of a storage container equipped with humidity and temperature controllers.

### DETAILED DESCRIPTION

Produce and other agricultural products (e.g., fruits, vegetables, roots, tubers, flowers) that are stored after harvesting, for example as a result of excess production or during shipping, are typically densely packed into storage bins, containers, or modified atmospheric packaging (MAP), and maintained at high average relative humidity (RH) levels (e.g., greater than 90% average relative humidity). The high relative humidity levels reduce the rate at which the agricultural products lose mass and water over time, thereby allowing the agricultural products to be of acceptably high quality when they are sold after storage and/or shipping, and preventing sellers and shippers from having to over pack the containers in order to provide a desired produce mass at the point of sale. However, such high humidity conditions can facilitate the growth of pathogens such as mold, fungi, and bacteria. The effects can be exacerbated particularly at high packing densities, thereby resulting in a high rate of spoilage.

Table 3 below is a compilation of recommended conditions, including recommended relative humidity, for long term storage of fresh fruits and vegetables. The recommended storage conditions for most types of produce represents a compromise between preventing mass loss from the produce during storage and minimizing the risk of growth of postharvest pathogens. Specifically, most produce items would benefit from nearly saturated environments (e.g., an in-package relative humidity of at least 95%) in order to minimize mass loss during storage. However, such high RH levels can create environments that run serious risk of growth of fungi and other postharvest pathogens (e.g., mold, bacteria), especially should condensation form on the surface of the produce or in any packaging within which the produce is stored, or should the produce experience damage at its surfaces due to high packing densities or handling of the produce. Furthermore, it can be quite difficult to precisely control the relative humidity at such high levels throughout a storage or shipping container, and so local RH variations can further exacerbate the risks of condensation formation. As such, improved methods for decreasing the rate of spoilage while maintaining high quality produce, with minimal loss in mass/moisture during storage and shipping, are desirable.

Described herein are methods of reducing spoilage in harvested produce and other agricultural products without increasing the rate of water or mass loss, thereby resulting in high quality produce with both reduced mass loss and lower rates of spoilage. Prior to packing the produce into a storage/shipping container, a protective coating is formed over the surface of the produce, which serves as a barrier to moisture transfer, as further described below. The protective coating serves to reduce the mass loss rate of the produce, even if the produce is kept at a lower average relative humidity level (e.g., less than about 90%, about 85%, about 80%, about 75%, about 70%, about 65%, about 60%, about 55%, about 50%, about 45%, about 40%, about 35% about 30%, about 25%, about 20%, about 15%, about 10%, or about 5% relative humidity, or in a range of about 40% to about 90%, about 45% to about 90%, about 50% to about 90%, about 55% to about 90%, about 60% to about 90%, about 65% to about 90%, about 70% to about 90%, about 75% to about 90%, about 80% to about 90%, about 40% to about 85%, about 45% to about 85%, about 50% to about 85%, about 55% to about 85%, about 60% to about 85%, about 65% to about 85%, about 70% to about 85%, about 75% to about 85%, about 80% to about 85%, about 40% to about 80%, about 45% to about 80%, about 50% to about 80%, about 55% to about 80%, about 60% to about 80%, about 65% to about 80%, about 70% to about 80%, about 40% to about 75%, about 45% to about 75%, about 50% to about 75%, about 55% to about 75%, about 60% to about 75%, or about 65% to about 75% relative humidity). The produce is subsequently maintained at the lower average RH level (e.g., less than about 90%, about 85%, about 80%, about 75%, about 70%, about 65%, about 60%, about 55%, about 50%, about 45%, about 40%, about 35% about 30%, about 25%, about 20%, about 15%, about 10%, or about 5% relative humidity, or in a range of about 40% to about 90%, about 45% to about 90%, about 50% to about 90%, about 55% to about 90%, about 60% to about 90%, about 65% to about 90%, about 70% to about 90%, about 75% to about 90%, about 80% to about 90%, about 40% to about 85%, about 45% to about 85%, about 50% to about 85%, about 55% to about 85%, about 60% to about 85%, about 65% to about 85%, about 70% to about 85%, about 75% to about 85%, about 80% to about 85%, about 40% to about 80%, about 45% to about 80%, about 50% to about 80%, about 55% to about 80%, about 60% to about 80%, about 65% to about 80%, about 70% to about 80%, about 40% to about 75%, about 45% to about 75%, about 50% to about 75%, about 55% to about 75%, about 60% to about 75%, or about 65% to about 75% relative humidity) during storage/shipping. The reduced relative humidity level during storage and/or shipping can result in a lower rate of spoilage (e.g., spoilage caused by biotic stressors), while the protective coating prevents higher rates of water and mass loss at the lower relative humidity levels, and in some cases can reduce water and mass loss as compared to uncoated produce that is stored at a higher average relative humidity. As such, the quality of the stored produce can be maintained while at the same time mass/water loss is minimized and spoilage rates are reduced.

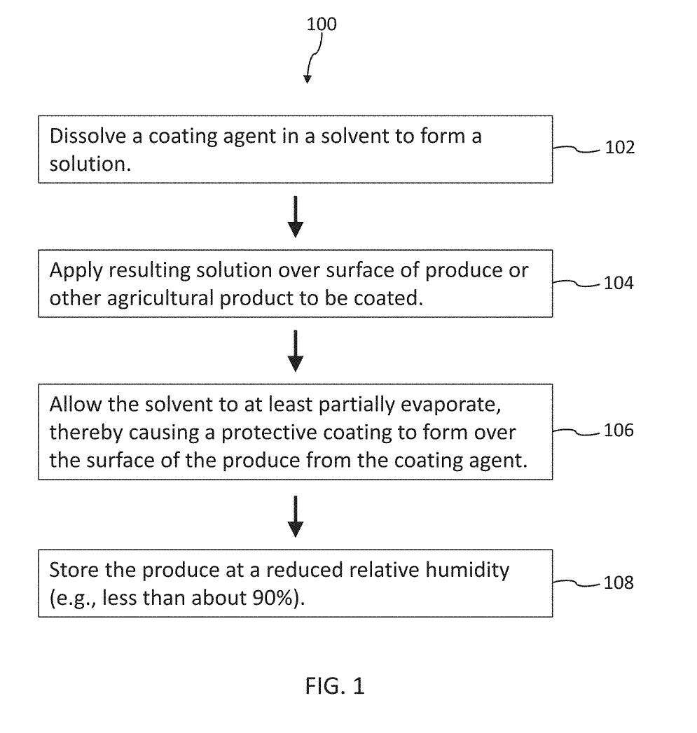

FIG. 1 illustrates a process 100 for preparing produce for storage and subsequently storing the produce such that mass/water loss is minimized and at the same time the spoilage rate is reduced. First, a solid mixture of a coating agent (e.g., a composition of monomer and/or oligomer, and/or polymer units) is dissolved in a solvent (e.g., ethanol, methanol, acetone, isopropanol, ethyl acetate, water, or combinations thereof) to form a solution (step 102). The concentration of the coating agent in the solvent can, for example, be in a range of about 0.1 to 200 mg/mL. Next, the solution, which includes the coating agent, is applied over the surface of the produce or other agricultural product to be coated (step 104), for example by spray coating the produce/product or by dipping the produce/product in the solution. In the case of spray coating, the solution can, for example, be placed in a spray bottle that generates a fine mist spray. The spray bottle head can then be held approximately three to twelve inches from the produce/product, and the produce/product then sprayed. In the case of dip coating, the produce/product can, for example, be placed in a bag, the solution containing the coating agent poured into the bag, and the bag then sealed and its contents lightly tumbled or agitated until the entire surface of the produce/product is wet. After applying the solution to the produce/product, the produce/product is allowed to dry until the solvent has at least partially evaporated, thereby allowing a protective coating composed of the constituents of the coating agent (e.g., monomer and/or oligomer and/or polymer units) to form over the surface of the produce/product (step 106). Finally, the coated produce/product is stored at a reduced relative humidity than would otherwise be required to allow for a sufficiently low rate of water/mass loss (e.g., an average relative humidity level less 90% or less than about 90%).

The process steps 102, 104, 106, and 108 of process 100 (FIG. 1) and their associated processing agents and resultant coatings are now described in further detail. The coating agent that is dissolved in the solvent (step 102) can include a plurality of monomers, oligomers, polymers, fatty acids, esters, triglycerides, diglycerides, monoglycerides, amides, amines, thiols, thioesters, carboxylic acids, ethers, aliphatic waxes, alcohols, salts (inorganic and organic), acids, bases, proteins, enzymes, or combinations thereof (e.g., Figure I, I-A and/or I-B). The specific composition of monomers, oligomers, polymers, fatty acids, esters, triglycerides, diglycerides, monoglycerides, amides, amines, thiols, thioesters, carboxylic acids, ethers, aliphatic waxes, alcohols, salts (inorganic and organic), acids, bases, proteins, enzymes, or combinations thereof can be formulated such that the resulting coating formed over the agricultural product (during step 106) mimics or enhances the cuticular layer of the product. The biopolyester cutin forms the main structural component of the cuticle that composes the aerial surface of most land plants. Cutin is formed from a mixture of polymerized mono- and/or polyhydroxy fatty acids and esters, as well as embedded cuticular waxes. The hydroxy fatty acids and esters of the cuticle layer form tightly bound networks with high crosslink density, thereby acting as a barrier to moisture loss and oxidation, as well as providing protection against other environmental stressors.

The monomers, oligomers, polymers, fatty acids, esters, triglycerides, diglycerides, monoglycerides, amides, amines, thiols, thioesters, carboxylic acids, ethers, aliphatic waxes, alcohols, salts (inorganic and organic), acids, bases, proteins, enzymes, or combinations thereof of which the coating agent is comprised can be extracted or derived from plant matter, and in particular from cutin obtained from plant matter. Plant matter typically includes some portions that contain cutin and/or have a high density of cutin (e.g., fruit peels, leaves, shoots, etc.), as well as other portions that do not contain cutin or have a low density of cutin (e.g., fruit flesh, seeds, etc.). The cutin-containing portions can be formed from the monomer and/or oligomer and/or polymer units that are subsequently utilized in the formulations described herein for forming the coatings over the surface of the agricultural products. The cutin-containing portions can also include other constituents such as non-hydroxylated fatty acids and esters, proteins, polysaccharides, phenols, lignans, aromatic acids, terpenoids, flavonoids, carotenoids, alkaloids, alcohols, alkanes, and aldehydes, which may be included in the formulations or may be omitted.

The monomers, oligomers, polymers, or combinations thereof can be obtained by first separating (or at least partially separating) portions of the plant that include molecules desirable for the coating agents from those that do not include the desired molecules. For example, when utilizing cutin as the feedstock for the coating agent composition, the cutin-containing portions of the plant matter are separated (or at least partially separated) from non-cutin-containing portions, and cutin is obtained from the cutin-containing portions (e.g., when the cutin-containing portion is a fruit peel, the cutin is separated from the peel). The obtained portion of the plant (e.g., cutin) is then depolymerized (or at least partially depolymerized) in order to obtain a mixture including a plurality of fatty acid or esterified cutin monomers, oligomers, polymers (e.g., low molecular weight polymers), or combinations thereof. The cutin derived monomers, oligomers, polymers, or combinations thereof can be directly dissolved in the solvent to form the solution used in the formation of the coatings, or alternatively can first be activated or chemically modified (e.g., functionalized). Chemical modification or activation can, for example, include glycerating the monomers, oligomers, polymers, or combinations thereof to form a mixture of 1-monoacylglycerides and/or 2-monoacylglycerides, and the mixture of 1-monoacylglycerides and/or 2-monoacylglycerides is dissolved in the solvent to form a solution, thereby resulting in the formulation formed in step 102 of FIG. 1 for preparation of the protective coating.

In some implementations, the coating agent comprises fatty acids, esters, triglycerides, diglycerides, monoglycerides, amides, amines, thiols, thioesters, carboxylic acids, ethers, aliphatic waxes, alcohols, salts (inorganic and organic), acids, bases, proteins, enzymes, or combinations thereof. In some implementations, the coating agent can be substantially similar to or the same as those described in U.S. patent application Ser. No. 15/330,403 (published as US 2017/0073532) entitled “Precursor Compounds for Molecular Coatings,” filed on Sep. 15, 2016, the disclosure of which is incorporated herein by reference in its entirely. For example, the coating agent can include compounds of Formula I:

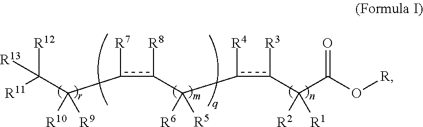

wherein:

R is selected from —H, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl or heteroaryl is optionally substituted with one or more C₁-C₆ alkyl or hydroxy;

R¹, R², R⁵, R⁶, R⁹, R¹⁰, R¹¹, R¹² and R¹³ are each independently, at each occurrence, —H, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with one or more —OR¹⁴, —NR¹⁴R¹⁵, —SR¹⁴, or halogen;

R³, R⁴, R⁷ and R⁸ are each independently, at each occurrence, —H, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with —OR¹⁴, —NR¹⁴R¹⁵, —SR¹⁴, or halogen; or

R³ and R⁴ can combine with the carbon atoms to which they are attached to form a C₃-C₆ cycloalkyl, a C₄-C₆ cycloalkenyl, or a 3- to 6-membered ring heterocycle; and/or

R⁷ and R⁸ can combine with the carbon atoms to which they are attached to form a C₃-C₆ cycloalkyl, a C₄-C₆ cycloalkenyl, or a 3 to 6-membered ring heterocycle;

R¹⁴ and R¹⁵ are each independently, at each occurrence, —H, —C₁-C₆ alkyl, —C₂-C₆ alkenyl, or —C₂-C₆ alkynyl;

the symbol [symbol] represents an optionally single or cis or trans double bond;

n is 0, 1, 2, 3, 4, 5, 6, 7, or 8;

m is 0, 1, 2, or 3;

q is 0, 1, 2, 3, 4, or 5; and

r is 0, 1, 2, 3, 4, 5, 6, 7, or 8.

In some embodiments, R is —H, —CH₃, or —CH₂CH₃.

In some implementations, the coating agent comprises monoacylglyceride (e.g., 1-monoacylglyceride or 2-monoacylglyceride) esters and/or monomers and/or oligomers and/or low molecular weight polymers formed thereof. The difference between a 1-monoacylglyceride and a 2-monoacylglyceride is the point of connection of the glycerol ester. Accordingly, in some embodiments, the coating agent comprises compounds of the Formula I-A (e.g., 2-monoacylglycerides):

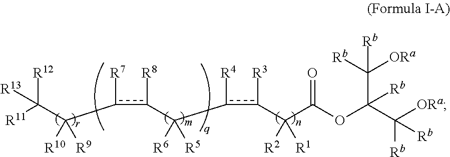

wherein:

each R^{a} is independently —H or —C₁-C₆ alkyl;

each R^{b} is independently selected from —H, —C₁-C₆ alkyl, or —OH;

R¹, R², R⁵, R⁶, R⁹, R¹⁰, R¹¹, R¹² and R¹³ are each independently, at each occurrence, —H, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with one or more —OR¹⁴, —NR¹⁴R¹⁵, —SR¹⁴, or halogen;

R³, R⁴, R⁷, and R⁸ are each independently, at each occurrence, —H, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl wherein each alkyl, alkynyl, cycloalkyl, aryl, or heteroaryl is optionally substituted with one or more —OR¹⁴, —NR¹⁴R¹⁵, —SR¹⁴, or halogen; or

R³ and R⁴ can combine with the carbon atoms to which they are attached to form a C₃-C₆ cycloalkyl, a C₄-C₆ cycloalkenyl, or 3- to 6-membered ring heterocycle; and/or

R⁷ and R⁸ can combine with the carbon atoms to which they are attached to form a C₃-C₆ cycloalkyl, a C₄-C₆ cycloalkenyl, or 3- to 6-membered ring heterocycle;

R¹⁴ and R¹⁵ are each independently, at each occurrence, —H, —C₁-C₆ alkyl, —C₂-C₆ alkenyl, or —C₂-C₆ alkynyl;

the symbol [symbol] represents a single bond or a cis or trans double bond;

n is 0, 1, 2, 3, 4, 5, 6, 7 or 8;

m is 0, 1, 2 or 3;

q is 0, 1, 2, 3, 4 or 5; and

r is 0, 1, 2, 3, 4, 5, 6, 7 or 8.

In some implementations, the coating agent comprises compounds of the Formula I-B (e.g., 1-monoacylglycerides):

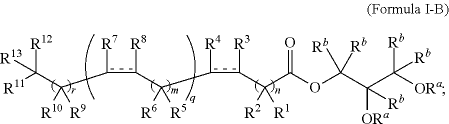

wherein:

each R^{a} is independently —H or —C₁-C₆ alkyl;

each R^{b} is independently selected from —H, —C₁-C₆ alkyl, or —OH;

R¹, R², R⁵, R⁶, R⁹, R¹⁰, R¹¹, R¹² and R¹³ are each independently, at each occurrence, —H, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with one or more —OR¹⁴, —NR¹⁴R¹⁵, —SR¹⁴, or halogen;

R³, R⁴, R⁷, and R⁸ are each independently, at each occurrence, —H, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl wherein each alkyl, alkynyl, cycloalkyl, aryl, or heteroaryl is optionally substituted with one or more —OR¹⁴, —NR¹⁴R¹⁵, —SR¹⁴, or halogen; or

R³ and R⁴ can combine with the carbon atoms to which they are attached to form a C₃-C₆ cycloalkyl, a C₄-C₆ cycloalkenyl, or 3- to 6-membered ring heterocycle; and/or

R⁷ and R⁸ can combine with the carbon atoms to which they are attached to form a C₃-C₆ cycloalkyl, a C₄-C₆ cycloalkenyl, or 3- to 6-membered ring heterocycle;

R¹⁴ and R¹⁵ are each independently, at each occurrence, —H, —C₁-C₆ alkyl, —C₂-C₆ alkenyl, or —C₂-C₆ alkynyl;

the symbol [symbol] represents a single bond or a cis or trans double bond;

n is 0, 1, 2, 3, 4, 5, 6, 7 or 8;

m is 0, 1, 2 or 3;

q is 0, 1, 2, 3, 4 or 5; and

r is 0, 1, 2, 3, 4, 5, 6, 7 or 8.

In some embodiments, the coating agent includes one or more of the following fatty acid compounds:

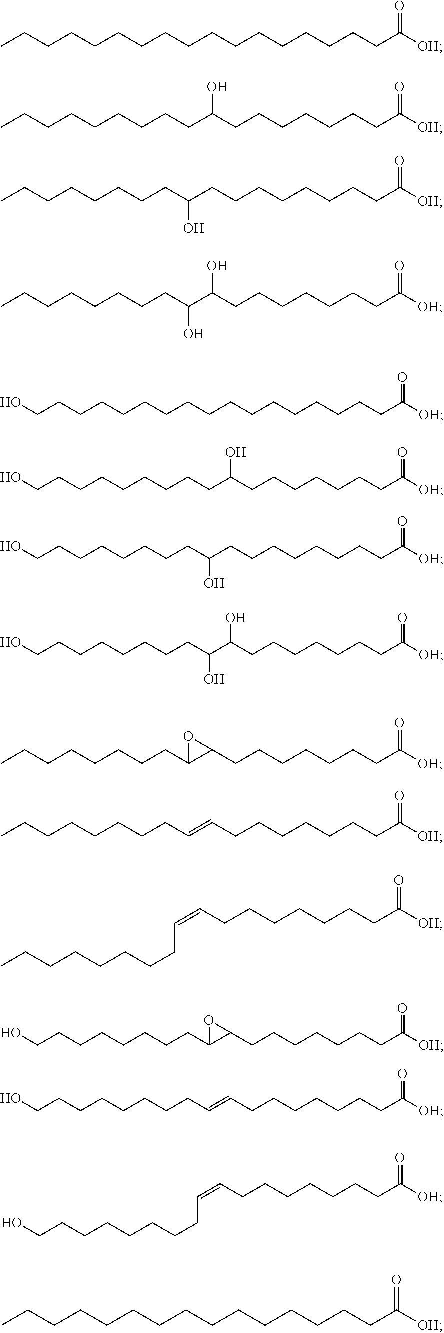

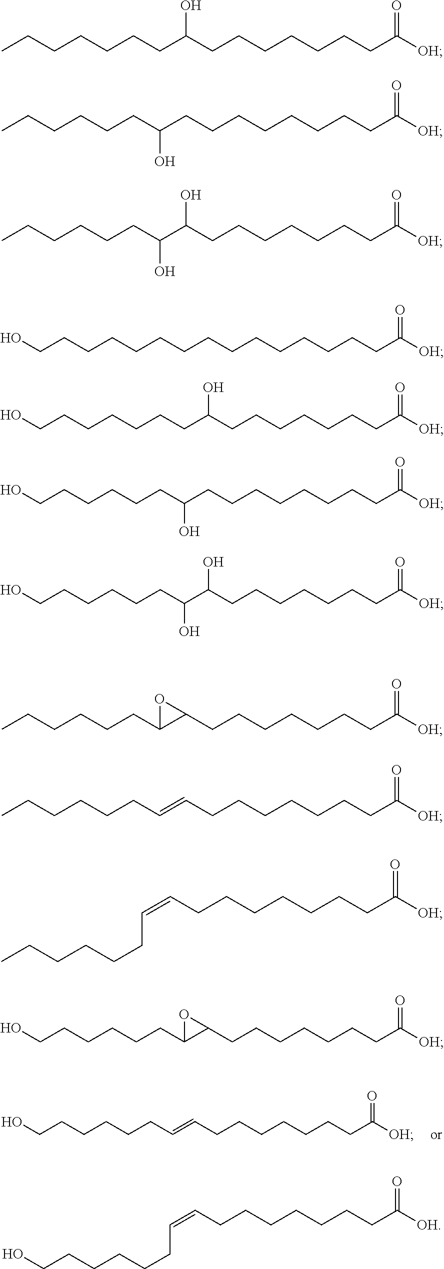

In some embodiments, the coating agent includes one or more of the following methyl ester compounds:

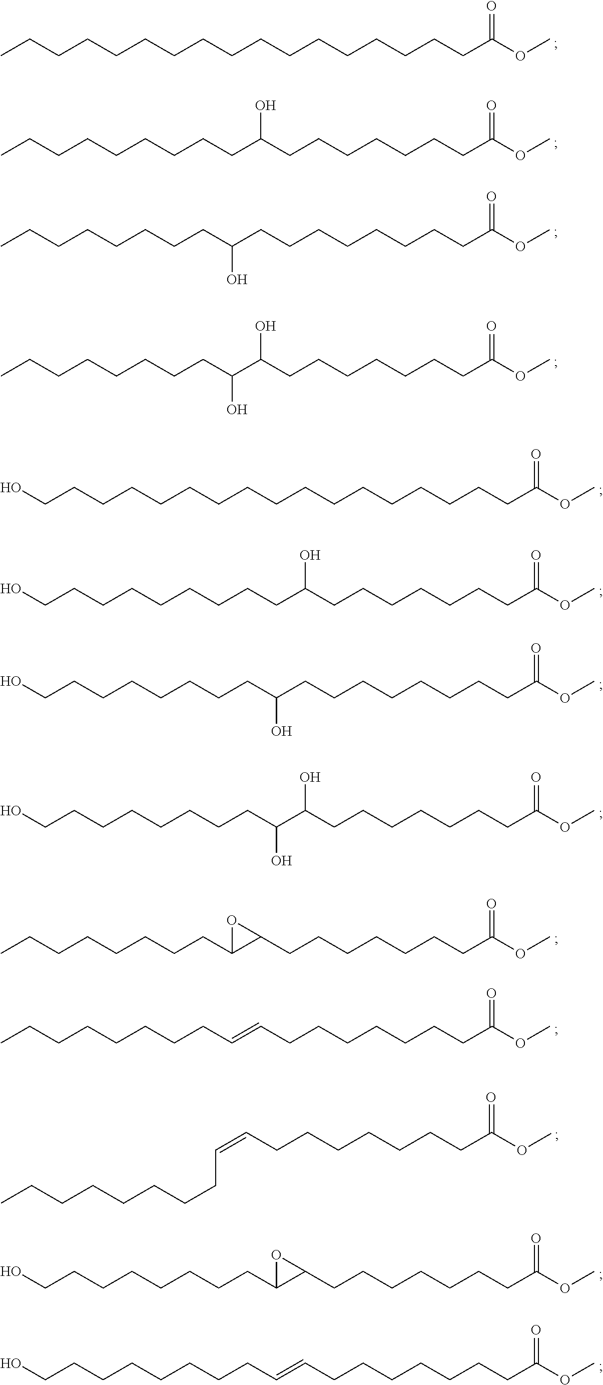

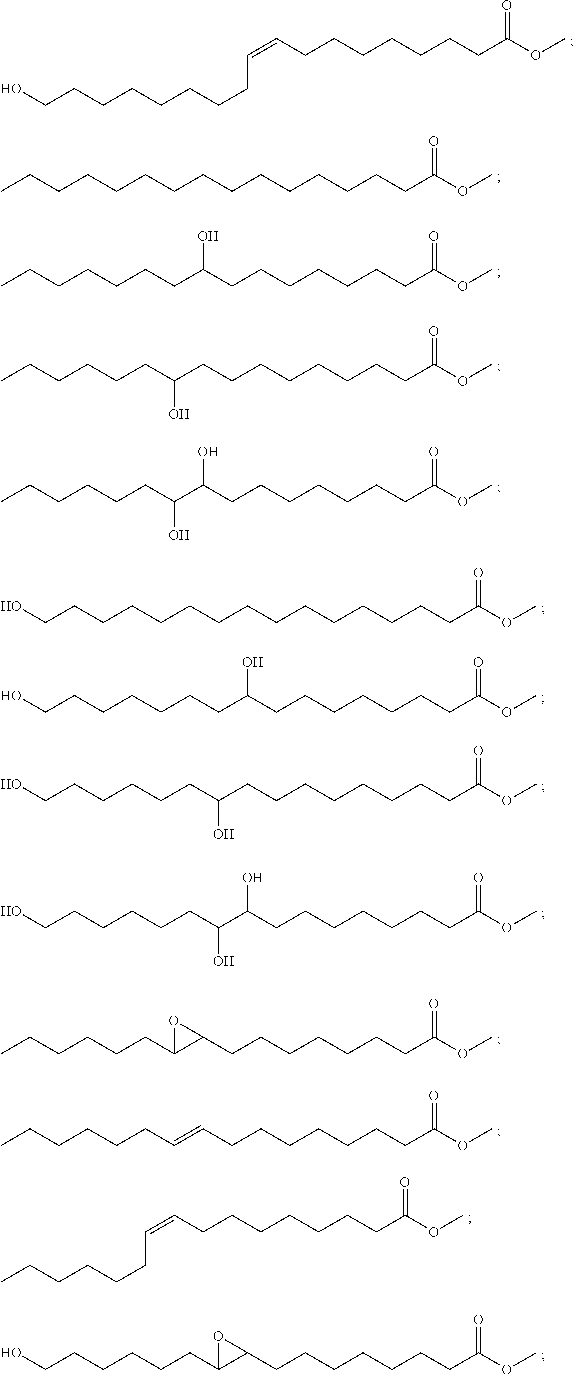

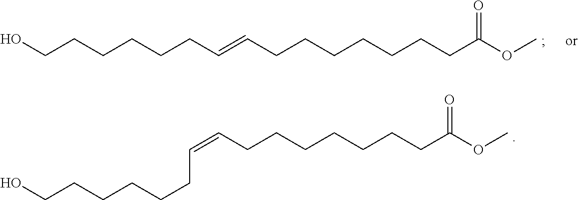

In some embodiments, the coating agent includes one or more of the following ethyl ester compounds:

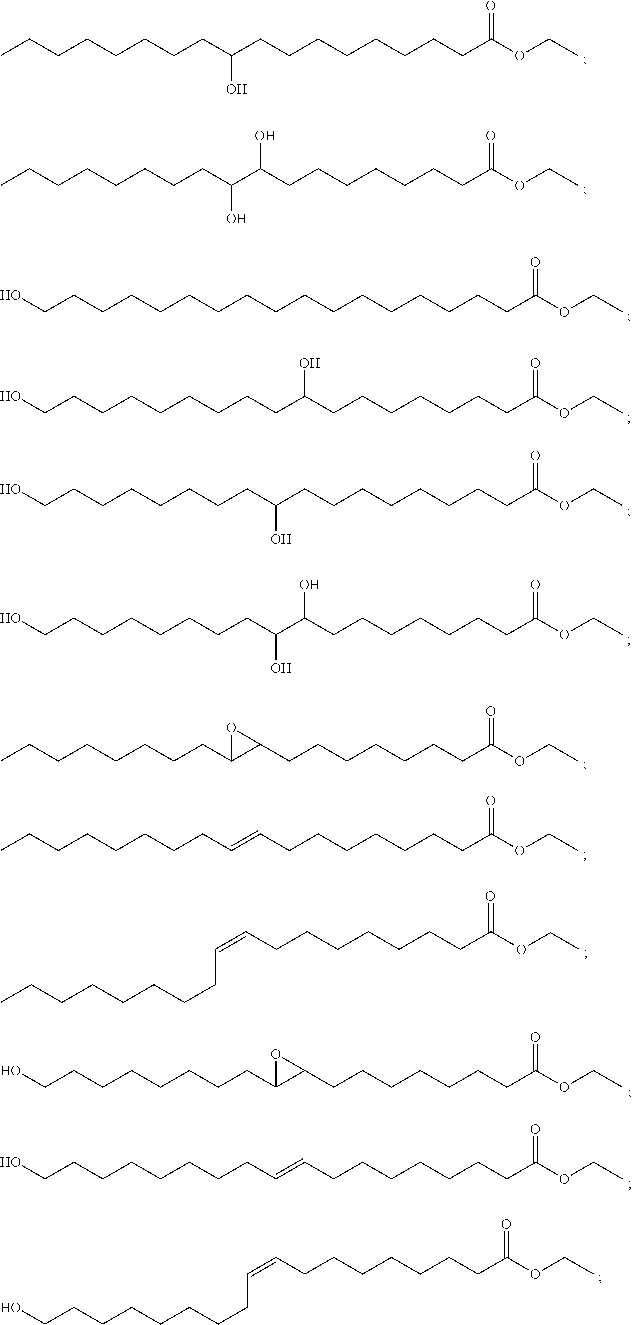

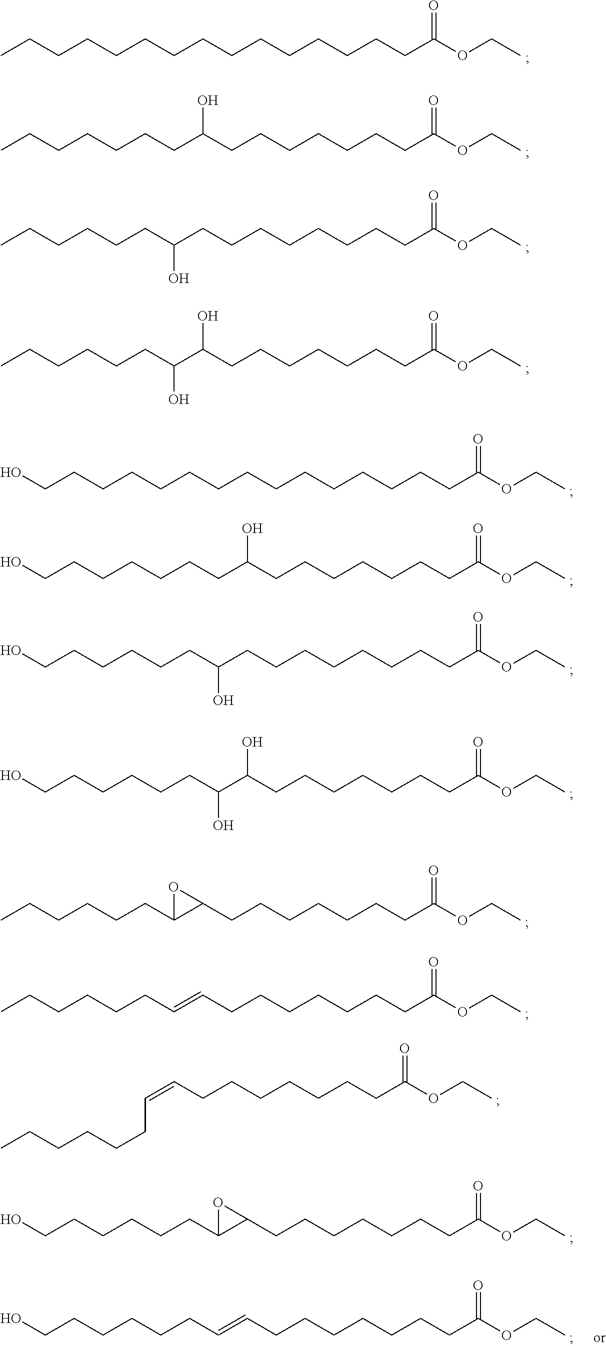

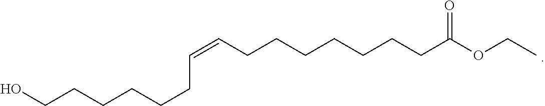 [SMILES: CCOC(=O)CCCCCCC/C=C\CCCCCCO]

In some embodiments, the coating agent includes one or more of the following 2-glycerol ester compounds:

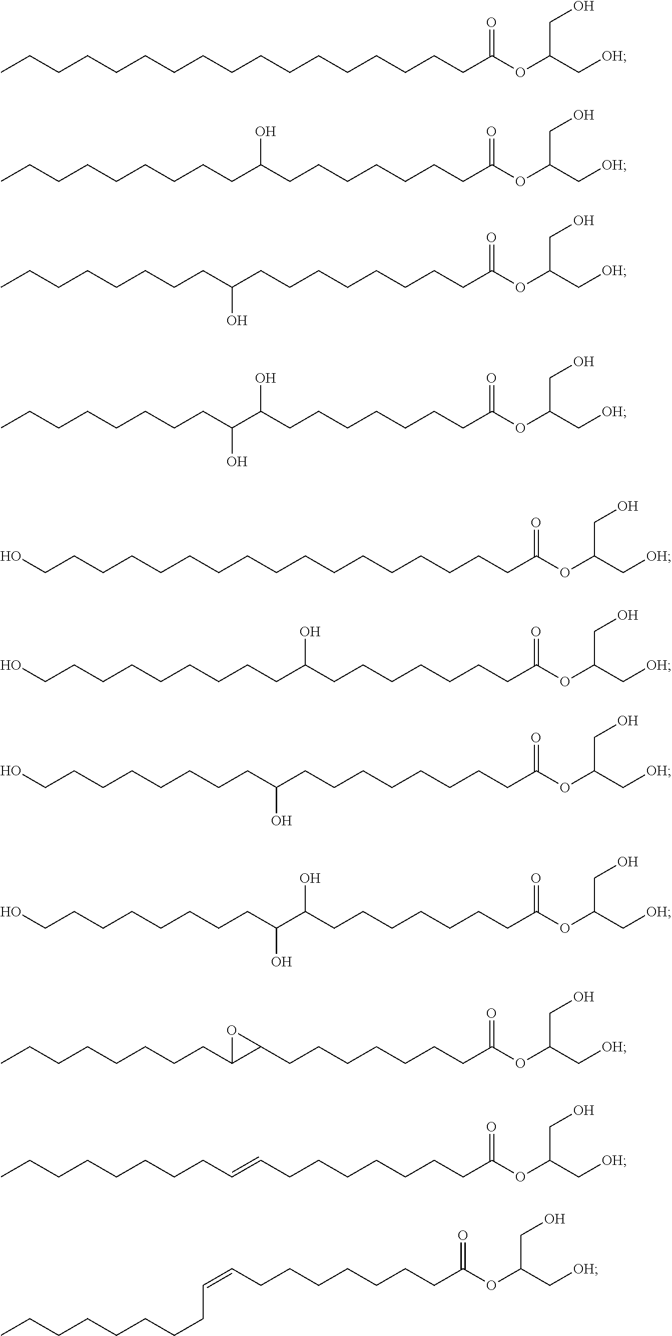

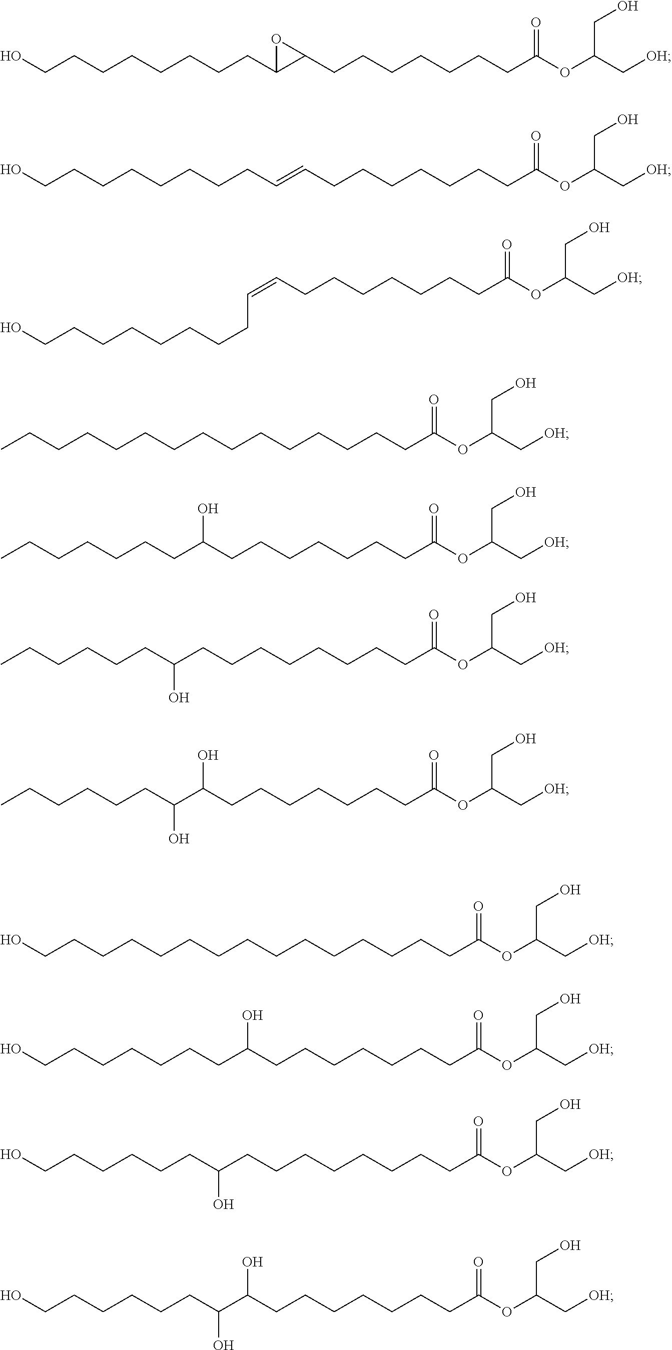

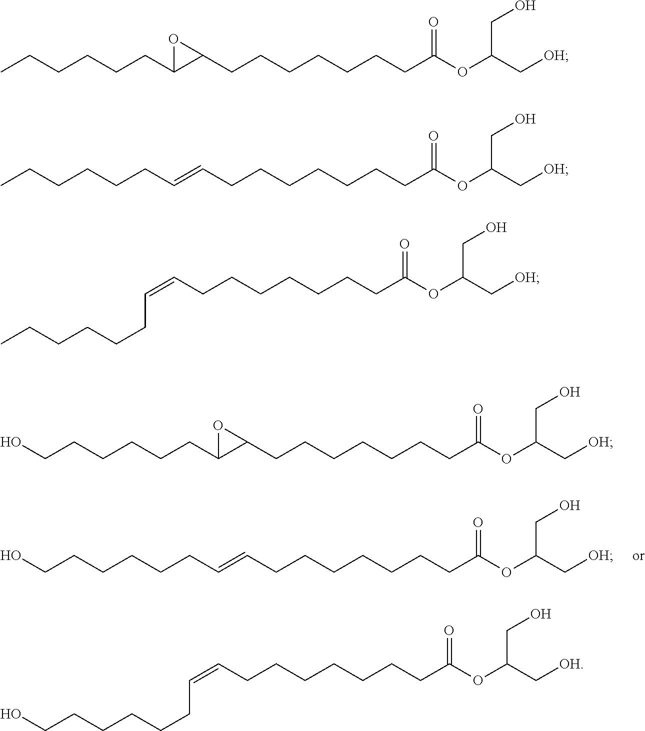 [SMILES: CCCCCCC1OC1CCCCCCCC(=O)OC(CO)CO ; CCCCCC/C=C/CCCCCCCC(=O)OC(CO)CO ; CCCCCC/C=C\CCCCCCCC(=O)OC(CO)CO ; O=C(CCCCCCCC1OC1CCCCCCO)OC(CO)CO ; O=C(CCCCCCC/C=C/CCCCCCO)OC(CO)CO ; O=C(CCCCCCC/C=C\CCCCCCO)OC(CO)CO]

In some embodiments, the coating agent includes one or more of the following 1-glycerol ester compounds:

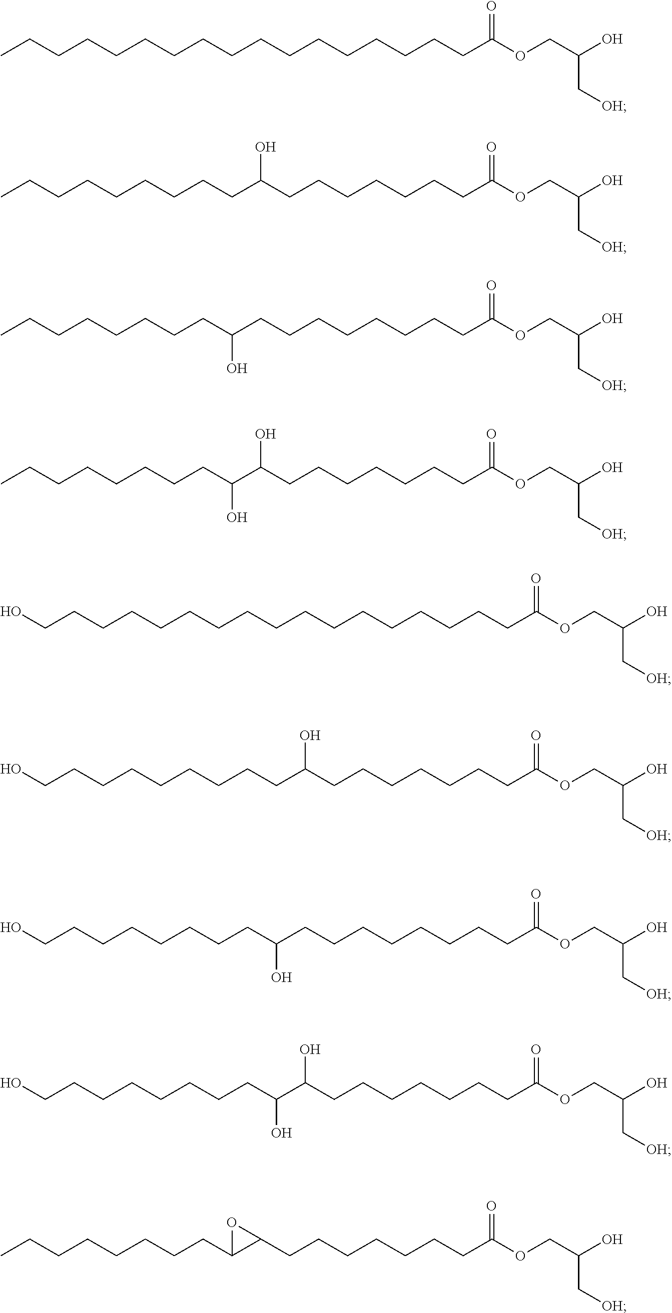

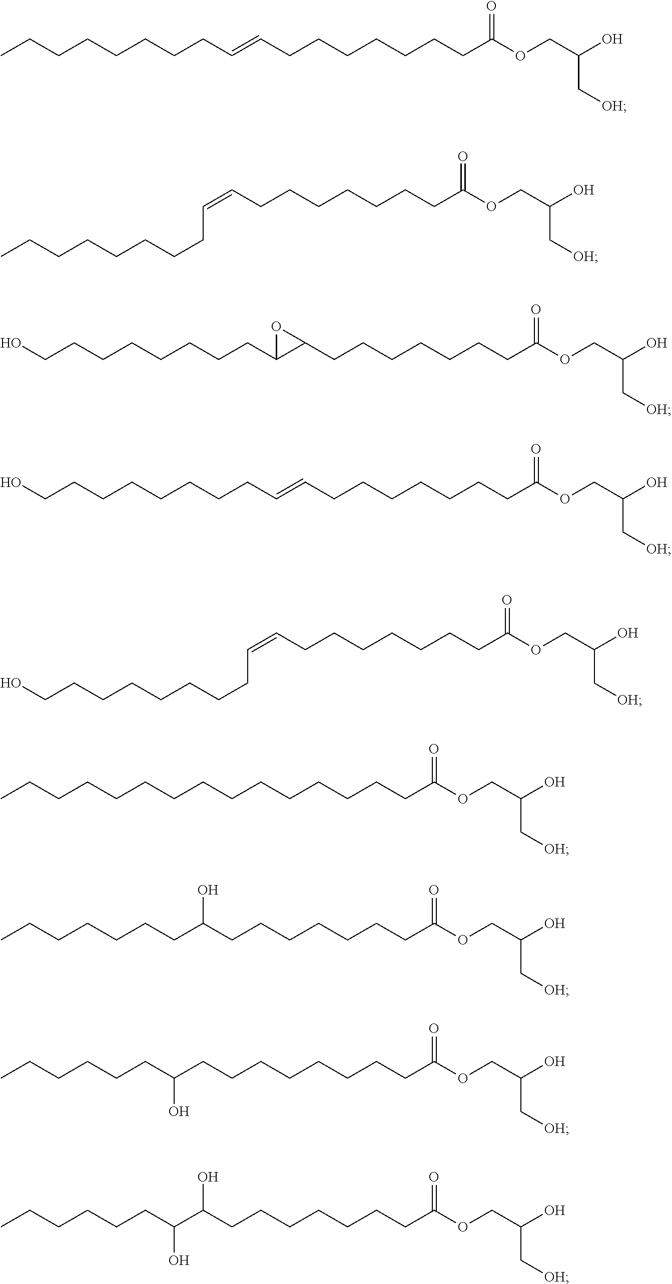

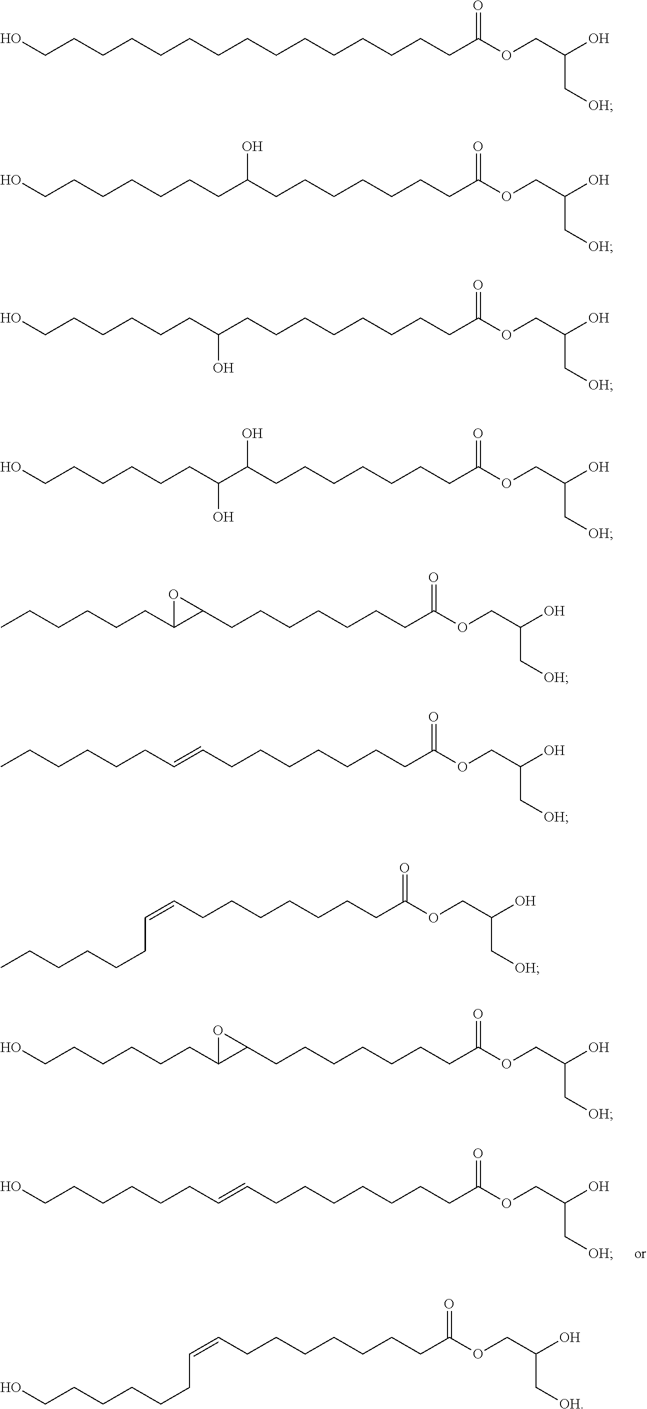

In some embodiments, the coating agent is formed of a combination of at least 2 different compounds. For example, the coating agent can comprise a compound of Formula I-A and an additive. The additive can, for example, include a saturated or unsaturated compound of Formula I-B, a saturated or unsaturated fatty acid, an ethyl ester, or a second compound of Formula I-A which is different from the (first) compound of Formula I-A (e.g., has a different length carbon chain). The compound of Formula I-A can make up at least about 10%, at least about 20%, at least about 30%, at least about 40%, at least about 50%, at least about 60%, at least about 70%, at least about 80%, or at least about 90% of the mass of the coating agent. A combined mass of the compound of Formula I-A and the additive can be at least about 10%, at least about 20%, at least about 30%, at least about 40%, at least about 50%, at least about 60%, at least about 70%, at least about 80%, or at least about 90% of the total mass of the coating agent. A molar ratio of the additive to the compound of Formula I-A in the coating agent can be in a range of 0.1 to 5, for example in a range of about 0.1 to about 4, about 0.1 to about 3, about 0.1 to about 2, about 0.1 to about 1, about 0.1 to about 0.9, about 0.1 to about 0.8, about 0.1 to about 0.7, about 0.1 to about 0.6, about 0.1 to about 0.5, about 0.15 to about 5, about 0.15 to about 4, about 0.15 to about 3, about 0.15 to about 2, about 0.15 to about 1, about 0.15 to about 0.9, about 0.15 to about 0.8, about 0.15 to about 0.7, about 0.15 to about 0.6, about 0.15 to about 0.5, about 0.2 to about 5, about 0.2 to about 4, about 0.2 to about 3, about 0.2 to about 2, about 0.2 to about 1, about 0.2 to about 0.9, about 0.2 to about 0.8, about 0.2 to about 0.7, about 0.2 to about 0.6, about 0.2 to about 0.5, about 0.3 to about 5, about 0.3 to about 4, about 0.3 to about 3, about 0.3 to about 2, about 0.3 to about 1, about 0.3 to about 0.9, about 0.3 to about 0.8, about 0.3 to about 0.7, about 0.3 to about 0.6, about 0.3 to about 0.5, about 1 to about 5, about 1 to about 4, about 1 to about 3, or about 1 to about 2. The coating agent can, for example, be formed from one of the combinations of a compound of Formula I-A and an additive listed in Table 1 below.

TABLE 1
Exemplary Coating Agent Compositions

| Compound of | | |
|---|---|---|
| Formula I-A | Additive | Note |
| SA-2G | SA-1G | Additive is a saturated compound of Formula I-B |
| | | (1-monoacylglyceride) with the same length carbon |
| | | chain as the compound of Formula I-A |
| PA-2G | PA-1G | Additive is a saturated compound of Formula I-B |
| | | (1-monoacylglyceride) with the same length carbon |
| | | chain as the compound of Formula I-A |
| PA-2G | MA-1G | Additive is a saturated compound of Formula I-B |
| | | (1-monoacylglyceride) with a shorter length carbon |
| | | chain than the compound of Formula I-A |
| PA-2G | OA-1G | Additive is an unsaturated compound of Formula I-B |
| | | (1-monoacylglyceride) with a longer length carbon |
| | | chain than the compound of Formula I-A |
| PA-2G | SA-1G | Additive is a saturated compound of Formula I-B |
| | | (1-monoacylglyceride) with a longer length carbon |
| | | chain than the compound of Formula I-A |
| PA-2G | PA | Additive is a saturated fatty acid with the same |
| | | length carbon chain as the compound of Formula I-A |
| PA-2G | OA | Additive is an unsaturated fatty acid with a longer |
| | | length carbon chain than the compound of Formula I-A |
| PA-2G | SA | Additive is a saturated fatty acid with a longer |
| | | length carbon chain than the compound of Formula I-A |
| PA-2G | MA | Additive is a saturated fatty acid with a shorter |
| | | length carbon chain than the compound of Formula I-A |
| PA-2G | OA-2G | Additive is an unsaturated compound of Formula I-A |
| | | (2-monoacylglyceride) with a longer carbon chain |
| | | than PA-2G (Formula I-A) |
| PA-2G | EtPA | Additive is an ethyl ester. |

In some embodiments, the coating agent is formed from one of the combinations of compounds listed in Table 2 below.

TABLE 2
Exemplary Coating Agent Compositions

| Component 1 | Component 2 | (Optional) Component 3 |
|---|---|---|
| SA-1G (Formula I-B) | MA (Fatty acid, shorter length carbon | |
| | chain than compound of Formula I-B) | |
| SA-1G (Formula I-B) | PA (Fatty acid, shorter length carbon | |
| | chain than compound of Formula I-B) | |
| SA-1G (Formula I-B) | SA (Fatty acid, same length carbon | |
| | chain as compound of Formula I-B) | |
| PA-1G (Formula I-B) | MA (Fatty acid, shorter length carbon | |
| | chain than compound of Formula I-B) | |
| PA-1G (Formula I-B) | PA (Fatty acid, same length carbon | |
| | chain as compound of Formula I-B) | |
| PA-1G (Formula I-B) | SA (Fatty acid, longer length carbon | |
| | chain than compound of Formula I-B) | |
| MA-1G (Formula I-B) | MA (Fatty acid, same length carbon | |
| | chain as compound of Formula I-B) | |
| MA-1G (Formula I-B) | PA (Fatty acid, longer length carbon | |
| | chain than compound of Formula I-B) | |
| MA-1G (Formula I-B) | SA (Fatty acid, longer length carbon | |
| | chain than compound of Formula I-B) | |
| SA-1G (First compound | PA-1G (Second compound of Formula | |
| of Formula I-B) | I-B, shorter carbon chain than First | |
| | compound of Formula I-B) | |
| SA-1G (First compound | MA-1G (Second compound of | |
| of Formula I-B) | Formula I-B, shorter carbon chain | |
| | than First compound of Formula I-B) | |
| MA-1G (First compound | PA-1G (Second compound of Formula | |
| of Formula I-B) | I-B, longer carbon chain than First | |
| | compound of Formula I-B) | |
| SA-1G (Formula I-B) | PA (Fatty acid, shorter length carbon | OA (Fatty acid, same |
| | chain than compound of Formula I-B) | length carbon chain as |
| | | compound of Formula I-B) |

As seen in Table 2 above, the coating agent can include a first component and a second component, where the first component is a compound of Formula I-B and the second component is either a fatty acid or a second compound of Formula I-B which is different than the (first) compound of Formula I-B. The compound of Formula I-B can make up at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, or at least about 90% of the mass of the coating agent. A combined mass of the first component and the second component can be at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90% or at least about 95% of the total mass of the coating agent.

Referring now to steps 104 and 106 of process 100 (FIG. 1), after dissolving the coating agent in a solvent to form a solution, the solution is applied over the surface of a piece of produce or other agricultural product in order to form a protective coating over the surface, the protective coating being formed from constituents of the coating agent. As previously described, the solution can, for example, be applied to the surface by dipping the produce or agricultural product in the solution, or by spraying the solution over the surface. The solvent is then removed from the surface of the produce or agricultural product, for example by allowing the solvent to evaporate or at least partially evaporate. In some embodiments, the act of at least partially removing of the solvent from the surface of the produce can comprise removing at least 90% of the solvent from the surface of the produce. As the solvent is removed (e.g., evaporated), the coating agent re-solidifies on the surface of the produce or agricultural product to form the protective coating over the surface. In some cases, the monomers, oligomers, polymers (e.g., low molecular weight polymers), or combinations thereof of the coating agent cross-link as the coating is formed while the solvent is removed from the surface. The resulting protective coating can then serve as a barrier to water loss from and/or oxidation of the produce or agricultural product, and can protect the produce or agricultural product from biotic and abiotic stressors.

Properties of the coating, such as thickness, cross-link density of monomers/oligomers/polymers, and permeability, can be varied to be suitable for a particular agricultural product by adjusting the specific composition of the coating agent, the specific composition of the solvent, the concentration of the coating agent in the solvent, and conditions of the coating deposition process (e.g., the amount of time the solution is applied to the surface of the produce or agricultural product before the solvent is removed, the temperature during the deposition process, the standoff distance between the spray head and the sample, and the spray angle). For example, too short an application time can result in too thin a protective coating being formed, whereas too long an application time can result in the produce or agricultural product being damaged by the solvent. Accordingly, the solution can be applied to the surface of the produce or agricultural product for between about 1 and about 3,600 seconds, for example between 1 and 3000 seconds, between 1 and 2000 seconds, between 1 and 1000 seconds, between 1 and 800 seconds, between 1 and 600 seconds, between 1 and 500 seconds, between 1 and 400 seconds, between 1 and 300 seconds, between 1 and 250 seconds, between 1 and 200 seconds, between 1 and 150 seconds, between 1 and 125 seconds, between 1 and 100 seconds, between 1 and 80 seconds, between 1 and 60 seconds, between 1 and 50 seconds, between 1 and 40 seconds, between 1 and 30 seconds, between 1 and 20 seconds, between 1 and 10 seconds, between about 5 and about 3000 seconds, between about 5 and about 2000 seconds, between about 5 and about 1000 seconds, between about 5 and about 800 seconds, between about 5 and about 600 seconds, between about 5 and about 500 seconds, between about 5 and about 400 seconds, between about 5 and about 300 seconds, between about 5 and about 250 seconds, between about 5 and about 200 seconds, between about 5 and about 150 seconds, between about 5 and about 125 seconds, between about 5 and about 100 seconds, between about 5 and about 80 seconds, between about 5 and about 60 seconds, between about 5 and about 50 seconds, between about 5 and about 40 seconds, between about 5 and about 30 seconds, between about 5 and about 20 seconds, between about 5 and about 10 seconds, between about 10 and about 3000 seconds, between about 10 and about 2000 seconds, between about 10 and about 1000 seconds, between about 10 and about 800 seconds, between about 10 and about 600 seconds, between about 10 and about 500 seconds, between about 10 and about 400 seconds, between about 10 and about 300 seconds, between about 10 and about 250 seconds, between about 10 and about 200 seconds, between about 10 and about 150 seconds, between about 10 and about 125 seconds, between about 10 and about 100 seconds, between about 10 and about 80 seconds, between about 10 and about 60 seconds, between about 10 and about 50 seconds, between about 10 and about 40 seconds, between about 10 and about 30 seconds, between about 10 and about 20 seconds, between about 20 and about 100 seconds, between about 100 and about 3,000 seconds, or between about 500 and about 2,000 seconds.

Furthermore, the concentration of the coating agent in the solvent can, for example, be in a range of 0.1 to 200 mg/mL or about 0.1 to about 200 mg/mL, such as in a range of about 0.1 to about 100 mg/mL, about 0.1 to about 75 mg/mL, about 0.1 to about 50 mg/mL, about 0.1 to about 30 mg/mL, about 0.1 to about 20 mg/mL, about 0.5 to about 200 mg/mL, about 0.5 to about 100 mg/mL, about 0.5 to about 75 mg/mL, about 0.5 to about 50 mg/mL, about 0.5 to about 30 mg/mL, about 0.5 to about 20 mg/mL, 1 to 200 mg/mL, 1 to 100 mg/mL, 1 to 75 mg/mL, 1 to 50 mg/mL, 1 to 30 mg/mL, about 1 to about 20 mg/mL, about 5 to about 200 mg/mL, about 5 to about 100 mg/mL, about 5 to about 75 mg/mL, about 5 to about 50 mg/mL, about 5 to about 30 mg/mL, or about 5 to about 20 mg/mL.

The protective coatings formed from coating agents described herein can be edible coatings. The protective coatings can be substantially undetectable to the human eye, and can be odorless and/or tasteless. The protective coatings can have an average thickness in the range of about about 0.1 microns to about 300 microns, for example in the range of about about 0.5 microns to about 100 microns, about 1 micron to about 50 microns, about 0.1 microns to about 1 micron, about 0.1 microns to about 2 microns, about 0.1 microns to about 5 microns, or about 0.1 microns to about 10 microns. In some implementations, the protective coatings are entirely organic (e.g., organic in the agricultural sense rather than the chemistry sense). In some embodiments, the produce is a thin-skinned fruit or vegetable. For instance, the produce can be a berry or grape. In some embodiments, the produce can include a cut fruit surface (e.g., a cut apple surface).

The protective coatings formed from coating agents described herein can serve a number of purposes. For example, the protective coatings can extend the shelf life of the produce or other agricultural products, even in the absence of refrigeration. Furthermore, produce and other agricultural products tend to lose mass (due to water loss) at a higher rate when maintained at lower relative humidity levels (e.g., lower than 90% relative humidity) as compared to higher relative humidity levels, as the driving force for water evaporation is increased at the lower relative humidity levels. As such, the protective coatings can be formulated to reduce the mass loss rate of the produce or agricultural product even at the lower relative humidity levels. For example, the protective coating can be formulated to reduce a mass loss rate of the produce at relative humidity levels less than or equal to a first relative humidity level (e.g., less than 90% relative humidity, less than 80% relative humidity, or less than 70% relative humidity). In some implementations, the first relative humidity level is sufficiently low to suppress fungal growth in the produce during storage. In some implementations, the protective coating causes the mass loss rate of the coated produce to be lower at relative humidity levels lower than the first relative humidity level than the mass loss rate of similar uncoated produce at relative humidity levels higher than or equal to the first relative humidity level.

Referring now to step 108 of process 100 (in FIG. 1), after forming the coating over the produce or other agricultural product, the coated produce/product is stored, for example in a container (e.g., a storage or shipping container), often for extended periods of time. For example, in some implementations, a grower of the produce harvests an excess amount of the produce, forms a protective coating over the produce, and stores the excess produce in an enlosed storage container for sale at a later date. Or, in cases where the produce is shipped from its location of harvesting to the point of sale, the produce is coated, packed into an enclosed shipping container, and shipped. In some implementations, the container in which the produce is stored comprises modified atmosphere packaging (MAP) configured to maintain the produce at a specific in-package relative humidity. In many cases, the produce is shipped by boat and remains in the container for at least 7 days, at least 10 days, at least 15 days, at least 20 days, at least 25 days, at least 30 days, at least 35 days, at least 40 days, or at least 45 days. The produce is often packed into the container and stored at a high packing density. For example, at least 10%, at least 20%, at least 30%, at least 40%, at least 50%, at least 60%, at least 70%, or at least 80% of the internal volume of the container can be filled with the produce.

In cases where the produce is stored and/or shipped in a container but is not coated as previously described, the produce is stored at a high enough in-package relative humidity level (e.g., at least 90% average relative humidity) to maintain a sufficiently low rate of mass loss for the time during which the produce is stored and/or shipped. For example, in some cases it may be required that the produce maintain at least 70%, at least 75%, at least 80%, at least 85%, at least 90%, or at least 95% of its original mass during storage. Accordingly, the produce is maintained at a sufficiently high average humidity during the duration of storage to ensure that the desired percent mass is maintained during storage. However, a problem arises in that the high relative humidity levels result in excessively high rates of molding, fungal growth, and spoilage.

Table 3 is a table showing recommended industry standard conditions, including recommended relative humidity, for long-term storage and/or shipment of fresh produce (e.g., fruits and vegetables). As shown in Table 3, humidity levels greater than about 90%, which are levels recommended for storage of a large number of types of produce, have been found to lead to particularly high rates of fungal growth and spoilage in a wide variety of produce.

TABLE 3
Properties and Recommended Conditions for Long-Term Storage of Fresh Fruits and Vegetables

| | | Storage | | | Highest freezing | | | | | | |
|---|---|---|---|---|---|---|---|---|---|---|---|
| | | temperature | | Relative | temperature | | Ethylene* | Ethylene** | Approximate | | Observations and |
| Common name | Scientific name | ° C. | ° F. | humidity % | ° C. | ° F. | production | sensitivity | storage-life | | beneficial conditions |
| Acerola; Barbados cherry | Malpighia glabra | 0 | 32 | 85-90 | −1.4 | 29.4 | | | 6-8 | weeks | |
| African horned melon; | Cucumis metuliferus | 13-15 | 55-59 | 90 | | | L | M | 3-6 | months | |
| Kiwano | | | | | | | | | | | |
| Amaranth; Pigweed | Amaranthus spp. | 0-2 | 32-36 | 95-100 | | | VL | M | 10-14 | days | |
| Anise; Fennel | Foeniculum vulgare | 0-2 | 32-36 | 90-95 | −1.1 | 30.0 | | | 2-3 | weeks | |
| Apple | Malus pumila | | | | | | | | | | 2-3% O2 + 1-2% CO2 |
| not chilling sensitive | | −1.1-0 | 30-32 | 90-95 | −1.5 | 29.3 | VH | H | 3-6 | months | |
| chilling sensitive | Yellow Newtown, | 4 | 40 | 90-95 | −1.5 | 29.3 | VH | H | 1-2 | months | |
| | Grimes Golden | | | | | | | | | | |
| Apricot | Prunus armeniaca | −0.5-0 | 31-32 | 90-95 | −1.1 | 30.0 | M | M | 1-3 | weeks | 2-3% O2 + 2-3% CO2 |
| Artichoke | | | | | | | | | | | |
| Globe artichoke | Cynara acolymus | 0 | 32 | 95-100 | −1.2 | 29.9 | VL | L | 2-3 | weeks | 2-3% O2 + 3-5% CO2 |
| Chinese artichoke | Stachys affinia | 0 | 32 | 90-95 | | | VL | VL | 1-2 | weeks | |
| Jerusalem artichoke | Helianthus tuberosus | −0.5-0 | 31-32 | 90-95 | −2.5 | 27.5 | VL | L | 4 | months | |
| Arugula | Eruca vesicaria var. | 0 | 32 | 95-100 | | | VL | H | 7-10 | days | |
| | sativa | | | | | | | | | | |
| Asian pear, Nashi | Pyrus serotina; P. pyrifolia | 1 | 34 | 90-95 | −1.6 | 29.1 | H | H | 4-6 | months | |
| Asparagus, green, white | Asparagus officinalis | 2.5 | 36 | 95-100 | −0.6 | 31.0 | VL | M | 2-3 | weeks | 5-12% CO2 in air |
| Atemoya | Annona squamosa × A. cherimola | 13 | 55 | 85-90 | | | H | H | 2-4 | weeks | 3-5% O2 + 5-10% CO2 |
| Avocado | Persea americana | | | | | | | | | | |
| cv Fuerte, Hass | | 3-7 | 37-45 | 85-90 | −1.6 | 29.1 | H | H | 2-4 | weeks | 2-5% O2 + 3-10% CO2 |
| cv. Fuchs, Pollock | | 13 | 55 | 85-90 | −0.9 | 30.4 | H | H | 2 | weeks | |
| cv. Lula, Booth | | 4 | 40 | 90-95 | −0.9 | 30.4 | H | H | 4-8 | weeks | |
| Babaco, Mt. papaya | Carica candamarcensis | 7 | 45 | 85-90 | | | | | 1-3 | weeks | |
| Banana | Musa paradisiaca var. | 13-15 | 55-59 | 90-95 | −0.8 | 30.6 | M | H | 1-4 | weeks | 2-5% O2 + 2-5% CO2 |
| | sapientum | | | | | | | | | | |
| Barbados cherry | see Acerola | | | | | | | | | | |
| Beans | | | | | | | | | | | |
| Snap; Wax; Green | Phaseolus vulgaris | 4-7 | 40-45 | 95 | −0.7 | 30.7 | L | M | 7-10 | days | 2-3% O2 + 4-7% CO2 |
| Fava, Broad beans | Vicia faba | 0 | 32 | 90-95 | | | | | 1-2 | weeks | |
| Lima beans | Phaseolus lunatus | 5-6 | 41-43 | 95 | −0.6 | 31.0 | L | M | 5-7 | days | |
| Winged bean | Psophocarpus | 10 | 50 | 90 | | | | | 4 | weeks | |
| | tetragonolobus | | | | | | | | | | |
| Long bean; Yard-long | Vigna sesquipedalis | 4-7 | 40-45 | 90-95 | | | L | M | 7-10 | days | |
| Beet, bunched | Beta vulgaris | 0 | 32 | 98-100 | −0.4 | 31.3 | VL | L | 10-14 | days | |
| beet, topped | | 0 | 32 | 98-100 | −0.9 | 30.3 | VL | L | 4 | months | |
| Berries | | | | | | | | | | | |
| Blackberries | Rubus spp. | −0.5-0 | 31-32 | 90-95 | −0.8 | 30.6 | L | L | 3-6 | days | 5-10% O2 + 15-20% CO2 |
| Blueberries | Vaccinium corymbosum | −0.5-0 | 31-32 | 90-95 | −1.3 | 29.7 | L | L | 10-18 | days | 2-5% O2 + 12-20% CO2 |
| Cranberry | Vaccinium macrocarpon | 2-5 | 35-41 | 90-95 | −0.9 | 30.4 | L | L | 8-16 | weeks | 1-2% O2 + 0-5% CO2 |
| Dewberry | Rubus spp. | −0.5-0 | 31-32 | 90-95 | −1.3 | 29.7 | L | L | 2-3 | days | |
| Elderberry | Rubus spp. | −0.5-0 | 31-32 | 90-95 | −1.1 | 30.0 | L | L | 5-14 | days | |
| Loganberry | Rubus spp. | −0.5-0 | 31-32 | 90-95 | −1.7 | 28.9 | L | L | 2-3 | days | |
| Raspberries | Rubus idaeus | −0.5-0 | 31-32 | 90-95 | −0.9 | 30.4 | L | L | 3-6 | days | 5-10% O2 + 15-20% CO2 |
| Strawberry | Fragaria spp. | 0 | 32 | 90-95 | −0.8 | 30.6 | L | L | 7-10 | days | 5-10% O2 + 15-20% CO2 |
| Bittermelon; Bitter gourd | Momordica charantia | 10-12 | 50-54 | 85-90 | | | L | M | 2-3 | weeks | 2-3% O2 + 5% CO2 |
| Black salsify; Scorzonera | Scorzonera hispanica | 0-1 | 32-34 | 95-98 | | | VL | L | 6 | months | |
| Bok choy | Brassica chinensis | 0 | 32 | 95-100 | | | VL | H | 3 | weeks | |
| Breadfruit | Artocarpus altilis | 13-15 | 55-59 | 85-90 | | | | | 2-4 | weeks | |
| Broccoli | B. oleracea var. Italica | 0 | 32 | 95-100 | −0.6 | 31.0 | VL | H | 10-14 | days | 1-2% O2 + 5-10% CO2 |
| Brussels sprouts | Brassica oleracea var. | 0 | 32 | 95-100 | −0.8 | 30.5 | VL | H | 3-5 | weeks | 1-2% O2 + 5-7% CO2 |
| | Gemnifera | | | | | | | | | | |
| Cabbage | | | | | | | | | | | |
| Chinese; Napa | Brassica campestris var. | 0 | 32 | 95-100 | −0.9 | 30.4 | VL | M-H | 2-3 | months | 1-2% O2 + 0-5% CO2 |
| | Pekinensis | | | | | | | | | | |
| Common, early crop | B. oleracea var. Capitata | 0 | 32 | 98-100 | −0.9 | 30.4 | VL | H | 3-6 | weeks | |
| late crop | ″ | 0 | 32 | 95-100 | −0.9 | 30.4 | VL | H | 5-6 | months | 3-5% O2 + 3-7% CO2 |
| Cactus pads or stems, | Opuntia spp. | 5-10 | 41-50 | 90-95 | | | VL | M | 2-3 | weeks | |
| Nopalitos | | | | | | | | | | | |
| Cactus fruit; Prickly pear | Opuntia spp. | 5 | 41 | 85-90 | −1.8 | 28.7 | VL | M | 2-6 | weeks | 2% O2 + 2-5% CO2 |
| fruit | | | | | | | | | | | |
| Caimito | see Sapotes | | | | | | | | | | |
| Calamondin | see Citrus | | | | | | | | | | |
| Canistel | see Sapotes | | | | | | | | | | |
| Carambola, Starfruit | Averrhoa carambola | 9-10 | 48-50 | 85-90 | −1.2 | 29.8 | | | 3-4 | weeks | |
| Carrots, topped | Daucus carota | 0 | 32 | 98-100 | −1.4 | 29.5 | VL | H | 3-6 | months | no CA benefit; ethylene |
| | | | | | | | | | | | causes bitterness |
| bunched; immature | ″ | 0 | 32 | 98-100 | −1.4 | 29.5 | VL | H | 10-14 | days | ethylene causes bitterness |
| Cashew apple | Anacardium occidentale | 0-2 | 32-36 | 85-90 | | | | | 5 | weeks | |
| Cassava, | Manihot esculenta | 0-5 | 32-41 | 85-90 | | | VL | L | 1-2 | months | no CA benefit |
| Yucca, Manioc | | | | | | | | | | | |
| Cauliflower | Brassica oleracea var. | 0 | 32 | 95-98 | −0.8 | 30.6 | VL | H | 3-4 | weeks | 2-5% O2 + 2-5% CO2 |
| | Botrytis | | | | | | | | | | |
| Celeriac | Apium graveolens var. | 0 | 32 | 98-100 | −0.9 | 30.4 | VL | L | 6-8 | months | 2-4% O2 + 2-3% CO2 |
| | Rapaceum | | | | | | | | | | |
| Celery | Apium graveolens var. | 0 | 32 | 98-100 | −0.5 | 31.1 | VL | M | 1-2 | months | 1-4% O2 + 3-5% CO2 |
| | Dulce | | | | | | | | | | |
| Chard | Beta vulgaris var. Cicla | 0 | 32 | 95-100 | | | VL | H | 10-14 | days | |
| Chayote | Sechium edule | 7 | 45 | 85-90 | | | | | 4-6 | weeks | |
| Cherimoya; Custard apple | Annona cherimola | 13 | 55 | 90-95 | −2.2 | 28.0 | H | H | 2-4 | weeks | 3-5% O2 + 5-10% CO2 |
| Cherries, sour | Prunus cerasus | 0 | 32 | 90-95 | −1.7 | 29.0 | VL | L | 3-7 | days | 3-10% O2 + 10-12% CO2 |
| Cherries, sweet | Prunus avium | −1 to 0 | 30-32 | 90-95 | −2.1 | 28.2 | VL | L | 2-3 | weeks | 10-20% O2 + 20-25% CO2 |
| Chicory | see Endive | | | | | | | | | | |
| Chiles | see Pepper | | | | | | | | | | |
| Chinese broccoli; Gailan | Brassica alboglabra | 0 | 32 | 95-100 | | | VL | H | 10-14 | days | |
| Chinese date | See Jujube | | | | | | | | | | |
| Chives | Allium schoenoprasum | 0 | 32 | 95-100 | | | VL | H | 2-3 | weeks | 5-10% O2 + 5-10% CO2 |
| Cilantro, Chinese parsley | See Herbs | | | | | | | | | | |
| Citrus | | | | | | | | | | | |
| Calamondin orange | Citrus reticulta × | 9-10 | 48-50 | 90 | −2.0 | 28.3 | | | 2 | weeks | |
| | Fortunella spp. | | | | | | | | | | |
| Grapefruit | Citrus paradisi | | | | | | | | | | 3-10% O2 + 5-10% CO2 |
| CA, AZ, dry areas | | 14-15 | 58-59 | 85-90 | −1.1 | 30.0 | VL | M | 6-8 | weeks | |
| FL, humid areas | | 10-15 | 50-59 | 85-90 | −1.1 | 30.0 | VL | M | 6-8 | weeks | |
| Kumquat | Fortunella japonica | 4 | 40 | 90-95 | | | VL | M | 2-4 | weeks | |
| Lemon | Citrus limon | 10-13 | 50-55 | 85-90 | −1.4 | 29.4 | | | 1-6 | months | 5-10% O2 + 0-10% CO2 |
| Lime, Mexican, | Citrus aurantifolia; C. latifolia | 9-10 | 48-50 | 85-90 | −1.6 | 29.1 | | | 6-8 | weeks | 5-10% O2 + 0-10% CO2 |
| Tahiti or Persian | | | | | | | | | | | |
| Orange | Citrus sinensis | | | | | | | | | | 5-10% O2 + 0-5% CO2 |
| CA, AZ, dry areas | | 3-9 | 38-48 | 85-90 | −0.8 | 30.6 | VL | M | 3-8 | weeks | |
| FL; humid regions | | 0-2 | 32-36 | 85-90 | −0.8 | 30.6 | VL | M | 8-12 | weeks | |
| Blood orange | | 4-7 | 40-44 | 90-95 | −0.8 | 30.6 | | | 3-8 | weeks | |
| Seville; Sour | Citrus aurantium | 10 | 50 | 85-90 | −0.8 | 30.6 | L | M | 12 | weeks | |
| Pummelo | Citrus grandis | 7-9 | 45-48 | 85-90 | −1.6 | 29.1 | | | 12 | weeks | |
| Tangelo, Minneola | C. reticulata × paradisi | 7-10 | 45-50 | 85-95 | −0.9 | 30.3 | | | 2-4 | weeks | |
| Tangerine, Mandarin | Citrus reticulata | 4-7 | 40-45 | 90-95 | −1.1 | 30.1 | VL | M | 2-4 | weeks | |
| Coconut | Cocos nucifera | 0-2 | 32-36 | 80-85 | −0.9 | 30.4 | | | 1-2 | months | |
| Collards | B. oleracea var. Acephala | 0 | 32 | 95-100 | −0.5 | 31.1 | VL | H | 10-14 | days | |
| Corn, sweet and baby | Zea mays | 0 | 32 | 95-98 | −0.6 | 30.9 | VL | L | 5-8 | days | 2-4% O2 + 5-10% CO2; to 4 wks, |
| | | | | | | | | | | | 5-10% O2 + 15% CO2 |
| Cowpeas | See Peas | | | | | | | | | | |
| Cucumber, slicing | Cucumis sativus | 10-12 | 50-54 | 85-90 | −0.5 | 31.1 | L | H | 10-14 | days | 3-5% O2 + 0-5% CO2 |
| pickling | | 4 | 40 | 95-100 | | | L | H | 7 | days | 3-5% O2 + 3-5% CO2 |
| Currants | Ribes sativum; | −0.5-0 | 31-32 | 90-95 | −1.0 | 30.2 | L | L | 1-4 | weeks | CA can extend storage life |
| | R. nigrum; R. rubrum | | | | | | | | | | to 3-6 months |
| Custard apple | see Cherimoya | | | | | | | | | | |
| Daikon; Oriental radish | Raphanus sativus | 0-1 | 32-34 | 95-100 | | | VL | L | 4 | months | |
| Dasheen | see Taro | | | | | | | | | | |
| Date | Phoenix dactylifera | −18-0 | 0-32 | 75 | −15.7 | 3.7 | VL | L | 6-12 | months | |
| Dill | see Herbs | | | | | | | | | | |
| Durian | Durio zibethinus | 4-6 | 39-42 | 85-90 | | | | | 6-8 | weeks | 3-5% O2 + 5-15% CO2 |
| Eggplant | Solanum melongena | 10-12 | 50-54 | 90-95 | −0.8 | 30.6 | L | M | 1-2 | weeks | 3-5% O2 + 0% CO2 |
| Endive, Escarole | Cichorium endivia | 0 | 32 | 95-100 | −0.1 | 31.7 | VL | M | 2-4 | weeks | |
| Belgian endive; | Cichorium intybus | 2-3 | 36-38 | 95-98 | | | VL | M | 2-4 | weeks | light causes greening; |
| Witloof chicory | | | | | | | | | | | 3-4% O2 + 4-5% CO2 |
| Epazote | See Herbs | | | | | | | | | | |
| Fava bean | See Beans | | | | | | | | | | |
| Feijoa, Pineapple guava | Feijoa sellowiana | 5-10 | 41-50 | 90 | | | M | L | 2-3 | weeks | |
| Fennel, see anise | | | | | | | | | | | |
| Fig | Ficus carica | −0.5-0 | 31-32 | 85-90 | −2.4 | 27.6 | M | L | 7-10 | days | 5-10% O2 + 15-20% CO2 |
| Garlic bulb | Allium sativum | −1-0 | 30-32 | 65-70 | −2.0 | 28.4 | VL | L | 6-7 | months | 0.5% O2 + 5-10% CO2 |
| Ginger | Zingiber officinale | 13 | 55 | 65 | | | VL | L | 6 | months | no CA benefit |
| Gooseberry | Ribes grossularia | −0.5-0 | 31-32 | 90-95 | −1.1 | 30.0 | L | L | 3-4 | weeks | |
| Granadilla | see Passionfruit | | | | | | | | | | |
| Grape | Vitis vinifera a = fruit; | −0.5-0 | 31-32 | 90-95 | −2.7 a | 27.1 a | VL | L | 1-6 | months | 2-5% O2 + 1-3% CO2; to 4 wks, |
| | b = stem | | | | −2.0 b | 28.4 b | | | | | 5-10% O2 + 10- |
| American grape | Vitis labrusca | −1 to −0.5 | 30-31 | 90-95 | −1.4 | 29.4 | VL | L | 2-8 | weeks | |
| Grapefruit | see Citrus | | | | | | | | | | |
| Guava | Psidium guajava | 5-10 | 41-50 | 90 | | | L | M | 2-3 | weeks | |
| Herbs, fresh culinary | See specific herb | | | | | | | | | | 5-10% O2 + 5-10% CO2 |
| Basil | Ocimum basilicum | 10 | 50 | 90 | | | VL | H | 7 | days | 2% O2 + 0 to <10% CO2 |
| Chives | Allium schoenoprasum | 0 | 32 | 95-100 | −0.9 | 30.4 | L | M | | | |
| Cilantro, Chinese | Coriandrum sativum | 0-1 | 32-34 | 95-100 | | | VL | H | 2 | weeks | 3% O2 + 7-10% CO2; air + |
| parsley | | | | | | | | | | | 7-10% CO2 |
| Dill | Anethum graveolens | 0 | 32 | 95-100 | −0.7 | 30.7 | VL | H | 1-2 | weeks | 5-10% O2 + 5-10% CO2 |
| Epazote | Chenopodium | 0-5 | 32-41 | 90-95 | | | VL | M | 1-2 | weeks | |
| | ambrosioides | | | | | | | | | | |
| Mint | Mentha spp. | 0 | 32 | 95-100 | | | VL | H | 2-3 | weeks | 5-10% O2 + 5-10% CO2 |
| Oregano | Origanum vulgare | 0-5 | 32-41 | 90-95 | | | VL | M | 1-2 | weeks | |
| Parsley | Petroselinum crispum | 0 | 32 | 95-100 | −1.1 | 30.0 | VL | H | 1-2 | months | 5-10% O2 + 5-10% CO2 |
| Perilla, Shiso | Perilla frutescens | 10 | 50 | 95 | | | VL | M | 7 | days | |
| Sage | Salvia officinalis | 0 | 32 | 90-95 | | | | | 2-3 | weeks | |
| Thyme | Thymus vulgaris | 0 | 32 | 90-95 | | | | | 2-3 | weeks | |
| Horseradish | Armoracia rusticana | −1 to 0 | 30-32 | 98-100 | −1.8 | 28.7 | VL | L | 10-12 | mo. | |
| Husk tomato | see Tomatillo | | | | | | | | | | |
| Jaboticaba | Myrciaria cauliflora = | 13-15 | 55-59 | 90-95 | | | | | 2-3 | days | |
| | Eugenia cauliflora | | | | | | | | | | |
| Jackfruit | Artocarpus heterophyllus | 13 | 55 | 85-90 | | | M | M | 2-4 | weeks | |
| Jerusalem artichoke | see Artichoke | | | | | | | | | | |
| Jicama, Yambean | Pachyrrhizus erosus | 13-18 | 55-65 | 85-90 | | | VL | L | 1-2 | months | |
| Jujube; Chinese date | Ziziphus jujuba | 2.5-10 | 36-50 | 85-90 | −1.6 | 29.2 | L | M | 1 | month | |
| Kaki | see Persimmon | | | | | | | | | | |
| Kale | Brassica oleracea var. | 0 | 32 | 95-100 | −0.5 | 31.1 | VL | H | 10-14 | days | |
| | acephala | | | | | | | | | | |
| Kiwano | see African horned melon | | | | | | | | | | |
| Kiwifruit; | Actinidia chinensis | 0 | 32 | 90-95 | −0.9 | 30.4 | L | H | 3-5 | months | 1-2% O2 + 3-5% CO2 |
| Chinese gooseberry | | | | | | | | | | | |
| Kohlrabi | Brassica oleracea var. | 0 | 32 | 98-100 | −1.0 | 30.2 | VL | L | 2-3 | months | no CA benefit |
| | Gongylodes | | | | | | | | | | |
| Kumquat | See Citrus | | | | | | | | | | |
| Langsat; Lanzone | Aglaia sp.; Lansium sp. | 11-14 | 52-58 | 85-90 | | | | | 2 | weeks | |
| Leafy Greens | | | | | | | | | | | |
| Cool season | various genera | 0 | 32 | 95-100 | −0.6 | 31.0 | VL | H | 10-14 | days | |
| Warm season | various genera | 7-10 | 45-50 | 95-100 | −0.6 | 31.0 | VL | H | 5-7 | days | |
| Leek | Allium porrum | 0 | 32 | 95-100 | −0.7 | 30.7 | VL | M | 2 | months | 1-2% O2 + 2-5% CO2 |
| Lemon | see Citrus | | | | | | | | | | |
| Lettuce | Lactuca sativa | 0 | 32 | 98-100 | −0.2 | 31.7 | VL | H | 2-3 | weeks | 2-5% O2 + 0% CO2 |
| Lima bean | see Beans | | | | | | | | | | |
| Lime | see Citrus | | | | | | | | | | |
| LoBok | see Daikon | | | | | | | | | | |
| Longan | Dimocarpus longan = | 4-7 | 39-45 | 90-95 | −2.4 | 27.7 | | | 2-4 | weeks | |
| | Euphoria longan | | | | | | | | | | |
| Long bean | See Beans | | | | | | | | | | |
| Loquat | Eriobotrya japonica | 0 | 32 | 90-95 | −1.9 | 28.6 | | | 3 | weeks | |
| Luffa; Chinese okra | Luffa spp. | 10-12 | 50-54 | 90-95 | | | L | M | 1-2 | weeks | |
| Lychee, Litchi | Litchi chinensis | 1-2 | 34-36 | 90-95 | | | M | M | 3-5 | weeks | 3-5% O2 + 3-5% CO2 |
| Malanga, Tania, New | Xanthosoma sagittifolium | 7 | 45 | 70-80 | | | VL | L | 3 | months | |
| cocoyam | | | | | | | | | | | |
| Mamey | see Sapote | | | | | | | | | | |
| Mandarin | see Citrus | | | | | | | | | | |
| Mango | Mangifera indica | 13 | 55 | 85-90 | −1.4 | 29.5 | M | M | 2-3 | weeks | 3-5% 2 + 5-10% O2 |
| Mangosteen | Garcinia mangostana | 13 | 55 | 85-90 | | | M | H | 2-4 | weeks | |
| Melons | | | | | | | | | | | |
| Cantaloupes and other | Cucurbita melo var. | 2-5 | 36-41 | 95 | −1.2 | 29.9 | H | M | 2-3 | weeks | 3-5% O2 + 10-15% CO2 |
| netted melons | reticulatus | | | | | | | | | | |
| Casaba | Cucurbita melo | 7-10 | 45-50 | 85-90 | −1.0 | 30.3 | L | L | 3-4 | weeks | 3-5% O2 + 5-10% CO2 |
| Crenshaw | Cucurbita melo | 7-10 | 45-50 | 85-90 | −1.1 | 30.1 | M | H | 2-3 | weeks | 3-5% O2 + 5-10% CO2 |
| Honeydew, and Orange- | Cucurbita melo | 5-10 | 41-50 | 85-90 | −1.1 | 30.1 | M | H | 3-4 | weeks | 3-5% O2 + 5-10% CO2 |
| flesh | | | | | | | | | | | |
| Persian | Cucurbita melo | 7-10 | 45-50 | 85-90 | −0.8 | 30.6 | M | H | 2-3 | weeks | 3-5% O2 + 5-10% CO2 |
| Mint | see Herbs | | | | | | | | | | |
| Mombin | see spondias | | | | | | | | | | |
| Mushrooms | Agaricus, other genera | 0 | 32 | 90 | −0.9 | 30.4 | VL | M | 7-14 | days | 3-21% O2 + 5-15% CO2 |
| Mustard greens | Brassica juncea | 0 | 32 | 90-95 | | | VL | H | 7-14 | days | |
| Nashi | see Asian pear | | | | | | | | | | |
| Nectarine | Prunus persica | −0.5-0 | 31-32 | 90-95 | −0.9 | 30.3 | M | M | 2-4 | weeks | 1-2% O2 + 3-5% CO2; |
| | | | | | | | | | | | internal breakdown 3-10° C. |
| Okra | Abelmoschus esculentus | 7-10 | 45-50 | 90-95 | −1.8 | 28.7 | L | M | 7-10 | days | air + 4-10% CO2 |
| Olives, fresh | Olea europea | 5-10 | 41-50 | 85-90 | −1.4 | 29.4 | L | M | 4-6 | weeks | 2-3% O2 + 0-1% CO2 |
| Onions | Allium cepa | | | | | | | | | | |
| Mature bulbs, dry | | 0 | 32 | 65-70 | −0.8 | 30.6 | VL | L | 1-8 | months | 1-3% O2 + 5-10% CO2 |
| Green onions | | 0 | 32 | 95-100 | −0.9 | 30.4 | L | H | 3 | weeks | 2-4% O2 + 10-20% CO2 |
| Orange | see Citrus | | | | | | | | | | |
| Papaya | Carica papaya | 7-13 | 45-55 | 85-90 | −0.9 | 30.4 | M | M | 1-3 | weeks | 2-5% O2 + 5-8% CO2 |
| Parsley | see Herbs | | | | | | | | | | |
| Parsnips | Pastinaca sativa | 0 | 32 | 95-100 | −0.9 | 30.4 | VL | H | 4-6 | months | ethylene causes bitterness |
| Passionfruit | Passiflora spp. | 10 | 50 | 85-90 | | | VH | M | 3-4 | weeks | |
| Peach | Prunus persica | −0.5-0 | 31-32 | 90-95 | −0.9 | 30.3 | M | M | 2-4 | weeks | 1-2% O2 + 3-5% CO2; |
| | | | | | | | | | | | internal breakdown 3-10° C. |
| Pear, European | Pyrus communis | −1.5 to | 29-31 | 90-95 | −1.7 | 29.0 | H | H | 2-7 | months | Cultivar variations; 1-3% |
| | | −0.5 | | | | | | | | | O2 + 0-5% CO2 |
| Pear, Asian | See Asian Pear | | | | | | | | | | |
| Peas in pods; Snow, Snap | Pisum sativum | 0 | 32 | 90-98 | −0.6 | 30.9 | VL | M | 1-2 | weeks | 2-3% O2 + 2-3% CO2 |
| & Sugar peas | | | | | | | | | | | |
| Southern peas; Cowpeas | Vigna sinensis = V. unguiculata | 4-5 | 40-41 | 95 | | | | | 6-8 | days | |
| Pepino; Melon pear | Solanum muricatum | 5-10 | 41-50 | 95 | | | L | M | 4 | weeks | |
| Peppers | | | | | | | | | | | |
| Bell Pepper, Paprika | Capsicum annuum | 7-10 | 45-50 | 95-98 | −0.7 | 30.7 | L | L | 2-3 | weeks | 2-5% O2 + 2-5% CO2 |
| Hot peppers, Chiles | Capsicum annuum and C. frutescens | 5-10 | 41-50 | 85-95 | −0.7 | 30.7 | L | M | 2-3 | weeks | 3-5% O2 + 5-10% CO2 |
| Persimmon; Kaki | Diospyros kaki | | | | | | | | | | 3-5% O2 + 5-8% CO2 |
| Fuyu | | 0 | 32 | 90-95 | −2.2 | 28.0 | L | H | 1-3 | months | |
| Hachiya | | 0 | 32 | 90-95 | −2.2 | 28.0 | L | H | 2-3 | months | |
| Pineapple | Ananas comosus | 7-13 | 45-55 | 85-90 | −1.1 | 30.0 | L | L | 2-4 | weeks | 2-5% O2 + 5-10% CO2 |
| Plantain | Musa paradisiaca var. | 13-15 | 55-59 | 90-95 | −0.8 | 30.6 | L | H | 1-5 | weeks | |
| | paradisiaca | | | | | | | | | | |
| Plums and Prunes | Prunus domestica | −0.5-0 | 31-32 | 90-95 | −0.8 | 30.5 | M | M | 2-5 | weeks | 1-2% O2 + 0-5% CO2 |
| Pomegranate | Punica granatum | 5-7.2 | 41-45 | 90-95 | −3.0 | 26.6 | VL | L | 2-3 | months | 3-5% O2 + 5-10% CO2 |
| Potato, early crop | Solanum tuberosum | 10-15 | 50-59 | 90-95 | −0.8 | 30.5 | VL | M | 10-14 | days | no CA benefit |
| late crop | | 4-8 | 40-46 | 95-98 | −0.8 | 30.5 | VL | M | 5-10 | months | no CA benefit |
| Pumpkin | Cucurbita maxima | 12-15 | 54-59 | 50-70 | −0.8 | 30.5 | L | M | 2-3 | months | |
| Quince | Cydonia oblonga | −0.5-0 | 31-32 | 90 | −2.0 | 28.4 | L | H | 2-3 | months | |
| Radicchio | Cichorium intybus | 0-1 | 32-34 | 95-100 | | | | | 4-8 | weeks | |
| Radish | Raphanus sativus | 0 | 32 | 95-100 | −0.7 | 30.7 | VL | L | 1-2 | months | 1-2% O2 + 2-3% CO2 |
| Rambutan | Nephelium lappaceum | 12 | 54 | 90-95 | | | H | H | 1-3 | weeks | 3-5% O2 + 7-12% CO2 |
| Rhubarb | Rheum rhaponticum | 0 | 32 | 95-100 | −0.9 | 30.3 | VL | L | 2-4 | weeks | |
| Rutabaga | Brassica napus var. | 0 | 32 | 98-100 | −1.1 | 30.1 | VL | L | 4-6 | months | |
| | Napobrassica | | | | | | | | | | |
| Sage | see Herbs | | | | | | | | | | |
| Salsify; Vegetable oyster | Trapopogon porrifolius | 0 | 32 | 95-98 | −1.1 | 30.1 | VL | L | 2-4 | months | |
| Sapotes | | | | | | | | | | | |
| Caimito, Star apple | Chrysophyllum cainito | 3 | 38 | 90 | −1.2 | 29.9 | | | 3 | weeks | |
| Canistel, Eggfruit | Pouteria campechiana | 13-15 | 55-59 | 85-90 | −1.8 | 28.7 | | | 3 | weeks | |
| Black sapote | Diospyros ebenaster | 13-15 | 55-59 | 85-90 | −2.3 | 27.8 | | | 2-3 | weeks | |
| White sapote | Casimiroa edulis | 20 | 68 | 85-90 | −2.0 | 28.4 | | | 2-3 | weeks | |
| Mamey sapote | Calocarpum mammosum | 13-15 | 55-59 | 90-95 | | | H | H | 2-3 | weeks | |
| Sapodilla, Chicosapote | Achras sapota | 15-20 | 59-68 | 85-90 | | | H | H | 2 | weeks | |
| Scorzonera | see Black Salsify | | | | | | | | | | |
| Shallots | Allium cepa var | 0-2.5 | 32-36 | 65-70 | −0.7 | 30.7 | L | L | | | |
| | ascalonicum | | | | | | | | | | |
| Snap bean | see Beans | | | | | | | | | | |
| Soursop | Annona muricata | 13 | 55 | 85-90 | | | | | 1-2 | weeks | 3-5% O2 + 5-10% CO2 |
| Spinach | spinacia oleracea | 0 | 32 | 95-100 | −0.3 | 31.5 | VL | H | 10-14 | days | 5-10% O2 + 5-10% CO2 |
| Spondias, Mombin, Wi | spondias spp. | 13 | 55 | 85-90 | | | | | 1-2 | weeks | |
| applejobo, Hogplum | | | | | | | | | | | |
| Sprouts from seeds | various genera | 0 | 32 | 95-100 | | | | | 5-9 | days | |
| Alfalfa sprouts | Medicago sativa | 0 | 32 | 95-100 | | | | | 7 | days | |
| Bean sprouts | Phaseolus sp. | 0 | 32 | 95-100 | | | | | 7-9 | days | |
| Radish sprouts | Raphanus sp. | 0 | 32 | 95-100 | | | | | 5-7 | days | |
| Squash | | | | | | | | | | | |
| Summer (soft rind); | Cucurbita pepo | 7-10 | 45-50 | 95 | −0.5 | 31.1 | L | M | 1-2 | weeks | 3-5% O2 + 5-10% CO2 |
| Courgette | | | | | | | | | | | |
| Winter (hard rind); | Cucurbita moschata; C. maxima | 12-15 | 54-59 | 50-70 | −0.8 | 30.5 | L | M | 2-3 | months | large differences among |
| Calabash | | | | | | | | | | | varieties |
| Star-apple | see Sapotes | | | | | | | | | | |
| Starfruit | see Carambola | | | | | | | | | | |
| Strawberry | see Berries | | | | | | | | | | |
| Sweetpotato, “Yam” | Ipomea batatas | 13-15 | 55-59 | 85-95 | −1.3 | 29.7 | VL | L | 4-7 | months | |
| Sweetsop; Sugar apple; | Annona squamosa; | 7 | 45 | 85-90 | | | H | H | 4 | weeks | 3-5% O2 + 5-10% CO2 |
| Custard apple | Annona spp. | | | | | | | | | | |
| Tamarillo, Tree tomato | Cyphomandra betacea | 3-4 | 37-40 | 85-95 | | | L | M | 10 | weeks | |
| Tamarind | Tamarindus indica | 2-7 | 36-45 | 90-95 | −3.7 | 25.3 | VL | VL | 3-4 | weeks | |
| Taro, Cocoyam, Eddoe, | Colocasia esculenta | 7-10 | 45-50 | 85-90 | −0.9 | 30.3 | | | 4 | months | No CA benefit |
| Dasheen | | | | | | | | | | | |
| Thyme | see Herbs | | | | | | | | | | |
| Tomatillo; Husk tomato | Physalis ixocarpa | 7-13 | 45-55 | 85-90 | | | VL | M | 3 | weeks | |
| Tomato, mature-green | Lycopersicon esculentum | 10-13 | 50-55 | 90-95 | −0.5 | 31.0 | VL | H | 2-5 | weeks | 3-5% O2 + 2-3% CO2 |
| Tomato, firm-ripe | | 8-10 | 46-50 | 85-90 | −0.5 | 31.1 | H | L | 1-3 | weeks | 3-5% O2 + 3-5% CO2 |
| Turnip root | Brassica campestris var. | 0 | 32 | 95 | −1.0 | 30.1 | VL | L | 4-5 | months | |
| | Rapifera | | | | | | | | | | |
| Water chestnut | Eleocharis dulcis | 1-2 | 32-36 | 85-90 | | | | | 2-4 | months | |
| Watercress; Garden cress | Lepidium sativum; | 0 | 32 | 95-100 | −0.3 | 31.5 | VL | H | 2-3 | weeks | |
| | Nasturtium officinales | | | | | | | | | | |
| Watermelon | Citrullus vulgaris | 10-15 | 50-59 | 90 | −0.4 | 31.3 | VL | H | 2-3 | weeks | no CA benefit |
| Winged bean | See Beans | | | | | | | | | | |
| Witloof chicory | See Endive | | | | | | | | | | |
| Yam | Dioscorea spp. | 15 | 59 | 70-80 | −1.1 | 30.0 | VL | L | 2-7 | months | |
| Yard-long bean | See Beans | | | | | | | | | | |
| Yucca | see Cassava | | | | | | | | | | |

*Ethylene production rate: VL = very low (<0.1 μL/kg-hr at 20° C.) L = low (0.1 = 1.0 μL/kg-hr) M = moderate (1.0-10.0 μL/kg-hr) H = high (10-100 μL/kg-hr) VH = very high (>100 μL/kg-hr)
**Ethylene sensitivity (detrimental effects include yellowing, softening, increased decay, abscission or loss of leaves, browning) L = low sensitivity M = moderately sensitive H = highly sensitive

When the produce is coated as described above prior to storage, the relative humidity level can be substantially reduced while still allowing for the desired percent mass of the produce to be maintained during storage. For example, in some cases the coated produce can be stored and/or shipped at average relative humidity levels less than about 90%, less than about 85%, less than about 80%, less than about 75%, less than about 70%, less than about 65%, or less than about 60%. As such, fungal growth in and spoilage of the produce is reduced while mass loss during storage is maintained at acceptable levels.

With reference to Table 3, leafy greens, herbs, or vegetables that have a very high surface area to volume ratio, such as artichoke, arugula, asparagus, bok choy, broccoli, Brussels sprouts, cabbage, cauliflower, celery, chives, corn, daikon, cilantro, mint, parsley, kale, leek, lettuce, green onions, bell peppers, spinach, sprouts (e.g., alfalfa sprouts, bean sprouts, radish sprouts), and carrots tend to lose percent mass at a higher rate than most other produce, and are therefore usually stored and shipped at very high relative humidity, typically at least 95%, making them very susceptible to molding and spoilage during storage. Forming a protective coating over the surfaces of these agricultural products, as described above, can allow them to be stored and/or shipped at lower relative humidity levels, for example less than 95% RH, less than 90% RH, or less than 85% RH, thereby reducing the rate of spoilage while still maintaining a sufficiently low mass loss rate.

Still referring to Table 3, berries, including blackberries, blueberries, cranberries, dewberries, elderberries, loganberries, raspberries, and strawberries, are typically all stored at a relative humidity of at least 90%. Forming a protective coating over the surfaces of these agricultural products, as described above, can allow them to be stored and/or shipped at lower relative humidity levels, for example less than 90% RH, less than 85% RH, or less than 80% RH, thereby reducing the rate of spoilage while still maintaining a sufficiently low mass loss rate.

Still referring to Table 3, other thin skinned fruits and vegetables, including apricots, pears, cherries, kumquats, cucumbers, grapes, mushrooms, nectarines, peaches, pears, plums, prunes, potatoes, tomatoes, are also typically stored at a relative humidity of at least 90%. Many thicker skinned fruits, including apples, melons, bananas, beans (e.g., snap beans, green beans, lima beans, long beans), blood oranges, tangerines, eggplant, guavas, kiwifruit, lychee, persimmons, pomegranates, watermelon, are also typically stored at a relative humidity of at least 90%. Forming a protective coating over the surfaces of these agricultural products, as described above, can allow them to be stored and/or shipped at lower relative humidity levels, for example less than 90% RH, less than 85% RH, or less than 80% RH, thereby reducing the rate of spoilage while still maintaining a sufficiently low mass loss rate.

Referring still to Table 3, other fruits and vegetables, for example cherries, avocados, papayas, starfruit, oranges (other than blood oranges), pummelos, tangelos, lemons, limes, grapefruit, figs, jicama, mangoes, many melons (casaba, crenshaw, honeydew, and Persian melons), papaya, passionfruit, yams, cassava, are typically stored at a relative humidity of at least 85%. Forming a protective coating over the surfaces of these agricultural products, as described above, can allow them to be stored and/or shipped at lower relative humidity levels, for example less than about 85% RH, less than about 80% RH, or less than about 75% RH, thereby reducing the rate of spoilage while still maintaining a sufficiently low mass loss rate.

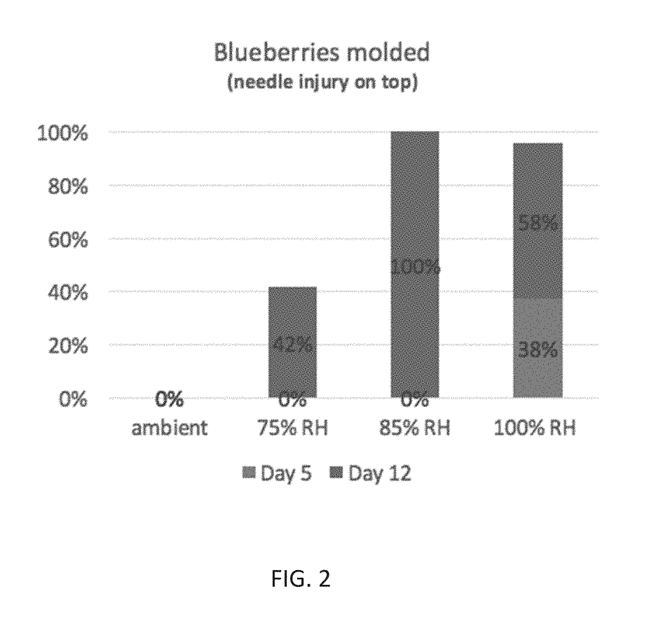

FIGS. 2, 3 and 4 are plots of measured data demonstrating the correlation between relative humidity levels during storage of blueberries at room temperature and resulting rates of molding/spoilage. As shown in FIG. 2, four groups of 24 blueberries each were wounded with a needle near the top (flower end) of the blueberry (in order to controllably increase the blueberries' susceptibility to spoilage) and then inoculated with spores of Botrytis cinerea conidia. The groups were then held at room temperature (about 18-20° C.) and maintained at different relative humidity levels for a period of 12 days in order to demonstrate the effect that increased relative humidity has in causing molding/spoilage. The first group was maintained at ambient conditions, for which the relative humidity was in the range of 30-50% throughout the 12 days. The second group was maintained at 75% relative humidity, the third group was maintained at 85% relative humidity, and the fourth group was maintained in saturated conditions (about 100% relative humidity). FIG. 2 illustrates the percentage of blueberries in each group displaying visible signs of molding after five days and after twelve days. None of the blueberries in the first, second, or third groups displayed any molding after five days, while 38% of the blueberries in the fourth group displayed molding after five days. After twelve days, none of the blueberries maintained at 30-50% relative humidity (first group) displayed any visible molding, while 42% of the blueberries maintained at 75% relative humidity (second group) and 100% of the blueberries maintained at 85% relative humidity (third group) displayed visible signs of molding. Additionally, 96% of the blueberries maintained at 100% relative humidity displayed visible molding.

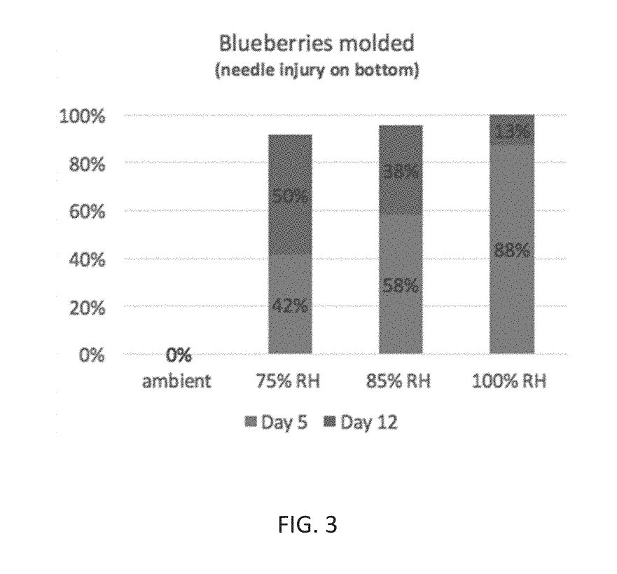

FIG. 3 is similar to FIG. 2, except that the blueberries used for the data in FIG. 3 were wounded with a needle near the bottom (stem end) of the blueberry and then inoculated with spores of—Botrytis cinerea conidia. The four groups of 24 blueberries each were then held at room temperature (about 18-20° C.) and maintained at different relative humidity levels for a period of 12 days. The first group was maintained at ambient conditions, for which the relative humidity was in the range of 30-50% throughout the 12 days. The second group was maintained at 75% relative humidity, the third group was maintained at 85% relative humidity, and the fourth group was maintained in saturated conditions (about 100% relative humidity). FIG. 3 illustrates the percentage of blueberries in each group displaying visible signs of molding after five days and after twelve days. None of the blueberries in the first group displayed any molding after five days or after twelve days. However, for the second group, 42% of the blueberries displayed visible molding after five days, and 92% displayed visible molding after twelve days. For the third group, 58% of the blueberries displayed visible molding after five days, and 96% displayed visible molding after twelve days. For the fourth group, 88% of the blueberries displayed visible molding after five days, and all (100%) displayed visible molding after twelve days.

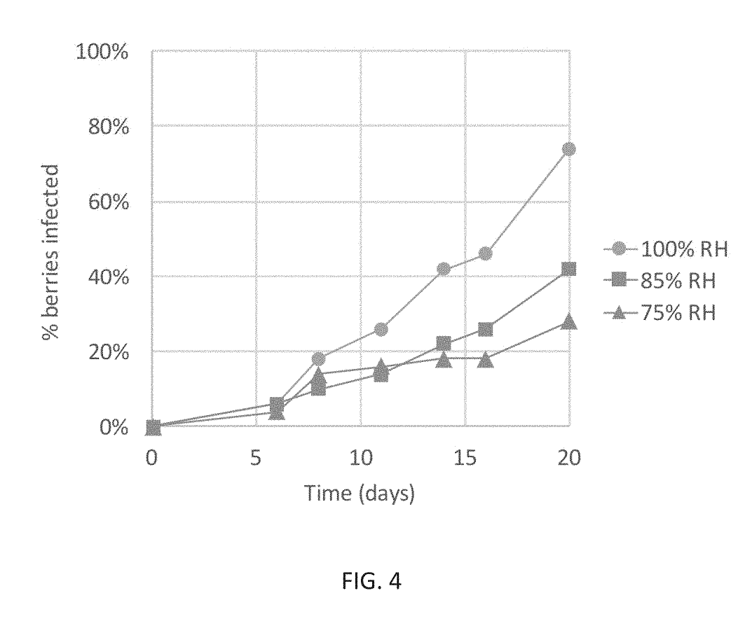

For the chart in FIG. 4, three groups of 50 blueberries each, none of which were wounded, were inoculated with spores of—Botrytis cinerea conidia. The groups were then held at room temperature (about 18-20° C.) and maintained at different relative humidity levels for a period of 20 days in order to demonstrate the effect that increased relative humidity has in causing molding/spoilage. The first group was maintained at 75% relative humidity, the second group was maintained at 85% relative humidity, and the third group was maintained in saturated conditions (about 100% relative humidity). FIG. 4 illustrates the percentage of blueberries in each group displaying visible signs of molding after six days, eight days, eleven days, fourteen days, sixteen days, and twenty days. As shown, the rate of molding in the group maintained in saturated conditions (third group) was highest, followed by the group maintained at 85% relative humidity (second group). The group maintained at 75% relative humidity (first group) had the lowest rate of molding. Specifically, after twenty days, 28% of the blueberries in the first group displayed visible signs of molding, 42% of the blueberries in the second group displayed visible signs of molding, and 74% of the blueberries in the third group displayed visible signs of molding. Although not shown in FIG. 4, unwounded blueberries maintained at a relative humidity in the range of about 30-50% at room temperature have generally been observed to exhibit little or no molding even after twenty days (typically less than 5% of blueberries display visible signs of molding after twenty days).

Without wishing to be bound by theory, the results shown in FIGS. 2, 3 and 4 indicate that storage of produce (e.g., berries) under conditions of higher relative humidity (e.g., above about 75% or 85% relative humidity) leads to greater spoilage due to molding compared with storing the produce at a lower relative humidity.

Through extensive experimentation, it has been found that coatings formed from compounds described above, and in particular from combinations of 2-monoacylglycerides and one or more of the other compounds described above (e.g., 1-monoacylglycerides, fatty acids, esters, triglycerides, diglycerides, monoglycerides, amides, amines, thiols, thioesters, carboxylic acids, ethers, aliphatic waxes, alcohols, salts (e.g., inorganic and organic salts), acids, bases, proteins, enzymes, or combinations thereof), are effective at reducing mass/water loss and increasing the shelf of the agricultural products, even at reduced relative humidity levels. In some cases, the coatings were further found to be effective at preventing or reducing molding and spoilage in produce as compared to similar produce maintained at the same temperature and relative humidity but without a coating.

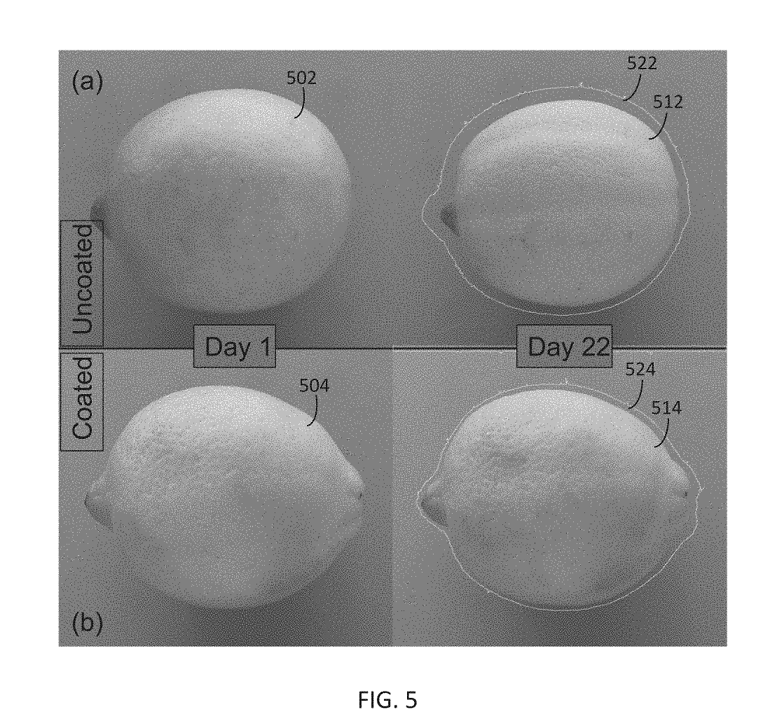

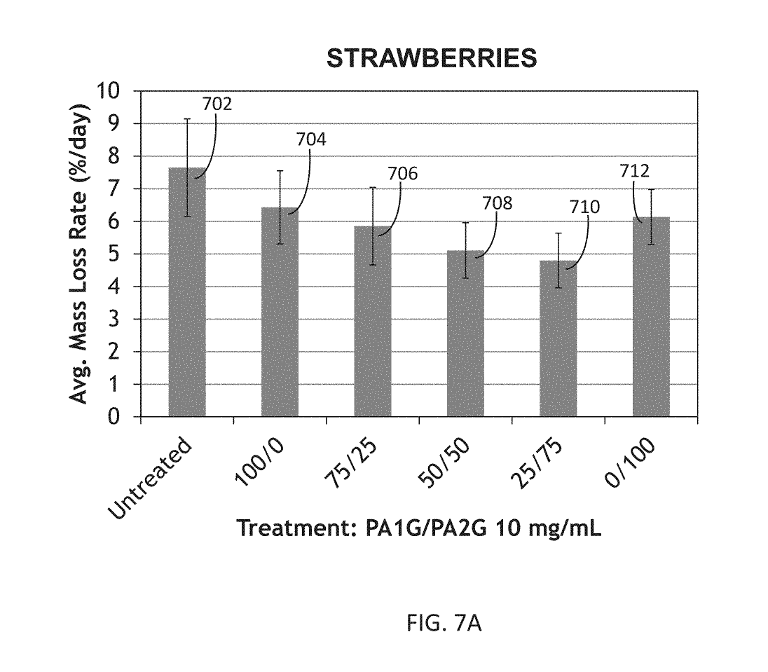

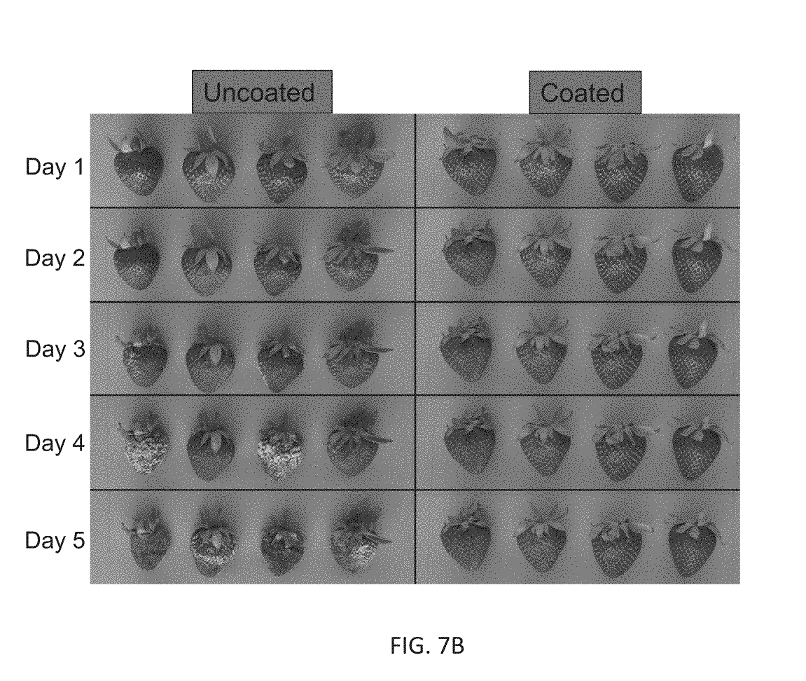

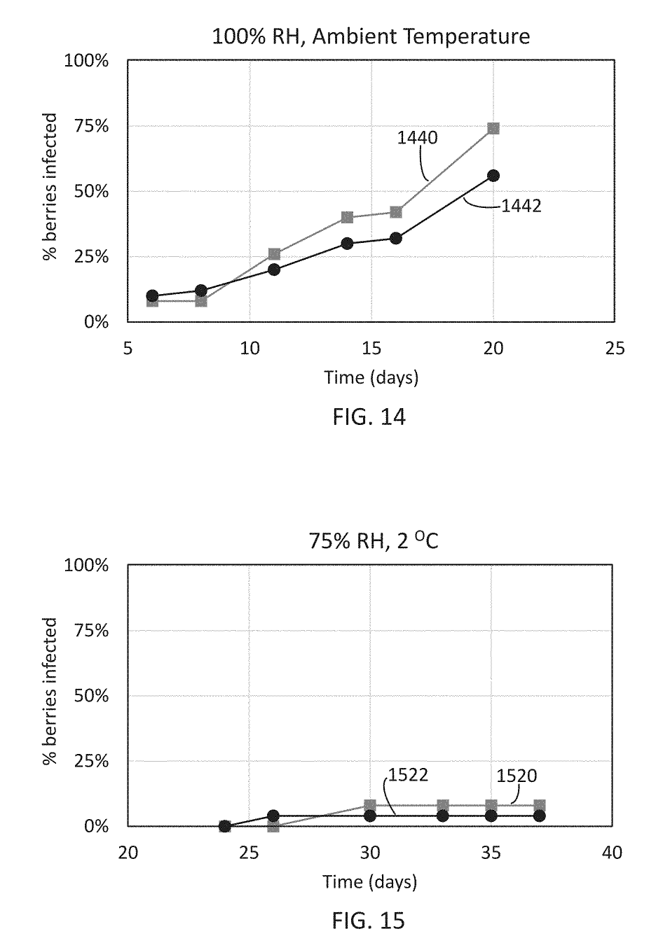

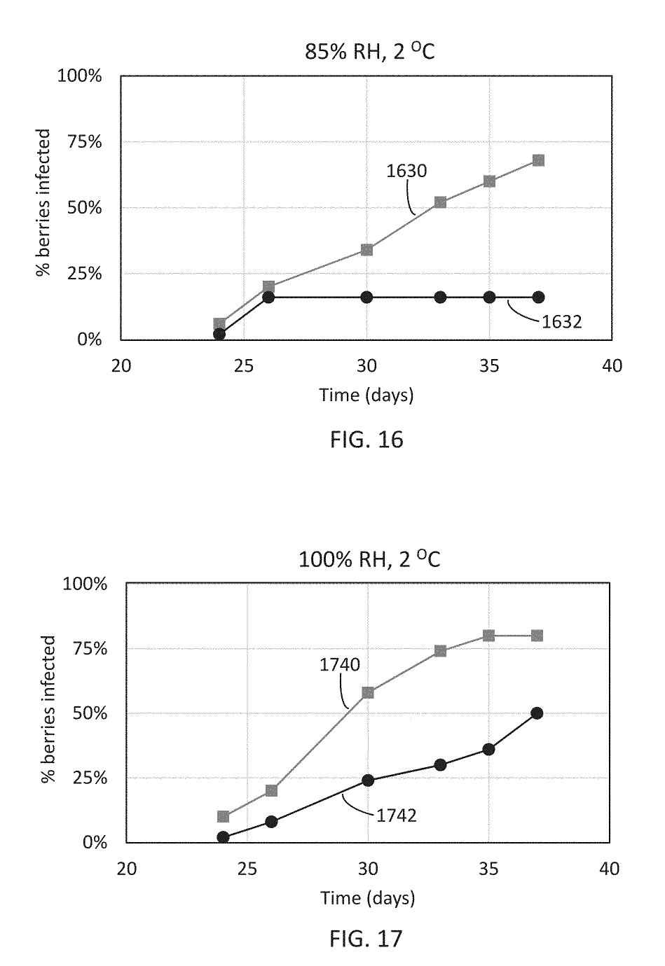

FIGS. 5-25 illustrate the reduced mass loss effects at various relative humidities for a variety of produce coated as described herein, as well as the effects of relative humidity on spoilage rates. In some cases (e.g., strawberries and blueberries, as shown in FIGS. 7 and 12-17), the coatings also resulted in reduced molding and/or spoilage as compared to similar produce maintained at the same temperature and relative humidity but without a coating. The coatings formed on the produce shown or referred in FIGS. 5-19 were each formed from compositions that included a mixture of compounds of Formula I-A (as previously defined) and an additive including compounds of Formula I-B (as also previously defined), wherein, except where indicated, a mass ratio of the additive to the compound of Formula I-A was in a range of 0.1 to 1. To form the coatings, solid mixtures of the compositions were first fully dissolved in ethanol or and ethanol/water mixture to form a solution. The solution was then applied to the agricultural products either by spraying or dip coating, as detailed for each of the cases below. The agricultural products were then dried on drying racks under ambient conditions (temperature in the range of 23-27° C., relative humidity in the range of 40-55%) until all of the solvent had evaporated, allowing the coatings to form over the substrates. The resultant coatings each had a thickness in the range of 0.5 μm to 1 μm.

FIG. 5 shows the effects of mass loss over time observed in lemons over the course of 3 weeks, both for uncoated lemons and for lemons that were coated with compositions described herein. The composition included PA-1G and PA-2G mixed at a 25:75 molar ratio. The composition was dissolved in ethanol at a concentration of 10 mg/mL to form a solution. In order to form the coatings, the lemons were placed in a bag, and the solution containing the composition was poured into the bag. The bag was then sealed and lightly agitated until the entire surface of each lemon was wet. The lemons were then removed from the bag and allowed to dry on drying racks under ambient room conditions at a temperature in the range of about 23-27° C. and relative humidity in the range of about 40-55%. The lemons were held at these same temperature and relative humidity conditions for the entire duration of the time they were tested. 502 is a high resolution photograph of an uncoated lemon immediately after being picked (Day 1), and 504 is a high resolution photograph of a lemon immediately after being picked and coated on the same day. 512 and 514 are photographs of the uncoated and coated lemons, respectively, taken on Day 22, 21 days after photographs 502 and 504. In order to better visualize the cross-sectional area loss (which is directly related to mass loss), an overlay 522 of the outline of the uncoated lemon on Day 1 is shown around 512, and an overlay 524 of the outline of the coated lemon on Day 1 is shown around 514. The coated lemons had a cross sectional area greater than 90% of their original area (e.g., greater than 92% of their original area), whereas the uncoated lemons had a cross sectional area less than 80% of their original area, thereby indicating reduced mass loss observed for coated lemons stored at less than 90% relative humidity (e.g., 40-55% relative humidity) as compared to uncoated lemons stored under the same conditions.

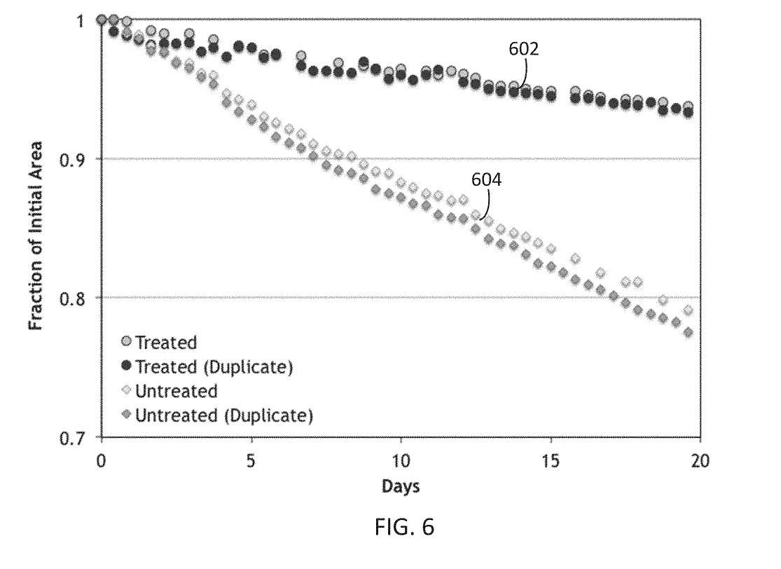

FIG. 6 shows plots for both coated (602) and uncoated (604) lemons indicating the reduction in cross sectional area as a function of time over a period of 20 days, where the coatings were formed in the same way as those described with reference to FIG. 5. Specifically, on each day, high resolution images of each of the lemons were taken and analyzed with image processing software (as in FIG. 5) to determine the ratio of the cross sectional area on the particular day to the initial cross sectional area of the lemon. As seen in FIG. 6, after 20 days, the coated lemons had a cross sectional area greater than 90% of their original area (e.g., greater than 92% of their original area), whereas the uncoated lemons had a cross sectional area less than 80% of their original area, thereby indicating the reduced mass loss observed for coated lemons stored at less than 90% relative humidity (e.g., 40-55% relative humidity) as compared to uncoated lemons stored under the same conditions.

FIG. 7A is a graph showing average daily mass loss rates for coated and uncoated harvested strawberries stored at low relative humidity levels for 4 days. The coating agents included various mixtures of PA-1G and PA-2G, as detailed below. Each bar in the graph represents average daily mass loss rates for a group of 15 strawberries. The strawberries corresponding to bar 702 were untreated (control group). The strawberries corresponding to bar 704 were treated with a solution for which the coating agent was substantially pure PA-1G. The strawberries corresponding to bar 706 were treated with a solution for which the coating agent was 75% PA-1G and 25% PA-2G by mass. The strawberries corresponding to bar 708 were treated with a solution for which the coating agent was 50% PA-1G and 50% PA-2G by mass. The strawberries corresponding to bar 710 were treated with a solution for which the coating agent was 25% PA-1G and 75% PA-2G by mass. The strawberries corresponding to bar 712 were treated with a solution for which the coating agent was substantially pure PA-2G. The coating agents were each dissolved in substantially pure ethanol (sanitizing agent) at a concentration of 10 mg/mL to form the solution, and the solution was applied to the surfaces of the strawberries to sanitize the surfaces and to form coatings. The strawberries were kept under ambient room conditions at a temperature in the range of about 23° C.-27° C. and humidity in the range of about 40%-55% for the entire duration of the time they were tested.

As shown in FIG. 7A, the untreated strawberries (702) exhibited an average mass loss rate of greater than 7.5% per day. The mass loss rates of the strawberries treated with the substantially pure 2,3-dihydroxypropan-2-yl hexadecanoate formulation (704) and the substantially pure 1,3-dihydroxypropan-2-yl hexadecanoate formulation (712) exhibited average daily mass loss rates between 6% and 6.5%, which was better than that of the untreated strawberries (702). The strawberries corresponding to bar 706 (2,3-dihydroxypropan-2-yl hexadecanoate to 1,3-dihydroxypropan-2-yl hexadecanoate mass ratio of 3) exhibited even lower mass loss rates, slightly less than 6% per day. The strawberries corresponding to bars 708 and 710 (2,3-dihydroxypropan-2-yl hexadecanoate to 1,3-dihydroxypropan-2-yl hexadecanoate mass ratios of 1 and 0.33, respectively) exhibited substantially improved mass loss rates; the strawberries corresponding to bar 708 exhibited average daily mass loss rates of just over 5%, while the strawberries corresponding to bar 710 exhibited average daily mass loss rates of under 5%.

FIG. 7B shows high-resolution photographs of 4 coated and 4 uncoated strawberries over the course of 5 days. The coating composition was a 25:75 molar ratio of PA-1G to PA-2G, as in bar 710 in FIG. 7A. As seen, the uncoated strawberries began to exhibit fungal growth and discoloration by Day 3, and were mostly covered in fungus by Day 5. In contrast, the coated strawberries did not exhibit any visible fungal growth by Day 5 and were largely similar in overall color and appearance on Day 1 and Day 5, indicating a reduction in molding in spoilage for coated strawberries stored at less than 90% relative humidity (e.g., 40-55% relative humidity) as compared to uncoated strawberries stored under the same conditions. Accordingly, without wishing to be bound by theory, as set forth in FIGS. 7A and 7B, coating produce with a coating agent comprising 1-monoacylglycerides and/or 2-monoacylglycerides can be effective at reducing a rate of and/or delaying the onset of fungal growth while at the same time reducing a mass loss rate of the produce during storage at low relative humidities. That is, the treatment can reduce the rate of fungal growth over the produce, and/or can increase the shelf life of the produce prior to fungal growth, while at the same time reducing a mass loss rate of the produce.

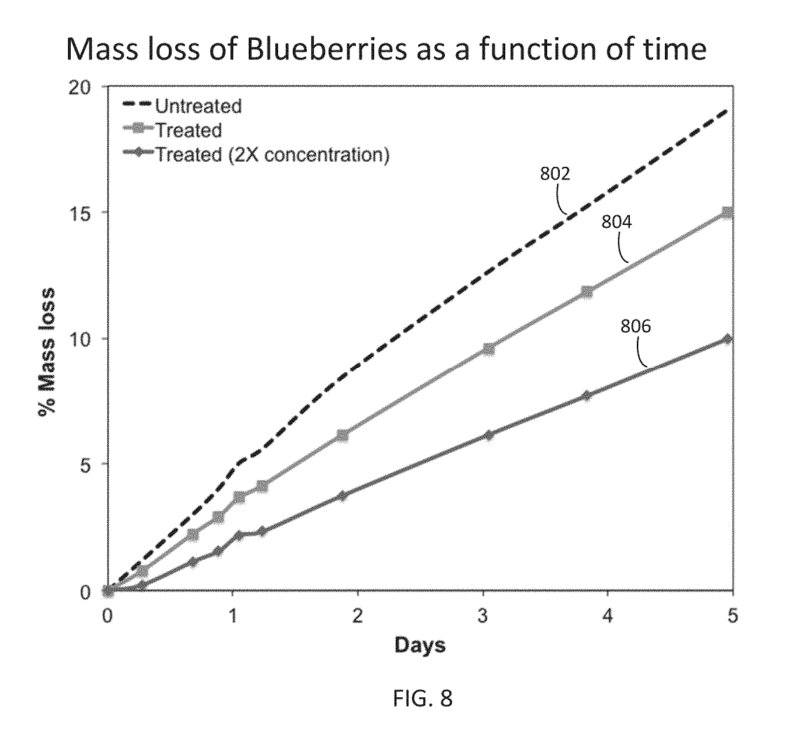

FIG. 8 shows plots of the percent mass loss over the course of 5 days in uncoated blueberries (802), blueberries coated using a first solution of 10 mg/mL of compounds dissolved in ethanol (804), and blueberries coated using a second solution of 20 mg/mL of compounds dissolved in ethanol (806). The compounds in both the first and second solutions included a mixture of PA-1G and PA-2G, where the mass ratio and molar ratio of PA-1G to PA-2G was about 0.33 (i.e., a molar ratio of 25:75). To form the coatings over the blueberries, the following dip coating procedures were used. Each blueberry was gently picked up with a set of tweezers and individually dipped in the solution for approximately 1 second or less, after which the blueberry was placed on a drying rack and allowed to dry. The blueberries were kept under ambient room conditions at a temperature in the range of about 23-27° C. and relative humidity in the range of about 40-55% while they dried and for the entire duration of the time they were tested. Mass loss was measured by carefully weighing the blueberries each day, where the reported percent mass loss was equal to the ratio of mass reduction to initial mass. As shown, the percent mass loss for uncoated blueberries was almost 20% after 5 days, whereas the percent mass loss for blueberries coated with the 10 mg/mL solution was less than 15% after 5 days, and the percent mass loss for blueberries coated with the 20 mg/mL solution was less than 10% after 5 days, thereby indicating reduced mass loss observed for coated blueberries stored at less than 90% relative humidity (e.g., 40-55% relative humidity) as compared to uncoated blueberries stored under the same conditions.

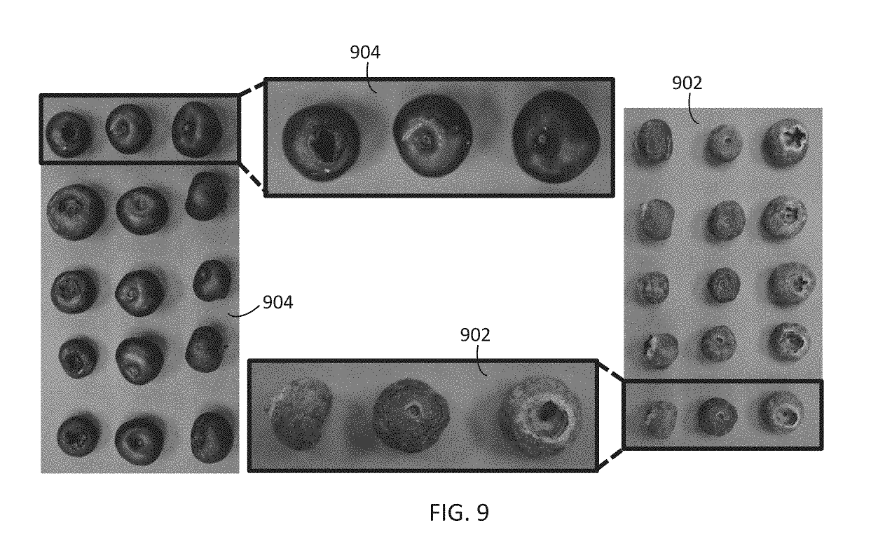

FIG. 9 shows high-resolution photographs of the uncoated blueberries (902) and of the blueberries coated with the 10 mg/mL solution (904) at Day 5. The skins of the uncoated blueberries 802 were highly wrinkled as a result of mass loss of the blueberries, whereas the skins of the coated blueberries remained very smooth.

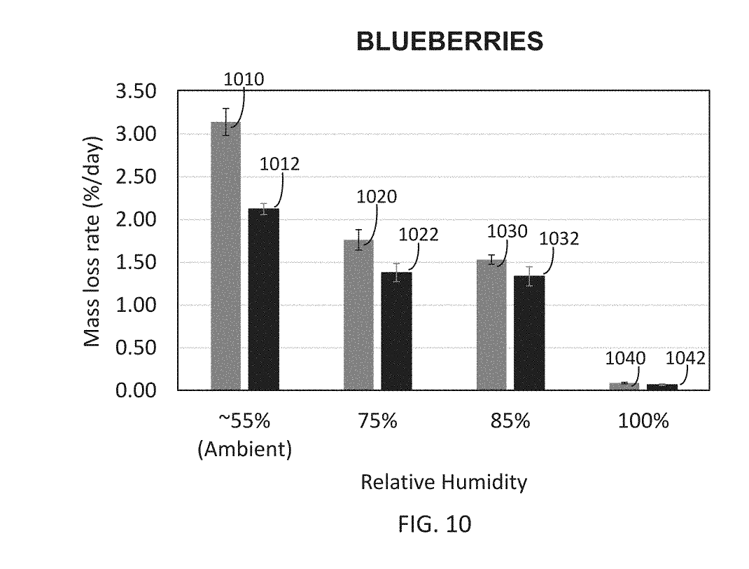

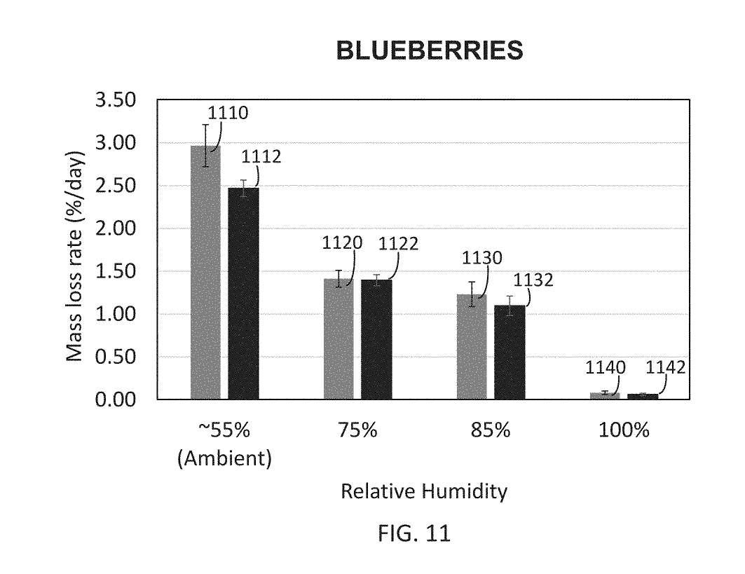

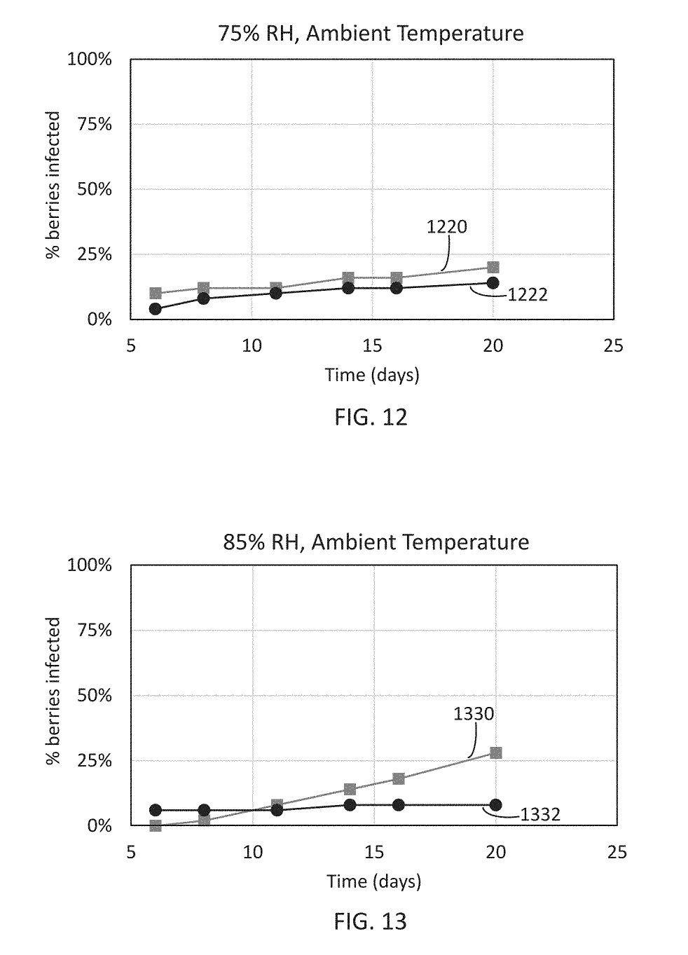

FIGS. 10-17 illustrate the results of another set of experiments comparing the effects of coatings on both mass loss rates and spoilage rates of emerald blueberries stored at various relative humidities. FIGS. 10-11 compare the mass loss rates of coated and uncoated blueberries at different relative humidity levels, while FIGS. 12-17 compare the spoilage rates of coated and uncoated blueberries at different relative humidity levels. FIGS. 10-14 correspond to storage at ambient temperature (about 20° C.), while FIGS. 15-17 correspond to storage at 2° C.

FIGS. 10 and 11 are plots of average daily mass loss rates over the course of 23 days for groups of coated and uncoated blueberries stored at various relative humidity levels at ambient temperature (about 20° C.). The blueberries corresponding to FIG. 10 were sanitized by soaking for 2 minutes in a 1% bleach solution prior to being coated/tested, while the blueberries corresponding to FIG. 11 were coated/tested without sanitization. Referring to FIG. 10, bars 1040, 1030, 1020, and 1010 correspond to uncoated blueberries stored at respective relative humidities of 100% (saturated conditions), 85%, 75%, and about 55% (approximate ambient humidity), and bars 1042, 1032, 1022, and 1012 correspond to coated blueberries stored at respective relative humidities of 100% (saturated conditions), 85%, 75%, and about 55% (approximate ambient humidity). Referring to FIG. 11, bars 1140, 1130, 1120, and 1110 correspond to uncoated blueberries stored at respective relative humidities of 100% (saturated conditions), 85%, 75%, and about 55% (approximate ambient humidity), and bars 1142, 1132, 1122, and 1112 correspond to coated blueberries stored at respective relative humidities of 100% (saturated conditions), 85%, 75%, and about 55% (approximate ambient humidity). Each bar in both graphs represents a group of 50 blueberries. For the coated blueberries, the solution used to form each of the coatings included a coating composition dissolved in 80% ethanol (i.e., an 80:20 mix of ethanol and water) at a concentration of 20 mg/mL, where the coating composition was a 30:70 mixture of PA-1G and PA-2G.

In order to form the coatings, the blueberries were placed in bags, and the solution containing the composition was poured into the bag. The bag was then sealed and lightly agitated until the entire surface of each blueberry was wet. The blueberries were then removed from the bag and allowed to dry on drying racks. The blueberries were then kept at the temperature and relative humidity levels specified above for the entire duration of time they were tested. The desired relative humidity was achieved by sealing groups of 50 blueberries in 7 L containers with exposed saturated salt solutions: sodium chloride for 75% relative humidity, potassium chloride for 85%, and pure water for 100%.

As seen in FIGS. 10 and 11, the average daily mass loss rate decreased with increasing relative humidity both for coated and uncoated blueberries. Furthermore, for the sanitized blueberries, the coated blueberries stored at relative humidities of 100%, 85%, 75%, and about 55% all had average daily mass loss rates that were substantially less (i.e., at least 10% less) than uncoated blueberries stored at the same conditions. In the case of non-sanitized blueberries, the coated blueberries stored at relative humidities of 100%, 85%, and about 55% all had average daily mass loss rates that were substantially less (i.e., at least 10% less) than uncoated blueberries stored at the same conditions, while the average daily mass loss rate of blueberries stored at 75% relative humidity was about the same for coated and uncoated blueberries. Additionally, for the sanitized blueberries referenced in FIG. 10, the average daily mass loss rate of coated blueberries stored at 75% relative humidity was about the same as that of coated blueberries stored at 85% relative humidity, and was substantially less than that of coated blueberries stored at either 75% or 85% relative humidity.

FIGS. 12-17 are plots of blueberry molding rates (i.e., percent of blueberries exhibiting visible molding) as a function of time for both coated and uncoated emerald blueberries measured at a variety of relative humidity conditions. FIGS. 12-14 correspond to blueberries stored at ambient temperature (about 20° C.) at relative humidities of 75%, 85%, and 100%, respectively, while FIGS. 15-17 correspond to blueberries stored at 2° C. at relative humidities of 75%, 85%, and 100%, respectively. In FIGS. 12-14, data lines 1220, 1330, and 1440 correspond to uncoated blueberries, while data lines 1222, 1332, and 1442 correspond to coated blueberries. In FIGS. 15-17, data lines 1520, 1630, and 1740 correspond to uncoated blueberries, while data lines 1522, 1632, and 1742 correspond to coated blueberries. Each data line represents a group of 50 blueberries. Coating formulations for all of the coated blueberries referenced in FIGS. 12-17 were the same as those for the blueberries in FIGS. 10-11 (30:70 mixture of PA-1G to PA-2G), and the solution used to form each of the coatings and coating deposition method were also the same as that described with reference to FIGS. 10-11. Molding rates for coated and uncoated blueberries stored at ambient humidity (about 55% relative humidity) were also measured both at ambient temperature (about 20° C.) and at 2° C., but no visible signs of molding were observed on any of the blueberries during the time periods reported in FIGS. 12-17.

As seen in FIGS. 12-17, for uncoated blueberries stored at ambient temperature and at 2° C., molding rates increased with increasing relative humidity. Furthermore, at each relative humidity level at a given temperature, the coated blueberries stored under the same conditions exhibited lower molding rates than the corresponding uncoated blueberries. Additionally, the onset of molding occurred much later at lower temperature both for coated and uncoated blueberries. As such, molding rates for blueberries stored at ambient temperature were measured and reported during the first 20 days of storage, whereas molding rates for blueberries stored at 2° C. were measured and reported during days 24-37 of storage.

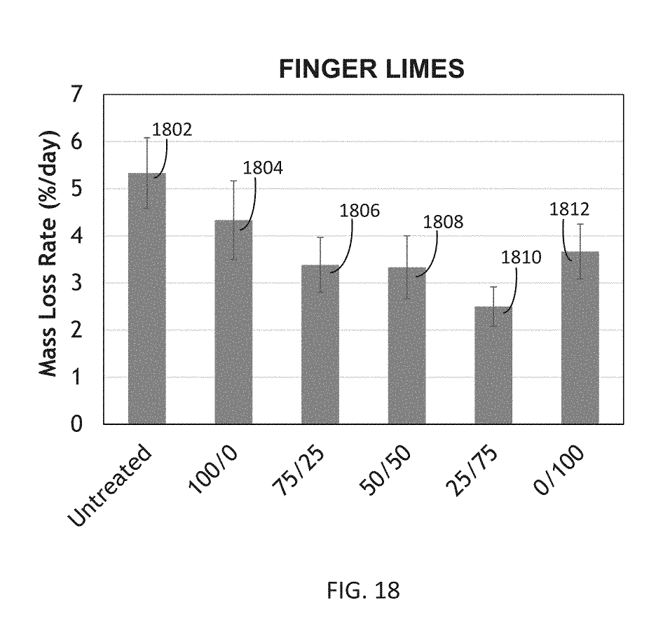

FIG. 18 is a graph showing average daily mass loss rates for finger limes coated with various mixtures of PA-2G (compound of Formula I-A) and PA-1G (additive) measured over the course of several days. Each bar in the graph represents average daily mass loss rates for a group of 24 finger limes. The finger limes corresponding to bar 1802 were uncoated (control group). The finger limes corresponding to bar 1804 were coated with a mixture that was substantially pure PA-1G. The finger limes corresponding to bar 1806 were coated with a mixture that was about 75% PA-1G and 25% PA-2G by mass (mass ratio and molar ratio of PA-1G to PA-2G was about 3). The finger limes corresponding to bar 1808 were coated with a mixture that was about 50% PA-1G and 50% PA-2G by mass (mass ratio and molar ratio of PA-1G to PA-2G was about 1). The finger limes corresponding to bar 1810 were coated with a mixture that was about 25% PA-1G and 75% PA-2G by mass (mass ratio and molar ratio of PA-1G to PA-2G was about 0.33). The finger limes corresponding to bar 1812 were coated with a mixture that was substantially pure PA-2G. The coating compositions were each dissolved in ethanol at a concentration of 10 mg/mL to form a solution, and the solution was applied to the surface of the finger limes to form the coatings.

In order to form the coatings, the finger limes were placed in bags, and the solution containing the composition was poured into the bag. The bag was then sealed and lightly agitated until the entire surface of each finger lime was wet. The finger limes were then removed from the bag and allowed to dry on drying racks. The finger limes were kept under ambient room conditions at a temperature in the range of about 23° C.-27° C. and humidity in the range of about 40%-55% while they dried and for the entire duration of the time they were tested.

As shown in FIG. 18, the uncoated finger limes (1802) exhibited an average mass loss rate of over 5% per day. The mass loss rates of the finger limes coated with the substantially pure PA-1G formulation (1804) and the substantially pure PA-2G formulation (1812) exhibited average daily mass loss rates of just over 4% and just under 4%, respectively, which was nominally better than the uncoated finger limes (1802). The finger limes corresponding to bar 1806 (75:25 mass ratio of PA-1G to PA-2G, or a mass ratio of about 3) showed improved results, yielding an average daily mass loss rate of less than 3.5%. The finger limes corresponding to bars 1808 and 1810 (PA-1G to PA-2G mass ratios of about 1 (50:50) and 0.33 (25:75), respectively) exhibited mass loss rates under 3.5% and under 2.6%, respectively, which was a substantial improvement over the uncoated finger limes (1802).

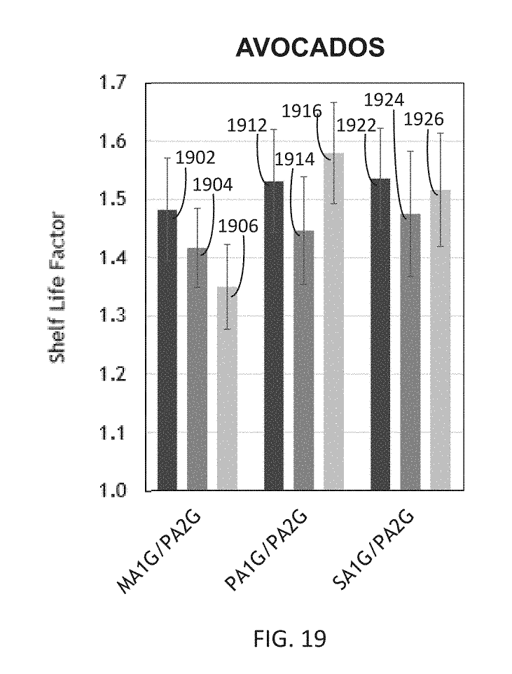

FIG. 19 is a graph showing the shelf life factor for avocados coated with various mixtures of PA-2G (compound of Formula I-A) and a 1-monoacylglyceride additive (bars 1902, 1904, and 1906 are for MA-1G; bars 1912, 1914, and 1916 are for PA-1G; bars 1922, 1924, and 1926 are for SA-1G). As used herein, the term “shelf life factor” is defined as the ratio of the average mass loss rate of uncoated produce (measured for a control group) to the average mass loss rate of the corresponding coated produce. Hence a larger shelf life factor corresponds to a greater reduction in average mass loss rate. Bars 1902, 1912, and 1922 correspond to a 25:75 mixture of 1-monoacylglycerides to PA-2G (molar ratio of 1-monoacylglycerides to PA-2G of about 0.33). Bars 1904, 1914, and 1924 correspond to a 50:50 mixture of 1-monoacylglycerides to PA-2G (molar ratio of 1-monoacylglycerides to PA-2G of about 1). Bars 1906, 1916, and 1926 correspond to a 75:25 mixture of 1-monoacylglycerides to PA-2G (molar ratio of 1-monoacylglycerides to PA-2G of about 3).

Each bar in the graph represents a group of 30 avocados. All coatings were formed by dipping the avocados in a solution comprising the associated mixture dissolved in substantially pure ethanol at a concentration of 5 mg/mL, placing the avocados on drying racks, and allowing the avocados to dry under ambient room conditions at a temperature in the range of about 23° C.-27° C. and humidity in the range of about 40%-55%. The avocados were held at these same temperature and humidity conditions for the entire duration of the time they were tested.

As seen, for both the MA-1G/PA-2G and SA-1G/PA-2G combinations, the greatest shelf life factor was achieved for a 1-monoacylglyceride to PA-2G molar ratio of about 0.33. For the case of the PA-1G/PA-2G combinations, the greatest shelf life factor was achieved for the avocados coated with the PA-1G/PA-2G ratio of 75:25.

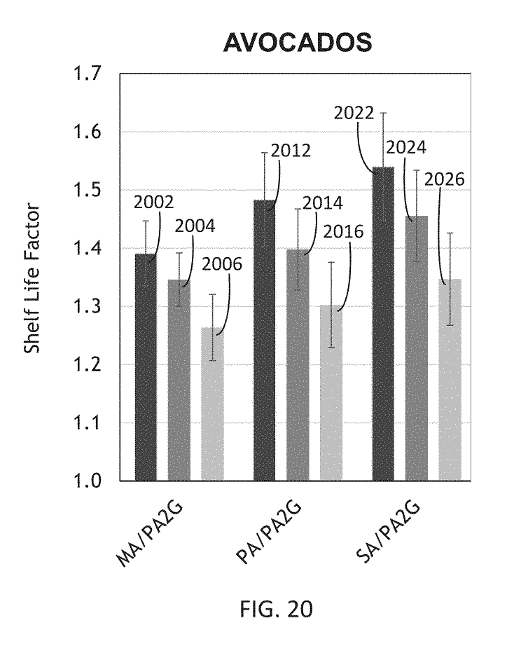

FIGS. 20-25 demonstrate the reduced mass loss effects at low relative humidities for avocados coated with a variety of coating agent formulations. FIG. 20 is a graph showing the shelf life factor for avocados coated with various mixtures of PA-2G (compound of Formula I-A) and a fatty acid additive (bars 2002, 2004, and 2006 are for MA; bars 2012, 2014, and 2016 are for PA; bars 2022, 2024, and 2026 are for SA). Bars 2002, 2012, and 2022 correspond to a 25:75 mixture of fatty acid to PA-2G (molar ratio of fatty acid to PA-2G of about 0.33). The mass ratios are about 0.23, 0.25, and 0.28, respectively. Bars 2004, 2014, and 2024 correspond to a 50:50 mixture of fatty acid to PA-2G (molar ratio of fatty acid to PA-2G of about 1). The mass ratios are about 0.35, 0.39, and 0.43, respectively. Bars 2006, 2016, and 2026 correspond to a 75:25 mixture of fatty acid to PA-2G (molar ratio of fatty acid to PA-2G of about 3). The mass ratios are about 2.1, 2.3, and 2.6, respectively.

Each bar in the graph represents a group of 30 avocados. All coatings were formed by dipping the avocados in a solution comprising the associated mixture dissolved in substantially pure ethanol at a concentration of 5 mg/mL, placing the avocados on drying racks, and allowing the avocados to dry under ambient room conditions at a temperature in the range of about 23° C.-27° C. and humidity in the range of about 40%-55%. The avocados were held at these same temperature and humidity conditions for the entire duration of the time they were tested. As seen, for all three of these combinations, the greatest shelf life factor was achieved for a fatty acid to PA-2G molar ratio of about 0.33.

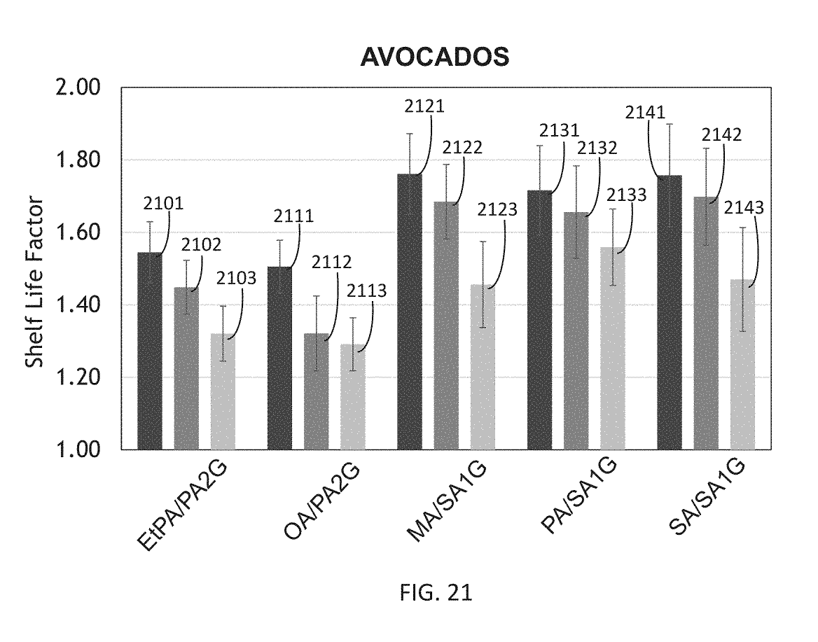

FIG. 21 is a graph showing the shelf life factor for avocados coated with various other compounds. Each bar in the graph represents a group of 30 avocados. All coatings were formed by dipping the avocados in a solution comprising the associated mixture dissolved in substantially pure ethanol at a concentration of 5 mg/mL, placing the avocados on drying racks, and allowing the avocados to dry under ambient room conditions at a temperature in the range of about 23° C.-27° C. and humidity in the range of about 40%-55%. The avocados were held at these same temperature and humidity conditions for the entire duration of the time they were tested.

Bars 2101-2103 correspond to mixtures of PA-2G (compound of Formula I-A) with ethyl palmitate as an additive. Bars 2111-2113 correspond to mixtures of PA-2G (compound of Formula I-A) with oleic acid (unsaturated fatty acid) as an additive. Bars 2101 and 2111 correspond to a 25:75 mixture of additive to PA-2G (molar ratio of additive to PA-2G of about 0.33). The mass ratios are both about 0.86. Bars 2102 and 2112 correspond to a 50:50 mixture of additive to PA-2G (molar ratio of additive to PA-2G of about 1). The mass ratios both are about 0.43. Bars 2103 and 2113 correspond to a 75:25 mixture of additive to PA-2G (molar ratio of additive to PA-2G of about 3). The mass ratios are both about 2.58. As seen for the combinations of PA-2G and EtPA as well as for the combinations of PA-2G and OA, the greatest shelf life factor was achieved with additive to PA-2G molar ratio of about 0.33.

Bars 2121-2123, 2131-2133, and 2141-2143 correspond to coatings formed of a compound of Formula I-B (e.g., a 1-monoacylglyceride) and an additive (e.g., a fatty acid). Bars 2121-2123 correspond to mixtures of SA-1G (compound of Formula I-B) with myristic acid as an additive. Bars 2131-2133 correspond to mixtures of SA-1G (compound of Formula I-B) with palmitic acid as an additive. Bars 2141-2143 correspond to mixtures of SA-1G (compound of Formula I-B) with stearic acid as an additive. Bars 2121, 2131, and 2141 correspond to a 25:75 mixture of fatty acid to SA-1G (molar ratio of fatty acid to SA-1G of about 0.33). The mass ratios are about 0.21, 0.23, and 0.26, respectively. Bars 2122, 2132, and 2142 correspond to a 50:50 mixture of fatty acid to SA-1G (molar ratio of fatty acid to SA-1G of about 1). The mass ratios are about 0.32, 0.35, and 0.40, respectively. Bars 2123, 2133, and 2143 correspond to a 75:25 mixture of fatty acid to SA-1G (molar ratio of fatty acid to SA-1G of about 3). The mass ratios are about 1.89, 2.13, and 2.37, respectively. As seen for all three of these combinations, the greatest shelf life factor was achieved for a fatty acid to SA-1G molar ratio of about 0.33.

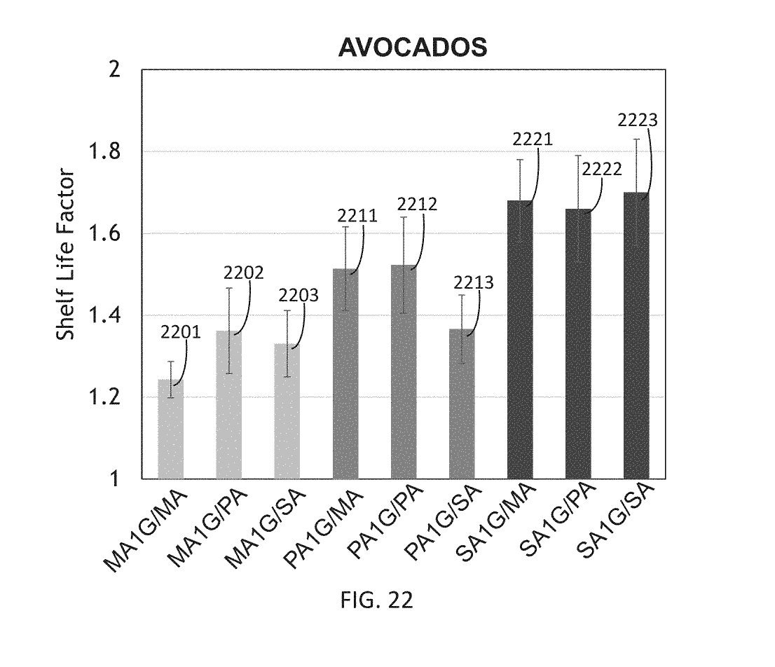

FIG. 22 is a graph showing the shelf life factor for avocados each coated with a mixture including a compound of Formula I-B and a fatty acid additive. All mixtures were a 1:1 mix by mole ratio of the compound of Formula I-B and the fatty acid. Bars 2201-2203 correspond to coatings with MA-1G as the compound of Formula I-B and MA (2201), PA (2202), and SA (2203) as the fatty acid additive. The mass ratios are about 1.32, 1.18, and 1.06, respectively. Bars 2211-2213 correspond to coatings with PA-1G as the compound of Formula I-B and MA (2211), PA (2212), and SA (2213) as the fatty acid additive. The mass ratios are about 1.44, 1.29, and 1.16, respectively. Bars 2221-2223 correspond to coatings with SA-1G as the compound of Formula I-B and MA (2221), PA (2222), and SA (2223) as the fatty acid additive. The mass ratios are about 1.57, 1.39, and 1.25, respectively. Each bar in the graph represents a group of 30 avocados. All coatings were formed by dipping the avocados in a solution comprising the associated mixture dissolved in substantially pure ethanol at a concentration of 5 mg/mL, placing the avocados on drying racks, and allowing the avocados to dry under ambient room conditions at a temperature in the range of about 23° C.-27° C. and humidity in the range of about 40%-55%. The avocados were held at these same temperature and humidity conditions for the entire duration of the time they were tested.

As shown, the shelf life factor tended to increase as the carbon chain length of the 1-monoacylglyceride was increased. For example, all mixtures having a 1-monoacylglyceride with a carbon chain length greater than 13 exhibited a shelf life factor great than 1.2, all mixtures having a 1-monoacylglyceride with a carbon chain length greater than 15 exhibited a shelf life factor great than 1.35, and all mixtures having a 1-monoacylglyceride with a carbon chain length greater than 17 exhibited a shelf life factor great than 1.6.

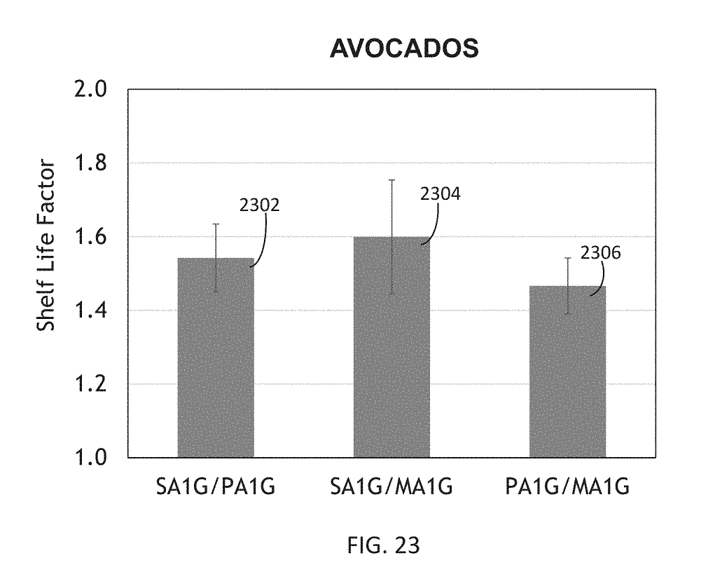

FIG. 23 is a graph showing the shelf life factor for avocados each coated with a mixture including two different compounds of Formula I-B, mixed at a 1:1 mole ratio, where for each mixture the 2 compounds of Formula I-B have a different length carbon chain. Bar 2302 corresponds to a mixture of SA-1G (C18) and PA-1G (C16), bar 2304 corresponds to a mixture of SA-1G (C18) and MA-1G (C14), and bar 2306 corresponds to a mixture of PA-1G (C16) and MA-1G (C14). Each bar in the graph represents a group of 30 avocados. All coatings were formed by dipping the avocados in a solution comprising the associated mixture dissolved in substantially pure ethanol at a concentration of 5 mg/mL, placing the avocados on drying racks, and allowing the avocados to dry under ambient room conditions at a temperature in the range of about 23° C.-27° C. and humidity in the range of about 40%-55%. The avocados were held at these same temperature and humidity conditions for the entire duration of the time they were tested. As shown, the PA-1G/MA-1G mixture (2306) resulted in a shelf life factor greater than 1.4, the SA-1G/PA-1G mixture (2302) resulted in a shelf life factor greater than 1.5, and the SA-1G/MA-1G mixture (2304) resulted in a shelf life factor of about 1.6.

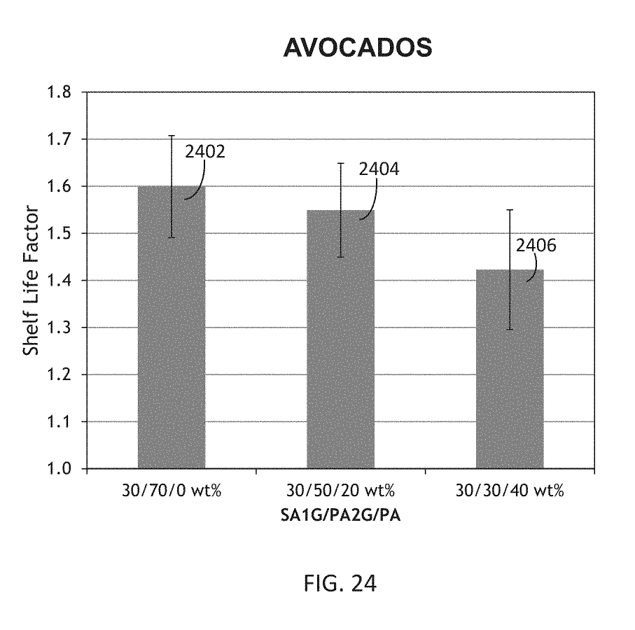

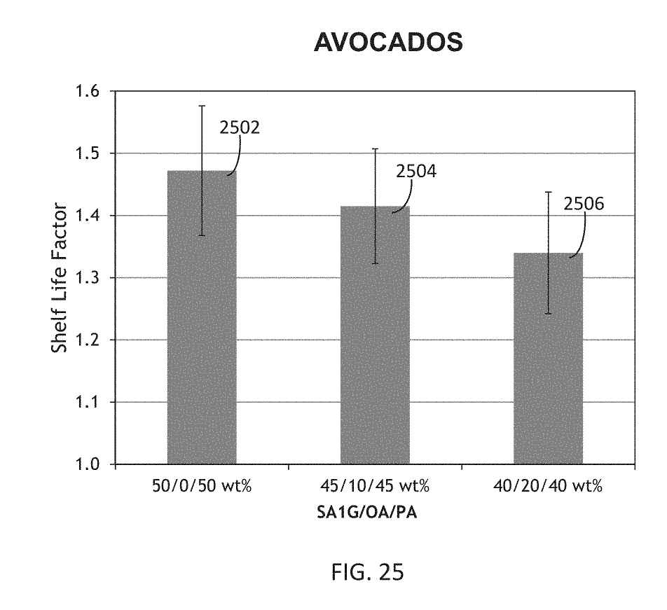

FIGS. 24 and 25 are graphs showing the shelf life factor for avocados coated with binary or ternary compound mixtures. Each bar in both graphs represents a group of 30 avocados. All coatings were formed by dipping the avocados in a solution comprising the associated mixture dissolved in substantially pure ethanol at a concentration of 5 mg/mL, placing the avocados on drying racks, and allowing the avocados to dry under ambient room conditions at a temperature in the range of about 23° C.-27° C. and humidity in the range of about 40%-55%. The avocados were held at these same temperature and humidity conditions for the entire duration of the time they were tested.

The study illustrated in FIG. 24 was directed to examining the effects of adding a second additive to a mixture including a compound of Formula I-A and a first additive (the first additive being different from the second additive) in order to reduce the relative amount of the compound of Formula I-A in the mixture while still maintaining an effective coating with no visible precipitates or other visible residues. Because in many cases compounds of Formula I-A can be more expensive to produce and often tend to be less stable (i.e., tend to convert to other types of compounds over time due to equilibrium driving forces) than other types of compounds (e.g., fatty acids and compounds of Formula I-B), reducing the relative composition of the compound of Formula I-A in the mixture can reduce the cost as well as increase the stability of the mixture.

Bar 2402 corresponds to avocados coated with a mixture including SA-1G (first additive, compound of Formula I-B) and PA-2G (compound of Formula I-A) mixed at a mass ratio of 30:70. This coating resulted in a shelf life factor of about 1.6. Bar 2404 corresponds to avocados coated with a mixture including SA-1G, PA-2G, and PA mixed at a respective mass ratio of 30:50:20. That is, as compared to the compounds corresponding to bar 2402, the coating formulation of bar 2404 could be formed by removing a portion of the PA-2G in the formulation corresponding to bar 1602 and replacing it with PA, such that the formulation of bar 2404 was 50% compounds of Formula I-A (by mass) and 50% additives (by mass). As shown, the shelf life factor is only reduced slightly (as compared to bar 2402) to about 1.55. Bar 2406 corresponds to avocados coated with a mixture including SA-1G, PA-2G, and PA mixed at a respective mass ratio of 30:30:40 (i.e., removing additional PA-2G and replacing it with PA). In this case, the formulation was only 30% compounds of Formula I-A (by mass) and 70% additives (by mass). As shown, although the shelf life factor is reduced (as compared to bars 2402 and 2404) to about 1.43, this coating formulation was still highly effective at reducing the rate of mass loss in avocados.

FIG. 25 illustrates the results of a study directed to forming coatings with 3-component mixtures that lacked a compound of Formula I-A, and for which a wide range of composition variations could still result in coatings which provided an effective barrier to moisture loss. Bar 2502 corresponds to avocados coated with a mixture including SA-1G (compound of Formula I-B) and PA (first fatty acid) mixed at a mass ratio of 50:50. The shelf life factor for these avocados was about 1.47. Bar 2504 corresponds to avocados coated with a mixture including SA-1G, OA, and PA mixed at a respective mass ratio of 45:10:45. That is, as compared to the compounds corresponding to bar 2502, the coating formulation of bar 2504 could be formed by removing equal portions (by mass) of the SA-1G and PA in the formulation of bar 2502 and replacing them with OA. The shelf life factor for these avocados was still greater than 1.4. Bar 2506 corresponds to avocados coated with a mixture including SA-1G, OA, and PA mixed at a respective mass ratio of 40:20:40. That is, as compared to the compounds corresponding to bar 2504, the coating formulation of bar 2506 could be formed by further removing equal portions (by mass) of the SA-1G and PA in the formulation of bar 2504 and replacing them with OA. The shelf life factor for these avocados was greater than 1.3.

It will be understood by one of skill in the art that the relative humidity of the air around fresh produce in a shipping container is dependent upon transpiration (and respiration) through the surface of the produce, the rate of fresh air ventilation, the relative humidity of the fresh air, and the temperature of the refrigerant coil relative to the dew point of the air in the cargo space.

The relative humidity of the air around fresh fruit and vegetables can be dependent upon the following factors: (i) when humid air is cooled down at the start of the transport, the relative humidity can increase; (ii) transpiration and respiration through the surface of the produce can provide additional humidity to the air; (iii) fresh-air ventilation with humid air can raise the relative humidity level further; (iv) the cooling process itself can remove humidity from the container air through condensation at the evaporator fins. Accordingly, although in some cases it can be operationally difficult to maintain a precise relative humidity when shipping or storing produce, a natural balance around approximately a range of RH values (e.g., about 85% to 95%) and having an average relative humidity level (e.g., about 90%) can be readily formed. Further, the temperature at which fresh produce is transported can be between about −3° C. to about 16° C. (e.g., about 0° C. to about 10° C.). The present disclosure enables the transportation of produce at lower average relative humidity than under current conventional practice (e.g., less than about 90% or less than about 85% relative humidity).

In view of the above, for produce which is coated with a coating described herein and then subsequently stored and/or shipped, parameters of the storage/shipping container such as reflow of air or other gasses and vapors through the storage container, level of cooling/refrigeration, and amount of ventilation can all be controlled to result in a lower average relative humidity within the container than would be maintained for identical produce that had not been coated prior to storage while still resulting in an acceptably low rate of mass loss during storage. For example, coated produce such as blueberries can be stored in a container at about 60% to about 90% average RH, about 60% to about 85% average RH, or about 65% to about 85% average RH for at least about 20 days and only lose less than about 30%, less than about 25%, or less than about 20% of their mass. The produce can then be removed from the container, for example to be consumed or to be packaged for sale.

In some embodiments, produce can be grown and harvested in one location and then transported to another location for sale and/or consumption. Often the produce is stored for days or weeks after harvest and/or before sale or consumption in addition to the shipping time.

It will be understood by one of skill in the art that in some embodiments, a produce grower (e.g., a farmer) will not be responsible for shipment and sale of produce he or she grows. In other words, there can be multiple parties involved in the supply chain necessary to deliver produce from the point of production (e.g., the fields or orchards in which it is produced) to an appropriate point for sale (e.g., a grocery store). Such parties include, but are not limited to: farmers, shippers, distributors, retailers (e.g., grocery stores), and consumers as well as wholesalers, which may receive produce from shippers and subsequently deliver the produce to retailers (e.g., grocery stores).

For instance, a farmer may contract with a shipper to transport a harvest of produce from the point of production (e.g., fields or orchards where the produce is grown). The shipper can contract with a retailer (e.g., a grocer or grocery store chain) to deliver the produce to the retailer, who in turn sells the produce to a consumer. In some instances, a shipper may deliver a harvest of produce from a farmer to a wholesaler who in turn delivers produce to the retailer (e.g., a grocery chain). In such instances, a second shipper can be necessary to transport the produce from the wholesaler to the retailer. Accordingly, one of skill in the art will understand that there are potentially multiple parties (e.g., growers, shippers, wholesalers, distributors, retailers, and the like) who can be charged with delivering produce from the point of harvest to an end-consumer.

In some embodiments of the above-scenario, each of the parties involved in bringing produce from the point of production to the consumer (e.g., farmer, shipper, distributor, retailer) can be independent parties. Alternatively, in some embodiments, one single organization can be responsible for one or all parts of the supply chain necessary to deliver produce from the point of production to a consumer. In other words, one organization can control the growing, harvesting, shipment and distribution of the produce. In some embodiments, one organization can be responsible for some but not all of the supply chain necessary to deliver produce from the point of production to a consumer. For instance, a distributor can be responsible for the shipment and sale of produce to a consumer, but not the growing or harvesting of the produce.

Accordingly, the present disclosure contemplates multiple scenarios under which produce can be transported from the point of production to a consumer. Additionally, the present disclosure contemplates multiple scenarios under which produce can be coated, or caused to be coated, with a coating of the present disclosure and transported to a consumer.

For instance, a grower can apply a coating of the present disclosure to the produce he or she grows. In some embodiments, a grower can apply a coating of the present disclosure prior to harvesting the produce or after harvesting the produce (e.g., after harvesting the produce but prior to shipment). In some embodiments, the grower can then store the produce before selling the produce directly to a consumer. In such embodiments, the grower can store the coated produce at a relative humidity level below current industry standards (e.g., less than 90% relative humidity) between coating the produce and selling it to the consumer.

Alternatively, in some embodiments the grower can coat the produce he or she produces with a coating of the present disclosure and sell the produce to a distributor, a retailer (e.g., a grocery store), or a wholesaler. In some embodiments, the grower may contract with a shipper to deliver the produce to the distributor, retailer, or wholesaler. In some embodiments, the distributor, retailer, or wholesaler may contract with a shipper to deliver the produce to the distributor, retailer, or wholesaler from the grower. In any of the above-embodiments, the grower, the wholesaler, distributor, retailer, or another party may direct the shipper to transport the coated produce at a relative humidity below current industry standards (e.g., below about 90% relative humidity). Alternatively, the shipper may elect independently to transport the coated produce at a relative humidity below current industry standards (e.g., below about 90% relative humidity). The wholesaler or distributor can then collect the produce from the shipper at a desired destination.

In some embodiments, a wholesaler, distributor, or retailer can provide a grower with a coating formulation of the present disclosure and direct the grower to coat the produce before shipment (e.g., immediately before or after harvest). The wholesaler, distributor, or retailer can request that a grower coat the produce as a condition of purchasing the produce from the grower. In such embodiments, any of the grower, wholesaler, distributor, or retailer can direct a shipper to transport the produce at a relative humidity below current industry standards (e.g., below about 90%). Alternatively, the shipper may independently transport the produce at a relative humidity below current industry standards (e.g., below about 90%).

For instance, a shipper or wholesaler or distributor or retailer can apply a coating of the present disclosure to the produce obtained from a grower or other party along the supply chain. In some embodiments, a grower can sell produce to a wholesaler or distributor or retailer. The wholesaler or distributor or retailer can apply a coating of the present disclosure to produce prior to shipment of the produce. The produce can then be shipped at a relative humidity below current industry standards (e.g., below about 90% relative humidity). Alternatively, the wholesaler or distributor or retailer can direct a shipper to apply the coatings before shipment and then ship the produce at a relative humidity below current industry standards (e.g., below about 90% relative humidity).

For instance, a wholesaler or distributor or retailer can apply a coating of the present disclosure to the produce obtained from a grower or shipper. Alternatively, a wholesaler or distributor or retailer can direct a grower or a shipper to coat the produce prior to shipment or storage.

In view of the above analysis, the present disclosure contemplates that any party involved with the distribution of produce (e.g., a grower, shipper, wholesaler, distributor, or retailer) can not only coat the produce with a coating of the present disclosure, but can also cause the produce to be coated with a coating of the present disclosure. That is, a party involved with the distribution of the produce can direct (e.g., can request) another party to coat the produce prior to shipment or storage. Thus, for example, even if a distributor or retailer does not coat produce by the methods and compositions described herein, the distributor or retailer may still cause the produce to be coated and shipped at a low relative humidity (e.g., less than about 90% relative humidity) by requesting such practice from, for instance, a grower or shipper.

Accordingly, as used herein, the act of coating a piece of produce also includes directing another party to coat the produce, or causing the produce to be coated with a coating of the present disclosure. The act of shipping a piece of produce as used herein is also understood to mean directing another party to ship the produce, or causing the produce to be shipped. The act of storing a piece of produce as used herein is also understood to mean directing another party to store the produce or causing the produce to be stored.

The current disclosure contemplates a number of different shipment and storage methods. For instance, produce can be shipped over land (e.g., by truck, or rail); over sea (e.g., by boat such as a barge or container ship); or through the air (e.g., in a cargo plane). The produce can be shipped in a shipping container. The shipping container can be, for instance, an intermodal container. An intermodal container is understood as a standardized shipping container that can be used across different modes of transportation, such as those listed above. An intermodal container may have standardized dimensions to enable modular stacking with other intermodal containers. Some exemplary dimensions for intermodal containers are about twenty feet or about forty feet in length; about 8 feet 6 inches or about 9 feet 6 inches in height and width. In some embodiments, the produce can be shipped in “dry freight” or “general purpose” containers.

In some embodiments, a shipping container containing produce can be equipped with a temperature controller and/or a humidity controller for controlling the temperature and/or humidity within the container (e.g., an air conditioning unit or refrigeration system) in order to maintain freshness of the produce therein. In some conventional applications, it is customary to keep the relative humidity at about 90%. The refrigeration system or air conditioning system can also be charged with maintaining a consistent temperature inside the shipping container. For instance, the refrigeration system or air conditioning system can be charged with maintaining a specific temperature (e.g., about 5° C.) and a specific relative humidity (e.g., about 90%).

While such relative humidity levels can help to prevent the effects of moisture loss from reducing the value of the produce, they can also enable spoilage of the same produce by facilitating the growth of germs such as fungus or mold. Accordingly, the present disclosure provides methods to keep produce fresh, even when the conditions of the temperature and/or humidity controller are adjusted such that the produce is stored or shipped at relatively low humidity (e.g., relative humidity below industry standards or below about 90%) by coating the produce with a coating that prevents moisture loss. This allows the produce to remain fresh while also helping to prevent the growth of products that could spoil the produce during storage or shipment (e.g., fungus, mold, and the like).

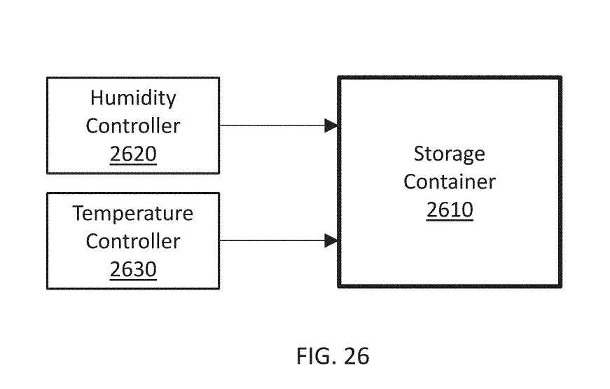

FIG. 26 is a block diagram showing a storage container 2610 for storing produce at a predetermined temperature and relative humidity level for specified period of time. As shown, the storage container 2610 is equipped with a humidity controller 2620 and a temperature controller 2630 (e.g., a refrigeration unit) for maintaining the predetermined temperature and relative humidity level within the container. In some embodiments, the humidity controller 2620 and/or temperature controller 2630 pumps gas and/or vapor into or out of the shipping container 2610. In some embodiments, the humidity controller 2620 and temperature controller 2630 are implemented as a single device capable of maintaining both the desired temperature and desired relative humidity within the container 2610 during storage of the produce.

In some embodiments, storage container 2610 or any other containers described herein in which produce can be stored or shipped can be enclosed containers. As used herein, an “enclosed container” is a container for which the stored contents are sufficiently surrounded by a material impenetrable to flow of gas and/or moisture such that a desired relative humidity and/or temperature range can be maintained within. In some embodiments, an enclosed container can include holes or other openings which allow for a certain degree of transfer of gas or vapor between the inside of the container and the surrounding environment. In some embodiments, the holes or other openings can be sufficiently small to limit the amount of gas or vapor transfer between the inside of the container and the surrounding environment.

Additionally, the current disclosure contemplates a number of different storage methods. In some embodiments, produce is stored in containers between the point of harvest and the point of sale. For instance, the produce can be stored in baskets, “clamshells”, or other vessels. Moreover, the produce can be stored in large storage or shipping containers. In some embodiments, the produce is stored in baskets or “clamshells” and loaded into shipping containers for storage or transportation (e.g., baskets or “clamshells” of produce can be loaded into a shipping container on pallets).

One of skill in the art can understand that the effect of storing or shipping produce can be redundant in terms of the effect on fresh produce. That is, in some embodiments, the amount of spoilage experienced by a harvest of produce can be viewed as a function of time, regardless of whether the produce is being stored or shipped. Accordingly, in some embodiments, the effect of shipping produce can have substantially the same effect as storing the produce for the same amount of time. That is, in some embodiments, it does not matter whether produce is being stored or shipped, but rather the amount of spoilage is dependent upon the amount of time that the produce is being stored and/or shipped. Therefore, as understood herein, the term “storage” or “storing” can include “shipping” or “transporting” the produce, and vice versa.

### EXAMPLES

The disclosure is further illustrated by the following examples and synthesis examples, which are not to be construed as limiting this disclosure in scope or spirit to the specific procedures herein described. It is to be understood that the examples are provided to illustrate certain embodiments and that no limitation to the scope of the disclosure is intended thereby. It is to be further understood that resort may be had to various other embodiments, modifications, and equivalents thereof which may suggest themselves to those skilled in the art without departing from the spirit of the present disclosure and/or scope of the appended claims.

For each of the Examples below, palmitic acid was purchased from Sigma Aldrich, 2,3-dihydroxypropan-2-yl hexadecanoate (PA-1G) was purchased from Tokyo Chemical Industry Co, 1,3-dihydroxypropan-2-yl hexadecanoate (PA-2G) was prepared following the method of Example 1, stearic acid (octadecanoic acid) was purchased from Sigma Aldrich, 2,3-dihydroxypropan-2-yl octadecanoate (SA-1G) was purchased from Alfa Aesar, 1,3-dihydroxypropan-2-yl octadecanoate (SA-2G) was prepared following the method of Example 2, tetradecanoic acid was purchased from Sigma Aldrich, 2,3-dihydroxypropan-2-yl tetradecanoate (MA-1G) was purchased from Tokyo Chemical Industry Co, oleic acid was purchased from Sigma Aldrich, and ethyl palmitate (EtPA) was purchased from Sigma Aldrich. All solvents and other chemical reagents were obtained from commercial sources (e.g., Sigma-Aldrich (St. Louis, Mo.)) and were used without further purification unless noted otherwise.

### Example 1: Synthesis of 1,3-dihydroxypropan-2-yl Hexadecanoate (PA-2G) for Use as a Coating Agent Component

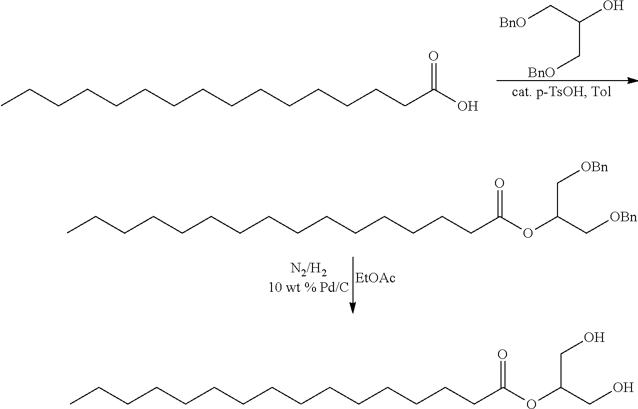 [SMILES: "EtOAc" ; CCCCCCCCCCCCCCCC(=O)O ; OC(COCc1ccccc1)COCc1ccccc1 ; CCCCCCCCCCCCCCCC(=O)OC(COCc1ccccc1)COCc1ccccc1 ; CCCCCCCCCCCCCCCC(=O)OC(CO)CO]

### Step 1. 1,3-bis(benzyloxy)propan-2-yl hexadecanoate

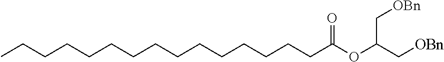 [SMILES: CCCCCCCCCCCCCCCC(=O)OC(COCc1ccccc1)COCc1ccccc1]

70.62 g (275.34 mmol) of palmitic acid, 5.24 g (27.54 mmol) of p-TsOH, 75 g (275.34 mmol) of 1,3-bis(benzyloxy)propan-2-ol, and 622 mL of toluene were charged into a round bottom flask equipped with a Teflon coated magnetic stir bar. A Dean-Stark Head and condenser were attached to the flask and a positive flow of N₂ was initiated. The flask was heated to reflux in a heating mantle while the reaction mixture was stirred vigorously until the amount of water collected (˜5 mL) in the Dean-Stark Head indicated full ester conversion (˜8 hr). The flask was allowed to cool down to room temperature and the reaction mixture was poured into a separatory funnel containing 75 mL of a saturated aqueous solution of Na₂CO₃ and 75 mL of brine. The toluene fraction was collected and the aqueous layer was extracted with 125 mL of Et₂O. The organic layers were combined and washed with 100 mL of brine, dried over MgSO₄, filtered and concentrated in vacuo. The crude colorless oil was dried under high vacuum providing (135.6 g, 265.49 mmol, crude yield=96.4%) of 1,3-bis(benzyloxy)propan-2-yl hexadecanoate.

HRMS (ESI-TOF) (m/z): calcd. for C₃₃H₅₀O₄Na, [M+Na]⁺, 533.3607; found, 533.3588;

¹H NMR (600 MHz, CDCl₃): δ 7.41-7.28 (m, 10H), 5.28 (p, J=5.0 Hz, 1H), 4.59 (d, J=12.1 Hz, 2H), 4.54 (d, J=12.1 Hz, 2H), 3.68 (d, J=5.2 Hz, 4H), 2.37 (t, J=7.5 Hz, 2H), 1.66 (p, J=7.4 Hz, 2H), 1.41-1.15 (m, 24H), 0.92 (t, J=7.0 Hz, 3H) ppm.

¹³C NMR (151 MHz, CDCl₃): δ 173.37, 138.09, 128.43, 127.72, 127.66, 73.31, 71.30, 68.81, 34.53, 32.03, 29.80, 29.79, 29.76, 29.72, 29.57, 29.47, 29.40, 29.20, 25.10, 22.79, 14.23 ppm.

### Step 2. 1,3-dihydroxypropan-2-yl hexadecanoate

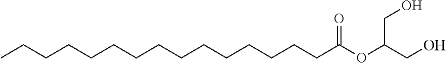 [SMILES: CCCCCCCCCCCCCCCC(=O)OC(CO)CO]

7.66 g (15.00 mmol) of 1,3-bis(benzyloxy)propan-2-yl hexadecanoate, 79.8 mg (0.75 mmol) of 10 wt % Pd/C and 100 mL of EtOAc were charged to a 3 neck round bottom flask equipped with a Teflon coated magnetic stir bar. A cold finger, with a bubbler filled with oil attached to it, and a bubbling stone connected to a 1:4 mixture of H₂/N₂ gas tank were affixed to the flask. H₂/N₂ was bubbled at 1.2 LPM into the flask until the disappearance of both starting material and mono-deprotected substrate as determined by TLC (˜60 min). Once complete, the reaction mixture was filtered through a plug of Celite, which was then washed with 100 mL of EtOAc. The filtrate was placed in a refrigerator at 4° C. for 24 hrs. The precipitate from the filtrate (white and transparent needles) was filtered and dried under high vacuum yielding (2.124 g, 6.427 mmol, yield=42.8%) of 1,3-dihydroxypropan-2-yl hexadecanoate.

HRMS (FD-TOF) (m/z): calcd. for C₁₉H₃₈O₄, 330.2770; found, 330.2757;

¹H NMR (600 MHz, CDCl₃): δ 4.93 (p, J=4.7 Hz, 1H), 3.84 (t, J=5.0 Hz, 4H), 2.37 (t, J=7.6 Hz, 2H), 2.03 (t, J=6.0 Hz, 2H), 1.64 (p, J=7.6 Hz, 2H), 1.38-1.17 (m, 26H), 0.88 (t, J=7.0 Hz, 3H) ppm.

¹³C NMR (151 MHz, CDCl₃): δ 174.22, 75.21, 62.73, 34.51, 32.08, 29.84, 29.83, 29.81, 29.80, 29.75, 29.61, 29.51, 29.41, 29.26, 25.13, 22.85, 14.27 ppm.

### Example 2: Synthesis of 1,3-dihydroxypropan-2-yl Octadecanoate (SA-2G) for Use as a Coating Agent Component

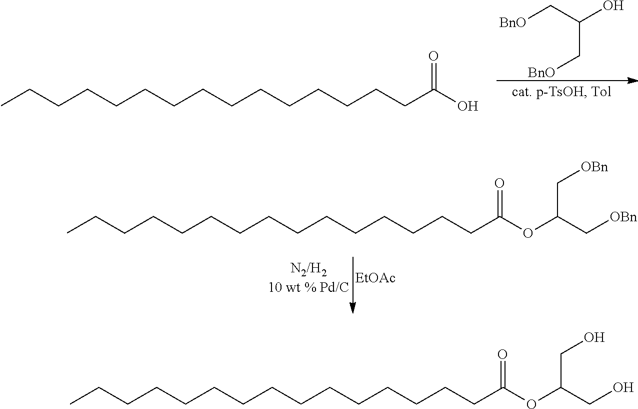 [SMILES: "EtOAc" ; CCCCCCCCCCCCCCCC(=O)O ; OC(COCc1ccccc1)COCc1ccccc1 ; CCCCCCCCCCCCCCCC(=O)OC(COCc1ccccc1)COCc1ccccc1 ; CCCCCCCCCCCCCCCC(=O)OC(CO)CO]

### Step 1. 1,3-bis(benzyloxy)propan-2-yl stearate

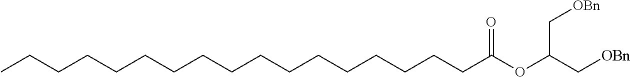 [SMILES: CCCCCCCCCCCCCCCCCC(=O)OC(COCc1ccccc1)COCc1ccccc1]

28.45 g (100 mmol) of stearic acid acid, 0.95 g (5 mmol) of p-TsOH, 27.23 g (275.34 mmol) of 1,3-bis(benzyloxy)propan-2-ol, and 200 mL of toluene were charged into a round bottom flask equipped with a Teflon coated magnetic stir bar. A Dean-Stark Head and condenser were attached to the flask and a positive flow of N₂ was initiated. The flask was heated to reflux in an oil bath while the reaction mixture was stirred vigorously until the amount of water collected (˜1.8 mL) in the Dean-Stark Head indicated full ester conversion (˜16 hr). The flask was allowed to cool down to room temperature and the solution was diluted with 100 mL of hexanes. The reaction mixture was poured into a separatory funnel containing 50 mL of a saturated aqueous solution of Na₂CO₃. The organic fraction was collected and the aqueous layer was extracted twice more with 50 mL portions of hexanes. The organic layers were combined and washed with 100 mL of brine, dried over MgSO₄, filtered and concentrated in vacuo. The crude colorless oil was further purified by selective liquid-liquid extraction using hexanes and acetonitrile and the product was again concentrated in vacuo, yielding (43.96 g, 81.60 mmol, yield=81.6%) of 1,3-bis(benzyloxy)propan-2-yl stearate.

¹H NMR (600 MHz, CDCl₃): δ 7.36-7.27 (m, 10H), 5.23 (p, J=5.0 Hz, 1H), 4.55 (d, J=12.0 Hz, 2H), 4.51 (d, J=12.1 Hz, 2H), 3.65 (d, J=5.0 Hz, 4H), 2.33 (t, J=7.5 Hz, 2H), 1.62 (p, J=7.4 Hz, 2H), 1.35-1.22 (m, 25H), 0.88 (t, J=6.9 Hz, 3H) ppm.

### Step 2. 1,3-dihydroxypropan-2-yl stearate

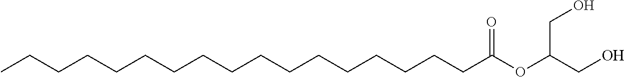 [SMILES: CCCCCCCCCCCCCCCCCC(=O)OC(CO)CO]

6.73 g (12.50 mmol) of 1,3-bis(benzyloxy)propan-2-yl stearate, 439 mg (0.625 mmol) of 20 wt % Pd(OH)₂/C and 125 mL of EtOAc were charged to a 3 neck round bottom flask equipped with a Teflon coated magnetic stir bar. A cold finger, with a bubbler filled with oil attached to it, and a bubbling stone connected to a 1:4 mixture of H₂/N₂ gas tank were affixed to the flask. H₂/N₂ was bubbled at 1.2 LPM into the flask until the disappearance of both starting material and mono-deprotected substrate as determined by TLC (˜120 min). Once complete, the reaction mixture was filtered through a plug of Celite, which was then washed with 150 mL of EtOAc. The filtrate was placed in a refrigerator at 4° C. for 48 hrs. The precipitate from the filtrate (white and transparent needles) was filtered and dried under high vacuum yielding (2.12 g, 5.91 mmol, yield=47.3%) of 1,3-dihydroxypropan-2-yl stearate.

LRMS (ESI+) (m/z): calcd. for C₂₁H₄₃O₄ [M+H]⁺, 359.32; found 359.47.

¹H NMR (600 MHz, CDCl₃): δ 4.92 (p, J=4.7 Hz, 1H), 3.88-3.78 (m, 4H), 2.40-2.34 (m, 2H), 2.09 (t, J=6.2 Hz, 2H), 1.64 (p, J=7.3 Hz, 2H), 1.25 (s, 25H), 0.88 (t, J=7.0 Hz, 3H) ppm.

¹³C NMR (151 MHz, CDCl₃): δ 174.32, 75.20, 62.63, 34.57, 32.14, 29.91, 29.89, 29.87, 29.82, 29.68, 29.57, 29.47, 29.33, 25.17, 22.90, 14.32 ppm.

### Example 3: Effect of Coatings on Post-Harvest Mass Loss of Lemons Stored at Low Average Relative Humidity

Lemons were harvested simultaneously and divided into two groups, each of the groups being qualitatively identical (i.e., lemons in both groups were of approximately the same average size and quality). The first group was untreated, while the second group was coated according to the following procedure. First, a composition was formed by combining PA-1G and PA-2G at a 25:75 molar ratio. The composition was dissolved in ethanol at a concentration of 10 mg/mL to form a solution. The lemons to be coated were placed in a bag, and the solution containing the composition was poured into the bag. The bag was then sealed and lightly agitated until the entire surface of each lemon was wet. The lemons were then removed from the bag and allowed to dry on drying racks under ambient room conditions at a temperature in the range of about 23-27° C. and relative humidity in the range of about 40-55% (ambient temperature and relative humidity). Both the coated and uncoated lemons were held at these same temperature and relative humidity conditions for the entire duration of the time they were tested.

FIG. 5 shows the effects of mass loss over time observed in lemons over the course of 3 weeks for both the coated and uncoated lemons. 502 is a high resolution photograph of one of the uncoated lemons immediately after being picked (Day 1), and 504 is a high resolution photograph of a lemon immediately after being picked and coated on the same day. 512 and 514 are photographs of the uncoated and coated lemons, respectively, taken on Day 22, 21 days after photographs 502 and 504. In order to better visualize the cross-sectional area loss (which is directly related to mass loss), an overlay 522 of the outline of the uncoated lemon on Day 1 is shown around 512, and an overlay 524 of the outline of the coated lemon on Day 1 is shown around 514.

FIG. 6 shows plots for both the coated (602) and uncoated (604) lemons indicating the reduction in cross sectional area as a function of time over a period of 20 days. Specifically, on each day, high resolution images of each of the lemons were taken and analyzed with image processing software (as in FIG. 5) to determine the ratio of the cross sectional area on the particular day to the initial cross sectional area of the lemon. As seen in FIG. 6, after 20 days, the coated lemons (in the non-duplicate group) had an average cross sectional area which was 93% of their original average cross sectional area, whereas the uncoated lemons (in the non-duplicate group) had an average cross sectional area which was 79% of their original average cross sectional area.

### Example 4: Effect of Coatings on Post-Harvest Mass Loss and Molding Rates of Strawberries Stored at Low Average Relative Humidity

Five solutions using C₁₆ glyceryl esters were prepared to examine the effect of the coating agent composition on the rate of mass loss in strawberries stored at low average relative humidity. Five solutions used to coat the strawberries were each composed of one of the following coating agents dissolved in pure ethanol at a concentration of 10 mg/mL. The coating agent of the first solution was pure PA-1G. The coating agent of the second solution was 75% PA-1G and 25% PA-2G by mass. The coating agent of the third solution was 50% PA-1G and 50% PA-2G by mass. The coating agent of the fourth solution was 25% PA-1G and 75% PA-2G by mass. The coating agent of the fifth solution was pure PA-2G.

Strawberries were harvested simultaneously and divided into six groups of 15 strawberries each, each of the groups being qualitatively identical (i.e., all groups had strawberries of approximately the same average size and quality). In order to form coatings over five of the groups of strawberries from the five solutions described above (the sixth group was left untreated), the strawberries were spray coated according to the following procedure. First, the strawberries were placed on drying racks. The five solutions were each placed in a spray bottle which generated a fine mist spray. For each bottle, the spray head was held approximately six inches from the strawberries, and the strawberries were sprayed and then allowed to dry on the drying racks. The strawberries were kept under ambient room conditions at a temperature in the range of 23° C.-27° C. and humidity in the range of 40%-55% while they dried and for the entire duration of the time they were tested.

FIG. 7A is a graph showing average daily mass loss rates, measured over the course of 4 days, of the untreated strawberries and of the strawberries coated with one of the five solutions described above. The strawberries corresponding to bar 702 were untreated (control group). The strawberries corresponding to bar 704 were coated with the first solution (i.e., pure PA-1G). The strawberries corresponding to bar 706 were treated with the second solution (i.e., 75% PA-1G and 25% PA-2G). The strawberries corresponding to bar 708 were treated with the third solution (i.e., 50% PA-1G and 50% PA-2G). The strawberries corresponding to bar 710 were treated with the fourth solution (i.e., 25% PA-1G and 75% PA-2G). The strawberries corresponding to bar 712 were treated with the fifth solution (i.e., pure PA-2G).

As shown in FIG. 7A, the untreated strawberries (702) exhibited an average mass loss rate of 7.6% per day. The strawberries treated with the pure PA-1G formulation (704) exhibited an average daily mass loss rate of 6.4%. The strawberries treated with the pure PA-2G formulation (712) exhibited an average daily mass loss rate of 6.1%. The strawberries corresponding to bar 706 (PA-1G to PA-2G mass ratio of 3) exhibited an average daily mass loss rate of 5.9%. The strawberries corresponding to bar 708 (PA-1G to PA-2G mass ratio of 1) exhibited an average daily mass loss rate of 5.1%. The strawberries corresponding to bar 710 (PA-1G to PA-2G mass ratio of 0.33) exhibited an average daily mass loss rate of 4.8%.

FIG. 7B shows high resolution photographs of 4 coated and 4 uncoated strawberries over the course of 5 days at the temperature and relative humidity conditions described above, where the coated strawberries were taken from the group coated with a solution for which the coating agent was a mixture of PA-1G and PA-2G combined at a mass ratio of 0.33 (corresponding to bar 710 in FIG. 7A). As seen, the untreated strawberries began to exhibit fungal growth and discoloration by day 3, and were mostly covered in fungus by day 5. In contrast, the treated strawberries did not exhibit any fungal growth by day 5 and were largely similar in overall color and appearance on day 1 and day 5.

### Example 5: Effect of Relative Humidity on Molding Rates of Blueberries During Storage

FIGS. 2 and 3 are bar graphs showing percent of blueberries that exhibited molding after being wounded, inoculated, and then stored at various relative humidity levels. Referring to FIG. 2, four groups of 24 blueberries each were wounded with a needle near the top (flower end) of the blueberry (in order to controllably increase the blueberries' susceptibility to spoilage) and then inoculated with spores of Botrytis cinerea conidia. The groups were then held at room temperature (about 18-20° C.) and maintained at different relative humidity levels for a period of 12 days. The first group was maintained at ambient conditions, for which the relative humidity was in the range of 30-50% throughout the 12 days. The second group was maintained at 75% relative humidity, the third group was maintained at 85% relative humidity, and the fourth group was maintained in saturated conditions (about 100% relative humidity). The desired relative humidity was achieved by sealing the groups of blueberries in 7 L containers with exposed saturated salt solutions: sodium chloride for 75% relative humidity, potassium chloride for 85%, and pure water for 100%. FIG. 2 illustrates the percentage of blueberries in each group displaying visible signs of molding after five days and after twelve days. None of the blueberries in the first, second, or third groups displayed any molding after five days, while 38% of the blueberries in the fourth group displayed molding after five days. After twelve days, none of the blueberries maintained at 30-50% relative humidity (first group) displayed any visible molding, while 42% of the blueberries maintained at 75% relative humidity (second group) and 100% of the blueberries maintained at 85% relative humidity (third group) displayed visible signs of molding. Additionally, 96% of the blueberries maintained at 100% relative humidity displayed visible molding.

FIG. 3 is similar to FIG. 2, except that the blueberries used for the data in FIG. 3 were wounded with a needle near the bottom (stem end) of the blueberry and then inoculated with spores of—Botrytis cinerea conidia. The four groups of 24 blueberries each were then held at room temperature (about 18-20° C.) and maintained at different relative humidity levels for a period of 12 days. The first group was maintained at ambient conditions, for which the relative humidity was in the range of 30-50% throughout the 12 days. The second group was maintained at 75% relative humidity, the third group was maintained at 85% relative humidity, and the fourth group was maintained in saturated conditions (about 100% relative humidity). The desired relative humidity was achieved by sealing the groups of blueberries in 7 L containers with exposed saturated salt solutions: sodium chloride for 75% relative humidity, potassium chloride for 85%, and pure water for 100%. FIG. 3 illustrates the percentage of blueberries in each group displaying visible signs of molding after five days and after twelve days. None of the blueberries in the first group displayed any molding after five days or after twelve days. For the second group, 42% of the blueberries displayed visible molding after five days, and 92% displayed visible molding after twelve days. For the third group, 58% of the blueberries displayed visible molding after five days, and 96% displayed visible molding after twelve days. For the fourth group, 88% of the blueberries displayed visible molding after five days, and all (100%) displayed visible molding after twelve days.

FIG. 4 is a plot of rates of molding in groups of unwounded blueberries stored at various relative humidities. For the plot in FIG. 4, three groups of 50 blueberries each, none of which were wounded, were inoculated with spores of—Botrytis cinerea conidia. The groups were then held at room temperature (about 18-20° C.) and maintained at different relative humidity levels for a period of 20 days in order to demonstrate the effect that increased relative humidity has in causing molding/spoilage. The first group was maintained at 75% relative humidity, the second group was maintained at 85% relative humidity, and the third group was maintained in saturated conditions (about 100% relative humidity). The desired relative humidity was achieved by sealing the groups of blueberries in 7 L containers with exposed saturated salt solutions: sodium chloride for 75% relative humidity, potassium chloride for 85%, and pure water for 100%. FIG. 4 illustrates the percentage of blueberries in each group displaying visible signs of molding after six days, eight days, eleven days, fourteen days, sixteen days, and twenty days. As shown, the rate of molding in the group maintained in saturated conditions (third group) was highest, followed by the group maintained at 85% relative humidity (second group). The group maintained at 75% relative humidity (first group) had the lowest rate of molding. Specifically, after twenty days, 28% of the blueberries in the first group displayed visible signs of molding, 42% of the blueberries in the second group displayed visible signs of molding, and 74% of the blueberries in the third group displayed visible signs of molding.

### Example 6: Effects of Coatings on Mass Loss Rates of Blueberries Stored at Ambient Temperature and Humidity

Two solutions including a coating agent formed of a mixture of PA-1G (25%) and PA-2G (75%) dissolved in pure ethanol (sanitizing agent) were prepared. For the first solution, the coating agent was dissolved in the ethanol at a concentration of 10 mg/mL, and for the second solution, the coating agent was dissolved in the ethanol at a concentration of 20 mg/mL.

Blueberries were harvested simultaneously and divided into three groups of 60 blueberries each, each of the groups being qualitatively identical (i.e., all groups had blueberries of approximately the same average size and quality). The first group was a control group of untreated blueberries, the second group was treated with the 10 mg/mL solution, and the third group was treated with the 20 mg/mL solution.

To treat the blueberries, each blueberry was picked up with a set of tweezers and individually dipped in the solution for approximately 1 second, after which the blueberry was placed on a drying rack and allowed to dry. The blueberries were kept under ambient room conditions at a temperature in the range of 23° C.-27° C. and humidity in the range of 40%-55% while they dried and for the entire duration of the time they were tested. Mass loss was measured by carefully weighing the blueberries each day, where the reported percent mass loss was equal to the ratio of mass reduction to initial mass.

FIG. 8 shows plots of the percent mass loss over the course of 5 days in untreated (control) blueberries (802), blueberries treated using the first solution of 10 mg/mL (804), and blueberries treated using the second solution of 20 mg/mL (806). As shown, the percent mass loss for untreated blueberries was 19.2% after 5 days, whereas the percent mass loss for blueberries treated with the 10 mg/mL solution was 15% after 5 days, and the percent mass loss for blueberries treated with the 20 mg/mL solution was 10% after 5 days.

FIG. 9 shows high resolution photographs of the untreated blueberries (902) and of the blueberries coated with the 10 mg/mL solution (904), taken at day 5. The skins of the uncoated blueberries (902) were highly wrinkled as a result of mass loss of the blueberries, whereas the skins of the blueberries coated with the 10 mg/mL solution (904) remained very smooth.

### Example 7: Effects of Coatings on Mass Loss Rates of Blueberries Stored at Various Relative Humidities

FIGS. 10 and 11 are plots of average daily mass loss rates over the course of 23 days for groups of coated and uncoated blueberries stored at various relative humidity levels at ambient temperature (about 20° C.), where each bar in both graphs represents a group of 50 blueberries. The blueberries corresponding to FIG. 10 were sanitized by soaking for 2 minutes in a 1% bleach solution prior to being coated/tested, while the blueberries corresponding to FIG. 11 were coated/tested without sanitization. Coatings were formed on all the blueberries as follows. First, a solution was formed by dissolving a coating agent in 80% ethanol (i.e., an 80:20 mix of ethanol and water) at a concentration of 20 mg/mL, where the coating agent was a 30:70 mixture of PA-1G and PA-2G. Next, the blueberries were placed in bags, and the solution containing the composition was poured into the bags. The bags were then sealed and lightly agitated until the entire surface of each blueberry was wet. The blueberries were then removed from the bags and allowed to dry on drying racks.

Referring to FIG. 10, bars 1040, 1030, 1020, and 1010 correspond to uncoated blueberries stored at respective relative humidities of 100% (saturated conditions), 85%, 75%, and about 55% (approximate ambient humidity), and bars 1042, 1032, 1022, and 1012 correspond to coated blueberries stored at respective relative humidities of 100% (saturated conditions), 85%, 75%, and about 55% (approximate ambient humidity). Referring to FIG. 11, bars 1140, 1130, 1120, and 1110 correspond to uncoated blueberries stored at respective relative humidities of 100% (saturated conditions), 85%, 75%, and about 55% (approximate ambient humidity), and bars 1142, 1132, 1122, and 1112 correspond to coated blueberries stored at respective relative humidities of 100% (saturated conditions), 85%, 75%, and about 55% (approximate ambient humidity). Each bar in both graphs represents a group of 50 blueberries. The desired relative humidity was achieved by sealing each group of 50 blueberries in a 7 L container with exposed saturated salt solutions: sodium chloride for 75% relative humidity, potassium chloride for 85%, and pure water for 100%.

Referring to FIG. 10, for the blueberries sanitized prior to coating, the uncoated blueberries stored at ambient humidity exhibited average mass loss rates of 3.14% per day, while the coated blueberries stored at ambient humidity exhibited average mass loss rates of 2.12% per day. The uncoated blueberries stored at 75% relative humidity exhibited average mass loss rates of 1.76% per day, while the coated blueberries stored at 75% relative humidity exhibited average mass loss rates of 1.38% per day. The uncoated blueberries stored at 85% relative humidity exhibited average mass loss rates of 1.53% per day, while the coated blueberries stored at 85% relative humidity exhibited average mass loss rates of 1.34% per day. The uncoated blueberries stored at 100% relative humidity exhibited average mass loss rates of 0.09% per day, while the coated blueberries stored at 100% relative humidity exhibited average mass loss rates of 0.07% per day.

Referring to FIG. 11, for the blueberries that were not sanitized prior to coating, the uncoated blueberries stored at ambient humidity exhibited average mass loss rates of 2.97% per day, while the coated blueberries stored at ambient humidity exhibited average mass loss rates of 2.47% per day. The uncoated blueberries stored at 75% relative humidity exhibited average mass loss rates of 1.41% per day, while the coated blueberries stored at 75% relative humidity exhibited average mass loss rates of 1.40% per day. The uncoated blueberries stored at 85% relative humidity exhibited average mass loss rates of 1.23% per day, while the coated blueberries stored at 85% relative humidity exhibited average mass loss rates of 1.10% per day. The uncoated blueberries stored at 100% relative humidity exhibited average mass loss rates of 0.08% per day, while the coated blueberries stored at 100% relative humidity exhibited average mass loss rates of 0.06% per day.

### Example 8: Effects of Coatings on Molding Rates of Blueberries Stored at Various Relative Humidities

FIGS. 12-17 are plots of blueberry molding rates (i.e., percent of blueberries exhibiting visible molding) as a function of time for both coated and uncoated emerald blueberries stored at various relative humidity levels, where 50 blueberries were measured for each condition. Coatings were formed on all the blueberries as follows. First, a solution was formed by dissolving a coating agent in 80% ethanol (i.e., an 80:20 mix of ethanol and water) at a concentration of 20 mg/mL, where the coating agent was a 30:70 mixture of PA-1G and PA-2G. Next, the blueberries were placed in bags, and the solution containing the composition was poured into the bags. The bags were then sealed and lightly agitated until the entire surface of each blueberry was wet. The blueberries were then removed from the bags and allowed to dry on drying racks.

FIGS. 12-14 correspond to blueberries stored at ambient temperature (about 20° C.) at relative humidities of 75%, 85%, and 100%, respectively, while FIGS. 15-17 correspond to blueberries stored at 2° C. at relative humidities of 75%, 85%, and 100%, respectively. The desired relative humidity was achieved by sealing each group of 50 blueberries in a 7 L container with exposed saturated salt solutions: sodium chloride for 75% relative humidity, potassium chloride for 85%, and pure water for 100%. In FIGS. 12-14, data lines 1220, 1330, and 1440 correspond to uncoated blueberries, while data lines 1222, 1332, and 1442 correspond to coated blueberries. In FIGS. 15-17, data lines 1520, 1630, and 1740 correspond to uncoated blueberries, while data lines 1522, 1632, and 1742 correspond to coated blueberries. Molding rates for coated and uncoated blueberries stored at ambient humidity (about 55% relative humidity) were also measured both at ambient temperature (about 20° C.) and at 2° C., but no visible signs of molding were observed on any of the blueberries during the time periods reported in FIGS. 12-17.

FIGS. 12-14 show plots of molding rates after 6 days, 8 days, 11 days, 14 days, 16 days, and 20 days of storage at ambient temperature. As seen, for the blueberries stored at ambient temperature at 75% relative humidity, after 20 days, 20% of the uncoated blueberries exhibited visible molding, while only 14% of the coated blueberries exhibited visible molding. For the blueberries stored at ambient temperature at 85% relative humidity, after 20 days, 28% of the uncoated blueberries exhibited visible molding, while only 8% of the coated blueberries exhibited visible molding. For the blueberries stored at ambient temperature at 100% relative humidity, after 20 days, 74% of the uncoated blueberries exhibited visible molding, while only 56% of the coated blueberries exhibited visible molding.

As seen in FIGS. 15-17, reducing the storage temperature to 2° C. delayed the onset of molding as compared to ambient room temperature, so molding rates in FIGS. 15-17 are plotted for 24 days, 26 days, 30 days, 33 days, 35 days, and 37 days of storage. For the blueberries stored at 2° C. at 75% relative humidity, after 37 days, 8% of the uncoated blueberries exhibited visible molding, while only 4% of the coated blueberries exhibited visible molding. For the blueberries stored at 2° C. at 85% relative humidity, after 37 days, 68% of the uncoated blueberries exhibited visible molding, while only 16% of the coated blueberries exhibited visible molding. For the blueberries stored at 2° C. at 100% relative humidity, after 37 days, 80% of the uncoated blueberries exhibited visible molding, while only 50% of the coated blueberries exhibited visible molding.

### Example 9: Effects of Coatings on Mass Loss Rates of Finger Limes Stored at Ambient Temperature and Humidity

Five solutions using C₁₆ glyceryl esters were prepared to examine the effect of the coating agent composition on the rate of mass loss in finger limes stored at low average relative humidity. Five solutions used to coat the finger limes were each composed of one of the following coating agents dissolved in pure ethanol at a concentration of 10 mg/mL. The coating agent of the first solution was pure PA-1G. The coating agent of the second solution was 75% PA-1G and 25% PA-2G by mass. The coating agent of the third solution was 50% PA-1G and 50% PA-2G by mass. The coating agent of the fourth solution was 25% PA-1G and 75% PA-2G by mass. The coating agent of the fifth solution was pure PA-2G.

Finger limes were harvested simultaneously and divided into six groups of 24 finger limes each, each of the groups being qualitatively identical (i.e., all groups had finger limes of approximately the same average size and quality). In order to form coatings over five of the groups of finger limes from the five solutions described above (the sixth group was left untreated), the groups of 24 finger limes were each placed in a bag, and the solution containing the associated composition was poured into each bag. The bag was then sealed and lightly agitated until the entire surface of each finger lime was wet. The finger limes were then removed from the bags and allowed to dry on drying racks. The finger limes were kept under ambient room conditions at a temperature in the range of about 23° C.-27° C. and humidity in the range of about 40%-55% while they dried and for the entire duration of the time they were tested.

FIG. 18 is a graph showing average daily mass loss rates of the untreated finger limes and of the finger limes coated with each of the five solutions described above. The finger limes corresponding to bar 1802 were untreated (control group). The finger limes corresponding to bar 1804 were coated with the first solution (i.e., pure PA-1G). The finger limes corresponding to bar 1806 were treated with the second solution (i.e., 75% PA-1G and 25% PA-2G). The finger limes corresponding to bar 1808 were treated with the third solution (i.e., 50% PA-1G and 50% PA-2G). The finger limes corresponding to bar 1810 were treated with the fourth solution (i.e., 25% PA-1G and 75% PA-2G). The finger limes corresponding to bar 1812 were treated with the fifth solution (i.e., pure PA-2G).

As shown in FIG. 18, the uncoated finger limes (1802) exhibited an average mass loss rate of 5.3% per day. The finger limes coated with the substantially pure PA-1G formulation (1804) exhibited an average mass loss rate of 4.3% per day. The finger limes corresponding to bar 1806 (75:25 mass ratio of PA-1G to PA-2G) exhibited an average mass loss rate of 3.4% per day. The finger limes corresponding to bar 1808 (50:50 mass ratio of PA-1G to PA-2G) exhibited an average mass loss rate of 3.3% per day. The finger limes corresponding to bar 1810 (25:75 mass ratio of PA-1G to PA-2G) exhibited an average mass loss rate of 2.5% per day. The finger limes coated with the substantially pure PA-2G formulation (1812) exhibited an average mass loss rate of 3.7% per day.

### Example 10: Effects of Coatings on Mass Loss Rates of Avocados Stored at Ambient Temperature and Humidity

Nine solutions using combinations 1-glyceryl and 2-glyceryl esters were prepared to examine the effect of the coating agent composition on the rate of mass loss on avocados treated with a solution comprising the coating agent dissolved in a solvent to form a coating over the avocados. Each solution was composed of the coating agents described below dissolved in pure ethanol at a concentration of 5 mg/mL.

The first solution contained 2,3-dihydroxypropan-2-yl tetradecanoate and 1,3-dihydroxypropan-2-yl hexadecanoate combined at a molar ratio of 1:3. The second solution contained 2,3-dihydroxypropan-2-yl tetradecanoate and 1,3-dihydroxypropan-2-yl hexadecanoate combined at a molar ratio of 1:1. The third solution contained 2,3-dihydroxypropan-2-yl tetradecanoate and 1,3-dihydroxypropan-2-yl hexadecanoate combined at a molar ratio of 3:1. The fourth solution contained 2,3-dihydroxypropan-2-ylhexadecanoate and 1,3-dihydroxypropan-2-yl hexadecanoate combined at a molar ratio of 3:1. The fifth solution contained 2,3-dihydroxypropan-2-yl hexadecanoate and 1,3-dihydroxypropan-2-yl hexadecanoate combined at a molar ratio of 1:1. The sixth solution contained 2,3-dihydroxypropan-2-yl hexadecanoate and 1,3-dihydroxypropan-2-yl hexadecanoate combined at a molar ratio of 1:3. The seventh solution contained 2,3-dihydroxypropan-2-yl octadecanoate and 1,3-dihydroxypropan-2-yl hexadecanoate combined at a molar ratio of 1:3. The eighth solution contained 2,3-dihydroxypropan-2-yl octadecanoate and 1,3-dihydroxypropan-2-yl hexadecanoate combined at a molar ratio of 1:1. The ninth solution contained 2,3-dihydroxypropan-2-yl octadecanoate and 1,3-dihydroxypropan-2-yl hexadecanoate combined at a molar ratio of 3:1.

Avocados were harvested simultaneously and divided into nine groups of 30 avocados, each of the groups being qualitatively identical (i.e., all groups had avocados of approximately the same average size and quality). In order to form the coatings, the avocados were each individually dipped in one of the solutions, with each group of 30 avocados being treated with the same solution. The avocados were then placed on drying racks and allowed to dry under ambient room conditions at a temperature in the range of about 23° C.-27° C. and relative humidity in the range of about 40%-55%. The avocados were all held at these same temperature and humidity conditions for the entire duration of time they were tested.

FIG. 19 is a graph showing the shelf life factor for avocados that were each treated with one of the nine solutions described above. Bar 1902 corresponds to the first solution (1:3 mixture of 2,3-dihydroxypropan-2-yl tetradecanoate and 1,3-dihydroxypropan-2-yl hexadecanoate), bar 1904 corresponds to the second solution (1:1 mixture of 2,3-dihydroxypropan-2-yl tetradecanoate and 1,3-dihydroxypropan-2-yl hexadecanoate), bar 1906 corresponds to the third solution (3:1 mixture of 2,3-dihydroxypropan-2-yl tetradecanoate and 1,3-dihydroxypropan-2-yl hexadecanoate), bar 1912 corresponds to the fourth solution (1:3 mixture of 2,3-dihydroxypropan-2-yl hexadecanoate and 1,3-dihydroxypropan-2-yl hexadecanoate), bar 1914 corresponds to the fifth solution (1:1 mixture of 2,3-dihydroxypropan-2-yl hexadecanoate and 1,3-dihydroxypropan-2-yl hexadecanoate), bar 1916 corresponds to the sixth solution (3:1 mixture of 2,3-dihydroxypropan-2-yl hexadecanoate and 1,3-dihydroxypropan-2-yl hexadecanoate), bar 1922 corresponds to the seventh solution (1:3 mixture of 2,3-dihydroxypropan-2-yl octadecanoate and 1,3-dihydroxypropan-2-yl hexadecanoate), bar 1924 corresponds to the eighth solution (1:1 mixture of 2,3-dihydroxypropan-2-yl octadecanoate and 1,3-dihydroxypropan-2-yl hexadecanoate), and bar 1926 corresponds to the ninth solution (3:1 mixture of 2,3-dihydroxypropan-2-yl octadecanoate and 1,3-dihydroxypropan-2-yl hexadecanoate). As previously described, the term “shelf life factor” is the ratio of the average daily mass loss rate of untreated produce (measured for a control group) to the average daily mass loss rate of the corresponding treated produce. Hence, a shelf life factor greater than 1 corresponds to a decrease in average daily mass loss rate of treated produce as compared to untreated produce, and a larger shelf life factor corresponds to a greater reduction in average daily mass loss rate.

As shown in FIG. 19, coating with the first solution (1902) resulted in a shelf life factor of 1.48, coating with the second solution (1904) resulted in a shelf life factor of 1.42, coating with the third solution (1906) resulted in a shelf life factor of 1.35, coating with the fourth solution (1912) resulted in a shelf life factor of 1.53, coating with the fifth solution (1914) resulted in a shelf life factor of 1.45, coating with the sixth solution (1916) resulted in a shelf life factor of 1.58, coating with the seventh solution (1922) resulted in a shelf life factor of 1.54, coating with the eighth solution (1924) resulted in a shelf life factor of 1.47, and coating with the ninth solution (1926) resulted in a shelf life factor of 1.52.

### Example 11: Use of Coating Agents to Reduce Spoilage of Avocados—Effect of Coating Agent Composition Using Combinations of Fatty Acids and Glyeryl Esters

Nine solutions using combinations of fatty acids and glyceryl esters were prepared to examine the effect of the coating agent composition on the rate of mass loss on avocados treated with a solution comprising the coating agent dissolved in a solvent to form a coating over the avocados. Each solution was composed of the coating agents described below dissolved in pure ethanol at a concentration of 5 mg/mL.

The first solution contained tetradecanoic acid and 1,3-dihydroxypropan-2-yl hexadecanoate combined at a molar ratio of 1:3. The second solution contained tetradecanoic acid and 1,3-dihydroxypropan-2-yl hexadecanoate combined at a molar ratio of 1:1. The third solution contained tetradecanoic acid and 1,3-dihydroxypropan-2-yl hexadecanoate combined at a molar ratio of 3:1. The fourth solution contained hexadecanoic acid and 1,3-dihydroxypropan-2-yl hexadecanoate combined at a molar ratio of 1:3. The fifth solution contained hexadecanoic acid and 1,3-dihydroxypropan-2-yl hexadecanoate combined at a molar ratio of 1:1. The sixth solution contained hexadecanoic acid and 1,3-dihydroxypropan-2-yl hexadecanoate combined at a molar ratio of 3:1. The seventh solution contained octadecanoic acid and 1,3-dihydroxypropan-2-yl hexadecanoate combined at a molar ratio of 1:3. The eighth solution contained octadecanoic acid and 1,3-dihydroxypropan-2-yl hexadecanoate combined at a molar ratio of 1:1. The ninth solution contained octadecanoic acid and 1,3-dihydroxypropan-2-yl hexadecanoate combined at a molar ratio of 3:1.

Avocados were harvested simultaneously and divided into nine groups of 30 avocados, each of the groups being qualitatively identical (i.e., all groups had avocados of approximately the same average size and quality). In order to form the coatings, the avocados were each individually dipped in one of the solutions, with each group of 30 avocados being treated with the same solution. The avocados were then placed on drying racks and allowed to dry under ambient room conditions at a temperature in the range of about 23° C.-27° C. and relative humidity in the range of about 40%-55%. The avocados were all held at these same temperature and humidity conditions for the entire duration of time they were tested.

FIG. 20 is a graph showing the shelf life factor for avocados that were each treated with one of the nine solutions described above. Bar 2002 corresponds to the first solution (1:3 mixture of tetradecanoic acid and 1,3-dihydroxypropan-2-yl hexadecanoate), bar 2004 corresponds to the second solution (1:1 mixture of tetradecanoic acid and 1,3-dihydroxypropan-2-yl hexadecanoate), bar 2006 corresponds to the third solution (3:1 mixture of tetradecanoic acid and 1,3-dihydroxypropan-2-yl hexadecanoate), bar 2012 corresponds to the fourth solution (1:3 mixture of hexadecanoic acid and 1,3-dihydroxypropan-2-yl hexadecanoate), bar 2014 corresponds to the fifth solution (1:1 mixture of hexadecanoic acid and 1,3-dihydroxypropan-2-yl hexadecanoate), bar 2016 corresponds to the sixth solution (3:1 mixture of hexadecanoic acid and 1,3-dihydroxypropan-2-yl hexadecanoate), bar 2022 corresponds to the seventh solution (1:3 mixture of octadecanoic acid and 1,3-dihydroxypropan-2-yl hexadecanoate), bar 2024 corresponds to the eighth solution (1:1 mixture of octadecanoic acid and 1,3-dihydroxypropan-2-yl hexadecanoate), and bar 2026 corresponds to the ninth solution (3:1 mixture of octadecanoic acid and 1,3-dihydroxypropan-2-yl hexadecanoate).

As shown in FIG. 20, treatment in the first solution (2002) resulted in a shelf life factor of 1.39, treatment in the second solution (2004) resulted in a shelf life factor of 1.35, treatment in the third solution (2006) resulted in a shelf life factor of 1.26, treatment in the fourth solution (2012) resulted in a shelf life factor of 1.48, treatment in the fifth solution (2014) resulted in a shelf life factor of 1.40, treatment in the sixth solution (2016) resulted in a shelf life factor of 1.30, treatment in the seventh solution (2022) resulted in a shelf life factor of 1.54, treatment in the eighth solution (2024) resulted in a shelf life factor of 1.45, and treatment in the ninth solution (2026) resulted in a shelf life factor of 1.35.

### Example 12: Use of Coating Agents to Reduce Spoilage of Avocados—Effect of Coating Agent Composition Using Combinations of Ethyl Esters and Glyceryl Esters or Fatty Acids and Glyeryl Esters

Fifteen solutions using combinations ethyl esters and glyceryl esters or fatty acids and glyceryl esters were prepared to examine the effect of the coating agent composition on the rate of mass loss on avocados treated with a solution comprising the coating agent dissolved in a solvent to form a coating over the avocados. Each solution was composed of the coating agents described below dissolved in pure ethanol at a concentration of 5 mg/mL.

The first solution contained ethyl palmitate and 1,3-dihydroxypropan-2-yl hexadecanoate combined at a molar ratio of 1:3. The second solution contained ethyl palmitate and 1,3-dihydroxypropan-2-yl hexadecanoate combined at a molar ratio of 1:1. The third solution contained ethyl palmitate and 1,3-dihydroxypropan-2-yl hexadecanoate combined at a molar ratio of 3:1. The fourth solution contained oleic acid and 1,3-dihydroxypropan-2-yl hexadecanoate combined at a molar ratio of 1:3. The fifth solution contained oleic acid and 1,3-dihydroxypropan-2-yl hexadecanoate combined at a molar ratio of 1:1. The sixth solution contained oleic acid and 1,3-dihydroxypropan-2-yl hexadecanoate combined at a molar ratio of 3:1. The seventh solution contained tetradecanoic acid and 2,3-dihydroxypropan-2-yl octadecanoate combined at a molar ratio of 1:3. The eighth solution contained tetradecanoic acid and 2,3-dihydroxypropan-2-yl octadecanoate combined at a molar ratio of 1:1. The ninth solution contained tetradecanoic acid and 2,3-dihydroxypropan-2-yl octadecanoate combined at a molar ratio of 3:1. The tenth solution contained hexadecanoic acid and 2,3-dihydroxypropan-2-yl octadecanoate combined at a molar ratio of 1:3. The eleventh solution contained hexadecanoic acid and 2,3-dihydroxypropan-2-yl octadecanoate combined at a molar ratio of 1:1. The twelfth solution contained hexadecanoic acid and 2,3-dihydroxypropan-2-yl octadecanoate combined at a molar ratio of 3:1. The thirteenth solution contained octadecanoic acid and 2,3-dihydroxypropan-2-yl octadecanoate combined at a molar ratio of 1:3. The fourteenth solution contained octadecanoic acid and 2,3-dihydroxypropan-2-yl octadecanoate combined at a molar ratio of 1:1. The fifteenth solution contained octadecanoic acid and 2,3-dihydroxypropan-2-yl octadecanoate combined at a molar ratio of 3:1.

Avocados were harvested simultaneously and divided into nine groups of 30 avocados, each of the groups being qualitatively identical (i.e., all groups had avocados of approximately the same average size and quality). In order to form the coatings, the avocados were each individually dipped in one of the solutions, with each group of 30 avocados being treated with the same solution. The avocados were then placed on drying racks and allowed to dry under ambient room conditions at a temperature in the range of about 23° C.-27° C. and relative humidity in the range of about 40%-55%. The avocados were all held at these same temperature and humidity conditions for the entire duration of time they were tested.

FIG. 21 is a graph showing the shelf life factor for avocados that were each treated with one of the fifteen solutions described above. Bar 2101 corresponds to the first solution (1:3 mixture of ethyl palmitate and 1,3-dihydroxypropan-2-yl hexadecanoate), bar 2102 corresponds to the second solution (1:1 mixture of ethyl palmitate and 1,3-dihydroxypropan-2-yl hexadecanoate), bar 2103 corresponds to the third solution (3:1 mixture of ethyl palmitate and 1,3-dihydroxypropan-2-yl hexadecanoate), bar 2111 corresponds to the fourth solution (1:3 mixture of oleic acid and 1,3-dihydroxypropan-2-yl hexadecanoate), bar 2112 corresponds to the fifth solution (1:1 mixture of oleic acid and 1,3-dihydroxypropan-2-yl hexadecanoate), bar 2113 corresponds to the sixth solution (3:1 mixture of oleic acid and 1,3-dihydroxypropan-2-yl hexadecanoate), bar 2121 corresponds to the seventh solution (1:3 mixture of tetradecanoic acid and 2,3-dihydroxypropan-2-yl octadecanoate), bar 2122 corresponds to the eighth solution (1:1 mixture of tetradecanoic acid and 2,3-dihydroxypropan-2-yl octadecanoate), bar 2123 corresponds to the ninth solution (3:1 mixture of octadecanoic acid and 2,3-dihydroxypropan-2-yl tetradecanoic), bar 2131 corresponds to the tenth solution (1:3 mixture of hexadecanoic acid and 2,3-dihydroxypropan-2-yl octadecanoate), bar 2132 corresponds to the eleventh solution (1:1 mixture of hexadecanoic acid and 2,3-dihydroxypropan-2-yl octadecanoate), bar 2133 corresponds to the twelfth solution (3:1 mixture of hexadecanoic acid and 2,3-dihydroxypropan-2-yl octadecanoate), bar 2141 corresponds to the thirteenth solution (1:3 mixture of octadecanoic acid and 2,3-dihydroxypropan-2-yl octadecanoate), bar 2142 corresponds to the fourteenth solution (1:1 mixture of octadecanoic acid and 2,3-dihydroxypropan-2-yl octadecanoate), and bar 2143 corresponds to the fifteenth solution (3:1 mixture of octadecanoic acid and 2,3-dihydroxypropan-2-yl octadecanoate).

As shown in FIG. 21, treatment in the first solution (2101) resulted in a shelf life factor of 1.54, treatment in the second solution (2102) resulted in a shelf life factor of 1.45, treatment in the third solution (2103) resulted in a shelf life factor of 1.32, treatment in the fourth solution (2111) resulted in a shelf life factor of 1.50, treatment in the fifth solution (2112) resulted in a shelf life factor of 1.32, treatment in the sixth solution (2113) resulted in a shelf life factor of 1.29, treatment in the seventh solution (2121) resulted in a shelf life factor of 1.76, treatment in the eighth solution (2122) resulted in a shelf life factor of 1.68, treatment in the ninth solution (2123) resulted in a shelf life factor of 1.46, treatment in the tenth solution (2131) resulted in a shelf life factor of 1.72, treatment in the eleventh solution (2132) resulted in a shelf life factor of 1.66, treatment in the twelfth solution (2133) resulted in a shelf life factor of 1.56, treatment in the thirteenth solution (2141) resulted in a shelf life factor of 1.76, treatment in the fourteenth solution (2142) resulted in a shelf life factor of 1.70, and treatment in the fifteenth solution (2143) resulted in a shelf life factor of 1.47.

### Example 13: Use of Coating Agents to Reduce Spoilage of Avocados—Effect of Coating Using Combination of Fatty Acids and 1-Glycerol Esters

Nine solutions using combinations of 1-glycerol esters and fatty acids were prepared to examine the effect of the coating agent compositions on the rate of mass loss on avocados treated with a solution comprising the coating agent dissolved in a solvent to form a coating over the avocados. All coatings were formed by dipping the avocados in a solution comprising the associated mixture dissolved in substantially pure ethanol at a concentration of 5 mg/mL, placing the avocados on drying racks, and allowing the avocados to dry under ambient room conditions at a temperature in the range of about 23° C.-27° C. and humidity in the range of about 40%-55%. The avocados were held at these same temperature and humidity conditions for the entire duration of the time they were tested.

The results are shown in FIG. 22. FIG. 22 is a graph showing the shelf life factor for avocados each coated with a mixture including a compound of Formula I-B and a fatty acid additive. All mixtures were a 1:1 mix by mole ratio of the compound of Formula I-B (i.e., a 1-glycerol ester) and the fatty acid. Bars 2201-2203 correspond to coatings with MA-1G as the compound of Formula I-B and MA (2201), PA (2202), and SA (2203) as the fatty acid additive. Bars 2211-2213 correspond to coatings with PA-1G as the compound of Formula I-B and MA (2211), PA (2212), and SA (2213) as the fatty acid additive. Bars 2221-2223 correspond to coatings with SA-1G as the compound of Formula I-B and MA (2221), PA (2222), and SA (2223) as the fatty acid additive. Each bar in the graph represents a group of 30 avocados

As shown, the shelf life factor tended to increase as the carbon chain length of the 1-monoacylglyceride was increased. Treatment with the first solution (2201) resulted in a shelf life factor of 1.25. Treatment with the second solution (2202) resulted in a shelf life factor of 1.35. Treatment with the third solution (2203) resulted in a shelf life factor of 1.32. Treatment with the fourth solution (2211) resulted in a shelf life factor of 1.51. Treatment with the fifth solution (2212) resulted in a shelf life factor of 1.51. Treatment with the sixth solution (2213) resulted in a shelf life factor of 1.37. Treatment with the seventh solution (2221) resulted in a shelf life factor of 1.69. Treatment with the eight solution (2222) resulted in a shelf life factor of 1.68. Treatment with the ninth solution (2223) resulted in a shelf life factor of 1.70.

### Example 14: Use of Coating Agents to Reduce Spoilage of Avocados—Effect of Coating Using Combination of 1-Glycerol Esters

Three solutions using combinations of two different 1-glycerol esters were prepared to examine the effect of the coating agent compositions on the rate of mass loss on avocados treated with a solution comprising the coating agent dissolved in a solvent to form a coating over the avocados. All coatings were formed by dipping the avocados in a solution comprising the associated mixture dissolved in substantially pure ethanol at a concentration of 5 mg/mL, placing the avocados on drying racks, and allowing the avocados to dry under ambient room conditions at a temperature in the range of about 23° C.-27° C. and humidity in the range of about 40%-55%. The avocados were held at these same temperature and humidity conditions for the entire duration of the time they were tested.

The results are shown in FIG. 23. FIG. 23 is a graph showing the shelf life factor for avocados each coated with a mixture including two different compounds of Formula I-B (i.e., two different 1-glycerol esters), mixed at a 1:1 mole ratio, where for each mixture the 2 compounds of Formula I-B have a different length carbon chain. Bar 2302 corresponds to a mixture of SA-1G (C18) and PA-1G (C16), bar 2304 corresponds to a mixture of SA-1G (C18) and MA-1G (C14), and bar 2306 corresponds to a mixture of PA-1G (C16) and MA-1G (C14). Each bar in the graph represents a group of 30 avocados.

As shown, the PA-1G/MA-1G mixture (2306) resulted in a shelf life factor greater of 1.44, the SA-1G/PA-1G mixture (2302) resulted in a shelf life factor of 1.51, and the SA-1G/MA-1G mixture (2304) resulted in a shelf life factor of 1.6.

### Example 15: Use of Coating Agents to Reduce Spoilage of Avocados—Effect of Coating Using 3-Component Combination

Three solutions comprising a combination of SA1G, PA2G, and optionally PA were prepared to examine the effect of three-component compositions on the rate of mass loss on avocados treated with a solution comprising the coating agent dissolved in a solvent to form a coating over the avocados.

All coatings were formed by dipping the avocados in a solution comprising the associated mixture dissolved in substantially pure ethanol at a concentration of 5 mg/mL, placing the avocados on drying racks, and allowing the avocados to dry under ambient room conditions at a temperature in the range of about 23° C.-27° C. and humidity in the range of about 40%-55%. The avocados were held at these same temperature and humidity conditions for the entire duration of the time they were tested. The results are shown in FIG. 24. Each bar in FIG. 24 represents a group of 30 avocados.

Bar 2402 corresponds to avocados coated with a mixture including SA-1G (first additive, compound of Formula I-B), PA-2G (compound of Formula I-A), and PA (compound of Formula I) mixed at a mass ratio of 30:70:0. This coating resulted in a shelf life factor of 1.6. Bar 2404 corresponds to avocados coated with a mixture including SA-1G, PA-2G, and PA mixed at a respective mass ratio of 30:50:20. That is, as compared to the compounds corresponding to bar 2402, the coating formulation of bar 2404 could be formed by removing a portion of the PA-2G in the formulation corresponding to bar 1602 and replacing it with PA, such that the formulation of bar 2404 was 50% compounds of Formula I-A (by mass) and 50% additives (by mass). As shown, the shelf life factor is 1.55. Bar 2406 corresponds to avocados coated with a mixture including SA-1G, PA-2G, and PA mixed at a respective mass ratio of 30:30:40 (i.e., removing additional PA-2G and replacing it with PA). In this case, the formulation was only 30% compounds of Formula I-A (by mass) and 70% additives (by mass). As shown, the shelf life factor is 1.43.

### Example 16: Use of Coating Agents to Reduce Spoilage of Avocados—Effect of Coating Using Combination of 1-Glycerol Esters

Three solutions comprising a combination of SA1G, optionally OA, and PA were prepared to examine the effect of three-component compositions on the rate of mass loss on avocados treated with a solution comprising the coating agent dissolved in a solvent to form a coating over the avocados.

All coatings were formed by dipping the avocados in a solution comprising the associated mixture dissolved in substantially pure ethanol at a concentration of 5 mg/mL, placing the avocados on drying racks, and allowing the avocados to dry under ambient room conditions at a temperature in the range of about 23° C.-27° C. and humidity in the range of about 40%-55%. The avocados were held at these same temperature and humidity conditions for the entire duration of the time they were tested. The results are shown in FIG. 25. Each bar in FIG. 25 represents a group of 30 avocados.

Bar 2502 corresponds to avocados coated with a mixture including SA-1G (compound of Formula I-B), OA and PA (first fatty acid) mixed at a mass ratio of 50:0:50. The shelf life factor for these avocados was 1.47. Bar 2504 corresponds to avocados coated with a mixture including SA-1G, OA, and PA mixed at a respective mass ratio of 45:10:45. That is, as compared to the compounds corresponding to bar 2502, the coating formulation of bar 2504 could be formed by removing equal portions (by mass) of the SA-1G and PA in the formulation of bar 2502 and replacing them with OA. The shelf life factor for these avocados was 1.41. Bar 2506 corresponds to avocados coated with a mixture including SA-1G, OA, and PA mixed at a respective mass ratio of 40:20:40. That is, as compared to the compounds corresponding to bar 2504, the coating formulation of bar 2506 could be formed by further removing equal portions (by mass) of the SA-1G and PA in the formulation of bar 2504 and replacing them with OA. The shelf life factor for these avocados was 1.33.

Various implementations of the compositions and methods have been described above. However, it should be understood that they have been presented by way of example only, and not limitation. Where methods and steps described above indicate certain events occurring in certain order, those of ordinary skill in the art having the benefit of this disclosure would recognize that the ordering of certain steps may be modified and such modifications are in accordance with the variations of the disclosure. The implementations have been particularly shown and described, but it will be understood that various changes in form and details may be made. Accordingly, other implementations are within the scope of the following claims.

1. A method of storing produce, comprising:
applying a coating agent to the produce to form a coating over a surface of the produce; and
causing the produce to be stored in a container; wherein
the container is equipped with a humidity controller that maintains an average relative humidity level of less than 90% within the container for at least 1 day while the produce is stored in the container.

2. The method of claim 1, wherein the coating agent comprises monomers, oligomers, low molecular weight polymers, fatty acids, esters, salts, or combinations thereof.

3. The method of claim 1, wherein the coating agent comprises monoacylglycerides.

4. The method of claim 1, wherein at least 20% of the volume of the container is filled with the produce.

5. The method of claim 1, wherein the humidity controller maintains an average relative humidity level of less than 80% within the container for the at least 1 day while the produce is stored in the container.

6. The method of claim 5, wherein the container is enclosed while the produce is stored at the average relative humidity level of less than 80%.

7. The method of claim 1, wherein the container includes a temperature controller configured to maintain a temperature within the container within a predetermined temperature range.

8. The method of claim 7, wherein the predetermined temperature range is −4° C. to 8° C.

9. The method of claim 1, wherein the container is transported while the produce is stored therein.

10. A method of storing produce, comprising:
receiving the produce, wherein the produce has a coating formed thereover, the coating formed by applying a coating agent to a surface of the produce; and
storing the produce in a container; wherein
the container is equipped with a humidity controller that maintains an average relative humidity level of less than 90% within the container for at least 1 day while the produce is stored in the container.

11. The method of claim 10, wherein the coating serves to reduce a mass loss rate of the produce.

12. The method of claim 11, wherein the coating further serves to prevent bacterial growth on the produce.

13. The method of claim 10, wherein the coating is disposed over a cuticular layer of the produce.

14. The method of claim 10, wherein the coating agent comprises monomers, oligomers, low molecular weight polymers, fatty acids, esters, salts, or combinations thereof

15. The method of claim 10, wherein the coating agent comprises monoacylglycerides.

16. The method of claim 10, wherein the coating agent comprises a compound of Formula I: 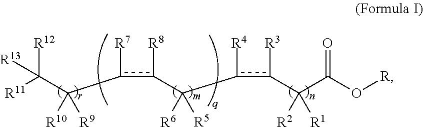
wherein:
R is selected from —H, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl or heteroaryl is optionally substituted with one or more C₁-C₆ alkyl or hydroxy;
R¹, R², R⁵, R⁶, R⁹, R¹⁰, R¹¹, R¹² and R¹³ are each independently, at each occurrence, —H, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with one or more —OR¹⁴, —NR¹⁴R¹⁵, —SR¹⁴, or halogen;
R³, R⁴, R⁷ and R⁸ are each independently, at each occurrence, —H, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with —OR¹⁴, —NR¹⁴R¹⁵, —SR¹⁴, or halogen; or
R³ and R⁴ can combine with the carbon atoms to which they are attached to form a C₃-C₆ cycloalkyl, a C₄-C₆ cycloalkenyl, or a 3- to 6-membered ring heterocycle; and/or
R⁷ and R⁸ can combine with the carbon atoms to which they are attached to form a C₃-C₆ cycloalkyl, a C₄-C₆ cycloalkenyl, or a 3 to 6-membered ring heterocycle;
R¹⁴ and R¹⁵ are each independently, at each occurrence, —H, —C₁-C₆ alkyl, —C₂-C₆ alkenyl, or —C₂-C₆ alkynyl;
the symbol [symbol] represents an optionally single or cis or trans double bond;
n is 0, 1, 2, 3, 4, 5, 6, 7, or 8;
m is 0, 1, 2, or 3;
q is 0, 1, 2, 3, 4, or 5; and
r is 0, 1, 2, 3, 4, 5, 6, 7, or 8.

17. The method of claim 10, wherein the humidity controller maintains an average relative humidity level of less than 80% within the container for the at least 1 day while the produce is stored in the container.

18. The method of claim 17, wherein at least 20% of the volume of the container is filled with the produce.

19. The method of claim 10, wherein the produce is stored in the container at the average relative humidity level of less than 90% for at least 20 days, and the method further comprises removing the produce from the container after the at least 20 days, wherein the produce has a first mass when placed in the container and a second mass upon removal of the container, wherein the second mass is within 30% of the first mass.

20. The method of claim 10, wherein the container includes a temperature controller configured to maintain a temperature within the container within a predetermined temperature range.

21. The method of claim 20, wherein the predetermined temperature range is −4° C. to 8° C.

22. The method of claim 10, further comprising transporting the container while the produce is stored therein.

23. The method of claim 10, wherein the average relative humidity level within the container is different from the ambient relative humidity around the container.

24. A method of storing produce, comprising:
causing a coating agent to be applied to a surface of the produce, thereby forming a coating from the coating agent over the surface of the produce;
storing the produce for at least 1 day; and
configuring a humidity controller to cause the produce to be stored at an average relative humidity level of less than 90% for the at least 1 day.

25. The method of claim 24, wherein the coating agent is part of a mixture comprising a solvent, and wherein the solvent is allowed to at least partially evaporate to form the coating over the surface of the produce.

26. The method of claim 25, wherein the solvent includes at least one of ethanol and water.

27. The method of claim 24, wherein the coating agent includes a compound of Formula I: 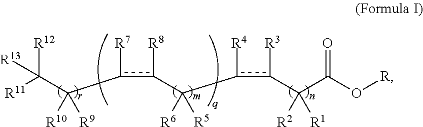
wherein:
R is selected from —H, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl or heteroaryl is optionally substituted with one or more C₁-C₆ alkyl or hydroxy;
R¹, R², R⁵, R⁶, R⁹, R¹⁰, R¹¹, R¹² and R¹³ are each independently, at each occurrence, —H, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with one or more —OR¹⁴, —NR¹⁴R¹⁵, —SR¹⁴, or halogen;
R³, R⁴, R⁷ and R⁸ are each independently, at each occurrence, —H, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with —OR¹⁴, —NR¹⁴R¹⁵, —SR¹⁴, or halogen; or
R³ and R⁴ can combine with the carbon atoms to which they are attached to form a C₃-C₆ cycloalkyl, a C₄-C₆ cycloalkenyl, or a 3- to 6-membered ring heterocycle; and/or
R⁷ and R⁸ can combine with the carbon atoms to which they are attached to form a C₃-C₆ cycloalkyl, a C₄-C₆ cycloalkenyl, or a 3 to 6-membered ring heterocycle;
R¹⁴ and R¹⁵ are each independently, at each occurrence, —H, —C₁-C₆ alkyl, —C₂-C₆ alkenyl, or —C₂-C₆ alkynyl;
the symbol [symbol] represents an optionally single or cis or trans double bond;
n is 0, 1, 2, 3, 4, 5, 6, 7, or 8;
m is 0, 1, 2, or 3;
q is 0, 1, 2, 3, 4, or 5; and
r is 0, 1, 2, 3, 4, 5, 6, 7, or 8.

28. A method of storing produce, comprising:
causing a mixture comprising a coating agent in a solvent to be applied to the produce, wherein the solvent is allowed to at least partially evaporate to form a coating from the coating agent over a surface of the produce; and
causing the coated produce to be stored in an enclosed container for at least 1 day, wherein at least 20% of the internal volume of the container is filled with the produce; wherein
the coating agent comprises monomers, oligomers, low molecular weight polymers, fatty acids, esters, salts, or combinations thereof; and
the container includes a humidity controller that maintains an average relative humidity level within the container at less than 90% for the at least 1 day.

29. The method of claim 27, wherein the average relative humidity level in the container is sufficiently low to suppress fungal growth in the produce during storage.

30. The method of claim 27, wherein the coating has a thickness in a range of about 0.1 microns to 5 microns.
